(19) United States
(12) Patent Application Publication
(10) Pub. No.: US 2021/0056492 A1
(43) Pub. Date: Feb. 25, 2021

(54) PROVIDING INFORMATION BASED ON DETECTION OF ACTIONS THAT ARE UNDESIRED TO WASTE COLLECTION WORKERS

(71) Applicant: Ron Zass, Kiryat Tivon (IL)

(72) Inventor: Ron Zass, Kiryat Tivon (IL)

(21) Appl. No.: 17/090,700

(22) Filed: Nov. 5, 2020

Related U.S. Application Data
(60) Provisional application No. 62/933,421, filed on Nov. 9, 2019.

(51) Int. Cl. G06Q 10/06; G06Q 50/26; G06K 9/00

(52) U.S. Cl. CPC G06Q 10/063114; G06Q 50/26; G06K 2009/00738; G06Q 10/06398; G06K 9/00718

(57) ABSTRACT

Systems, methods and non-transitory computer readable media for providing information based on detection of actions that are undesired to waste collection workers are provided. One or more images captured using one or more image sensors from an environment of a garbage truck may be obtained. The one or more images may be analyzed to detect a waste collection worker in the environment of the garbage truck. The one or more images may be analyzed to determine whether the waste collection worker performs an action that is undesired to the waste collection worker. In response to a determination that the waste collection worker performs an action that is undesired to the waste collection worker, first information may be provided.

### CROSS REFERENCES TO RELATED APPLICATIONS

This application claims the benefit of priority of U.S. Provisional Patent Application No. 62/933,421, filed on Nov. 9, 2019, the disclosure of which incorporated herein by reference in its entirety.

### BACKGROUND

### Technological Field

The disclosed embodiments generally relate to systems and methods for analyzing images. More particularly, the disclosed embodiments relate to systems and methods for analyzing images to provide based on detection of actions that are undesired to waste collection workers.

### Background Information

Containers are widely used in many everyday activities. For example, a mailbox is a container for mail and packages, a trash can is a container for waste, and so forth. Containers may have different types, shapes, colors, structures, content, and so forth.

Actions involving containers are common to many everyday activities. For example, a mail delivery may include collecting mail and/or packages from a mailbox or placing mail and/or packages in a mailbox. In another example, garbage collection may include collecting waste from trash cans.

Usage of vehicles is common and key to many everyday activities.

Audio and image sensors, as well as other sensors, are now part of numerous devices, from mobile phones to vehicles, and the availability of audio data and image data, as well as other information produced by these devices, is increasing.

### SUMMARY

In some embodiments, systems, methods and non-transitory computer readable media for controlling vehicles and vehicle related systems are provided.

In some embodiments, systems, methods and non-transitory computer readable media for adjusting vehicle routes based on absent of items (for example, based on absent of items of particular types, based on absent of containers, based on absent of trash cans, based on absent of containers of particular types, based on absent of trash cans of particular types, and so forth) are provided.

In some embodiments, one or more images captured using one or more image sensors from an environment of a vehicle may be obtained. The one or more images may be analyzed to determine an absent of items of at least one type in a particular area of the environment. Further, a route of the vehicle may be adjusted based on the determination that items of the at least one type are absent in the particular area of the environment, for example to forgo a route portion associated with handling one or more items of the at least one type in the particular area of the environment.

In some embodiments, one or more images captured using one or more image sensors from an environment of a vehicle may be obtained. The one or more images may be analyzed to determine an absent of containers of at least one type of containers in a particular area of the environment. Further, a route of the vehicle may be adjusted based on the determination that containers of the at least one type of containers are absent in the particular area of the environment, for example to forgo a route portion associated with handling one or more containers of the at least one type of containers in the particular area of the environment.

In some embodiments, one or more images captured using one or more image sensors from an environment of a garbage truck may be obtained. The one or more images may be analyzed to determine an absent of trash cans of at least one type of trash cans in a particular area of the environment. Further, a route of the garbage truck may be adjusted based on the determination that trash cans of the at least one type of trash cans are absent in the particular area of the environment, for example to forgo a route portion associated with handling one or more trash cans of the at least one type of trash cans in the particular area of the environment.

In some embodiments, one or more images captured using one or more image sensors from an environment of a garbage truck may be obtained. The one or more images may be analyzed to determine an absent of trash cans in a particular area of the environment. Further, a route of the garbage truck may be adjusted based on the determination that trash cans are absent in the particular area of the environment, for example to forgo a route portion associated with handling one or more trash cans in the particular area of the environment.

In some embodiments, systems, methods and non-transitory computer readable media for providing information about trash cans are provided.

In some embodiments, one or more images captured using one or more image sensors and depicting at least part of a trash can may be obtained. Further, in some examples, the one or more images may be analyzed to determine a type of the trash can. Further, in some examples, in response to a first determined type of trash can, first information may be provided, and in response to a second determined type of trash can, providing the first information may be withheld and/or forgone. In some examples, the determined type of the trash can may be at least one of a trash can for paper, a trash can for biodegradable waste, and a trash can for packaging products.

In some examples, the one or more images may be analyzed to determine a type of the trash can based on at least one color of the trash can. In some examples, the one or more images may be analyzed to determine a color of the trash can, in response to a first determined color of the trash can, it may be determined that the type of the trash can is a first type of trash cans, and in response to a second determined color of the trash can, it may be determined that the type of the depicted trash can is not the first type of trash cans.

In some examples, the one or more images may be analyzed to determine a type of the trash can based on at least a logo presented on the trash can. In some examples, the one or more images may be analyzed to detect a logo presented on the trash can, in response to a first detected logo, it may be determined that the type of the trash can is a first type of trash cans, and in response to a second detected logo, it may be determined that the type of the depicted trash can is not the first type of trash cans.

In some examples, the one or more images may be analyzed to determine a type of the trash can based on at least a text presented on the trash can. In some examples, the one or more images may be analyzed to detect a text presented on the trash can, in response to a first detected text, it may be determined that the type of the trash can is a first type of trash cans, and in response to a second detected text, it may be determined that the type of the depicted trash can is not the first type of trash cans.

In some examples, the one or more images may be analyzed to determine a type of the trash can based on a shape of the trash can. In some examples, the one or more images may be analyzed to identify a shape of the trash can, in response to a first identified shape, it may be determined that the type of the trash can is a first type of trash cans, and in response to a second identified shape, it may be determined that the type of the depicted trash can is not the first type of trash cans.

In some examples, the one or more images may be analyzed to determine that the trash can is overfilled, and the determination that the trash can is overfilled may be used to determine a type of the trash can. In some examples, the one or more images may be analyzed to obtain a fullness indicator associated with the trash can, and the obtained fullness indicator may be used to determine whether a type of the trash can is the first type of trash cans. For example, the obtained fullness indicator may be compared with a selected fullness threshold, and in response to the obtained fullness indicator being higher than the selected threshold, it may be determined that the depicted trash can is not of the first type of trash cans.

In some examples, the one or more images may be analyzed to identify a state of a lid of the trash can, and the identified state of the lid of the trash can may be used to identify the type of the trash can. In some examples, the one or more images may be used to identify an angle of a lid of the trash can, and the identified angle of the lid of the trash can may be used to identify the type of the trash can. In some examples, the one or more images may be analyzed to identify a distance of at least part of a lid of the trash can from at least one other part of the trash can, and the identified distance of the at least part of a lid of the trash can from the at least one other part of the trash can may be used to identify the type of the trash can.

In some examples, the first information may be provided to a user and configured to cause the user to initiate an action involving the trash can. In some examples, the first information may be provided to an external system and configured to cause the external system to perform an action involving the trash can. For example, the action may comprise moving the trash can. In another example, the action may comprise obtaining one or more objects placed within the trash can. In yet another example, the action may comprise changing a physical state of the trash can. In some examples, the first information may be configured to cause an adjustment to a route of a vehicle. In some examples, the first information may be configured to cause an update to a list of tasks.

In some embodiments, systems, methods and non-transitory computer readable media for selectively forgoing actions based on fullness levels of containers are provided.

In some embodiments, one or more images captured using one or more image sensors and depicting at least part of a container may be obtained. Further, in some examples, the one or more images may be analyzed to identify a fullness level of the container. Further, in some examples, it may be determined whether the identified fullness level is within a first group of at least one fullness level. Further, in some examples, at least one action involving the container may be withheld and/or forgone based on a determination that the identified fullness level is within the first group of at least one fullness level. For example, the first group of at least one fullness level may comprise an empty container, may comprise an overfilled container, and so forth. For example, the one or more images may depict at least part of the content of the container, may depict at least one external part of the container, and so forth. In some examples, the one or more image sensors may be configured to be mounted to a vehicle, and the at least one action may comprise adjusting a route of the vehicle to bring the vehicle to a selected position with respect to the container. In some examples, the container may be a trash can, and the at least one action may comprise emptying the trash can. For example, the one or more image sensors may be configured to be mounted to a garbage truck, and the at least one action may comprise collecting the content of the trash can with the garbage truck. In another example, the emptying of the trash can may be performed by an automated mechanical system without human intervention. In some examples, a notification may be provided to a user in response to the determination that the identified fullness level is within the first group of at least one fullness level.

In some examples, a type of the container may be used to determine the first group of at least one fullness level. For example, the one or more images may be analyzed to determine the type of the container.

In some examples, the one or more images may depict at least one external part of the container, the container may be configured to provide a visual indicator associated with the fullness level on the at least one external part of the container, the one or more images may be analyzed to detect the visual indicator, and the detected visual indicator may be used to identify the fullness level.

In some examples, the one or more images may be analyzed to identify a state of a lid of the container, and the identified state of the lid of the container may be used to identify the fullness level of the container. In some examples, the one or more images may be analyzed to identify an angle of a lid of the container, and the identified angle of the lid of the container may be used to identify the fullness level of the container. In some examples, the one or more images may be analyzed to identify a distance of at least part of a lid of the container from at least part of the container, and the identified distance of the at least part of a lid of the container from the at least part of the container may be used to identify the fullness level of the container.

In some examples, in response to a determination that the identified fullness level is not within the first group of at least one fullness level, the at least one action involving the container may be performed, and in response to a determination that the identified fullness level is within the first group of at least one fullness level, performing the at least one action may be withheld and/or forgone. In some examples, in response to a determination that the identified fullness level is not within the first group of at least one fullness level, first information may be provided (the first information may be configured to cause the performance of the at least one action involving the container), and in response to a determination that the identified fullness level is within the first group of at least one fullness level, providing the first information may be withheld and/or forgone.

In some examples, the identified fullness level of the container may be compared with a selected fullness threshold. Further, in some examples, in response to a first result of the comparison of the identified fullness level of the container with the selected fullness threshold, it may be determined that the identified fullness level is within the first group of at least one fullness level, and in response to a second result of the comparison of the identified fullness level of the container with the selected fullness threshold, it may be determined that the identified fullness level is not within the first group of at least one fullness level.

In some embodiments, systems, methods and non-transitory computer readable media for selectively forgoing actions based on the content of containers are provided.

In some embodiments, one or more images captured using one or more image sensors and depicting at least part of a container may be obtained. Further, in some examples, the one or more images may be analyzed to identify a type of at least one item in the container. Further, in some examples, in response to a first identified type of at least one item in the container, a performance of at least one action involving the container may be caused, and in response to a second identified type of at least one item in the container, causing the performance of the at least one action may be withheld and/or forgone.

In some examples, it may be determined whether the identified type is in a group of one or more allowable types, and in response to a determination that the identified type is not in the group of one or more allowable types, causing the performance of the at least one action may be withheld and/or forgone. For example, the group of one or more allowable types may comprise at least one type of waste. In another example, the group of one or more allowable types may include at least one type of recyclable objects and not include at least one type of non-recyclable objects. In yet another example, the group of one or more allowable types may include at least a first type of recyclable objects and not include at least a second type of recyclable objects. In one example, the type of the container may be used to determine the group of one or more allowable types. For example, the one or more images may be analyzed to determine the type of the container. In one example, a notification may be provided to a user in response to the determination that the identified type is not in the group of one or more allowable types.

In some examples, it may be determined whether the identified type is in a group of one or more forbidden types, and in response to a determination that the identified type is in the group of one or more forbidden types, causing the performance of the at least one action may be withheld and/or forgone. For example, the group of one or more forbidden types may include at least one type of hazardous materials. In another example, the group of one or more forbidden types may comprise at least one type of waste. In yet another example, the group of one or more forbidden types may include non-recyclable waste. In an additional example, the group of one or more forbidden types may include at least a first type of recyclable objects and not include at least a second type of recyclable objects. In one example, a type of the container may be used to determine the group of one or more forbidden types. For example, the one or more images may be analyzed to determine the type of the container. In one example, a notification may be provided to a user in response to the determination that the identified type is not in the group of one or more forbidden types.

In some examples, the one or more images may depict at least part of the content of the container. In some examples, the one or more images may depict at least one external part of the container. For example, the container may be configured to provide a visual indicator of the type of the at least one item in the container on the at least one external part of the container, the one or more images may be analyzed to detect the visual indicator, and the detected visual indicator may be used to identify the type of the at least one item in the container.

In some examples, the one or more image sensors may be configured to be mounted to a vehicle, and the at least one action may comprise adjusting a route of the vehicle to bring the vehicle to a selected position with respect to the container. In some examples, the container may be a trash can, and the at least one action may comprise emptying the trash can. For example, the one or more image sensors may be configured to be mounted to a garbage truck, and the at least one action may comprise collecting the content of the trash can with the garbage truck. In another example, the emptying of the container may be performed by an automated mechanical system without human intervention.

In some embodiments, systems, methods and non-transitory computer readable media for restricting movement of a vehicle based on a presence of human rider on an external part of the vehicle are provided.

In some embodiments, one or more images captured using one or more image sensors and depicting at least part of an external part of a vehicle may be obtained. The depicted at least part of the external part of the vehicle may comprise at least part of a place for at least one human rider. Further, in some examples, the one or more images may be analyzed to determine whether a human rider is in the place for at least one human rider. Further, in some examples, in response to a determination that the human rider is in the place, at least one restriction on the movement of the vehicle may be placed, and in response to a determination that the human rider is not in the place, placing the at least one restriction on the movement of the vehicle may be withheld and/or forgone. Further, in some examples, after determining that the human rider is in the place for at least one human rider and placing the at least one restriction on the movement of the vehicle, one or more additional images captured using the one or more image sensors may be obtained. Further, in some examples, the one or more additional images may be analyzed to determine that the human rider is no longer in the place for at least one human rider. Further, in some examples, in response to the determination that the human rider is no longer in the place, the at least one restriction on the movement of the vehicle may be removed. For example, the vehicle may be a garbage truck and the human rider is a waste collector. In one example, the at least one restriction may comprise a restriction on the speed of the vehicle. In another example, the at least one restriction may comprise a restriction on the speed of the vehicle to a maximal speed, the maximal speed may be less than 20 kilometers per hour. In yet another example, the at least one restriction may comprise a restriction on the driving distance of the vehicle. In an additional example, the at least one restriction may comprise a restriction on the driving distance of the vehicle to a maximal distance, the maximal distance may be less than 400 meters.

In some examples, one or more additional images captured using the one or more image sensors after determining that the human rider is in the place for at least one human rider and/or after placing the at least one restriction on the movement of the vehicle may be obtained. The one or more additional images may be analyzed to determine that the human rider is no longer in the place for at least one human rider. Further, in some examples, in response to the determination that the human rider is no longer in the place, the at least one restriction on the movement of the vehicle may be removed.

In some examples, weight data may be obtained from a weight sensor connected to the riding step, the weight data may be analyzed to determine whether a human rider is standing on the riding step, and the determination of whether a human rider is standing on the riding step may be used to determine whether a human rider is in the place for at least one human rider.

In some examples, pressure data may be obtained from a pressure sensor connected to the riding step, the pressure data may be analyzed to determine whether a human rider is standing on the riding step, and the determination of whether a human rider is standing on the riding step may be used to determine whether a human rider is in the place for at least one human rider.

In some examples, touch data may be obtained from a touch sensor connected to the riding step, the touch data may be analyzed to determine whether a human rider is standing on the riding step, and the determination of whether a human rider is standing on the riding step may be used to determine whether a human rider is in the place for at least one human rider.

In some examples, pressure data may be obtained from a pressure sensor connected to the grabbing handle, the pressure data may be analyzed to determine whether a human rider is holding the grabbing handle, and the determination of whether a human rider is holding the grabbing handle may be used to determine whether a human rider is in the place for at least one human rider.

In some examples, touch data may be obtained from a touch sensor connected to the grabbing handle, the touch data may be analyzed to determine whether a human rider is holding the grabbing handle, and the determination of whether a human rider is holding the grabbing handle may be used to determine whether a human rider is in the place for at least one human rider.

In some examples, the one or more images may be analyzed to determine whether the human rider in the place is in an undesired position, and in response to a determination that the human rider in the place is in the undesired position, the at least one restriction on the movement of the vehicle may be adjusted. For example, the place for at least one human rider may comprise at least a riding step externally attached to the vehicle, and the undesired position may comprise a person not safely standing on the riding step. In another example, the place for at least one human rider may comprise at least a grabbing handle externally attached to the vehicle, and the undesired position may comprise a person not safely holding the grabbing handle. In yet another example, the one or more images may be analyzed to determine that at least part of the human rider is at least a threshold distance away of the vehicle, and the determination that the at least part of the human rider is at least a threshold distance away of the vehicle may be used to determine that the human rider in the place is in the undesired position. In an additional example, the adjusted at least one restriction may comprise forbidding the vehicle from driving. In yet another example, the adjusted at least one restriction may comprise forbidding the vehicle from increasing speed.

In some examples, placing the at least one restriction on the movement of the vehicle may comprise providing a notification related to the at least one restriction to a driver of the vehicle. In some examples, placing the at least one restriction on the movement of the vehicle may comprise causing the vehicle to enforce the at least one restriction. In some examples, the vehicle may be an autonomous vehicle, and placing the at least one restriction on the movement of the vehicle may comprise causing the autonomous vehicle to drive according to the at least one restriction.

In some examples, image data depicting a road ahead of the vehicle may be obtained, the image data may be analyzed to determine whether the vehicle is about to drive over a bumper, and in response to a determination that the vehicle is about to drive over the bumper, the at least one restriction on the movement of the vehicle may be adjusted.

In some examples, image data depicting a road ahead of the vehicle may be obtained, the image data may be analyze to determine whether the vehicle is about to drive over a pothole, and in response to a determination that the vehicle is about to drive over the pothole, the at least one restriction on the movement of the vehicle may be adjusted.

In some embodiments, systems, methods and non-transitory computer readable media for monitoring activities around vehicles are provided.

In some embodiments, one or more images captured using one or more image sensors and depicting at least two sides of an environment of a vehicle may be obtained. The at least two sides of the environment of the vehicle may comprise a first side of the environment of the vehicle and a second side of the environment of the vehicle. Further, in some examples, the one or more images may be analyzed to determine that a person is performing a first action of a first type on at least one of the two sides of the environment of the vehicle. Further, in some examples, the at least one of the two sides of the environment of the vehicle may be identified. Further, in some examples, in response to the determination that the person is performing the first action of the first type on the at least one of the two sides of the environment of the vehicle and in response to the identification that the at least one of the two sides of the environment of the vehicle is the first side of the environment of the vehicle, a performance of a second action may be caused. Further, in some examples, in response to the determination that the person is performing the first action of the first type on the at least one of the two sides of the environment of the vehicle and in response to the identification that the at least one of the two sides of the environment of the vehicle is the second side of the environment of the vehicle, causing the performance of the second action may be withheld and/or forgone. For example, the vehicle may comprise a garbage truck, the person may comprise a waste collector, and the first action may comprise collecting trash. In another example, the vehicle may carry a cargo, and the first action may comprise unloading at least part of the cargo. In yet another example, the first action may comprise loading cargo to the vehicle. In an additional example, the first action may comprise entering the vehicle. In yet another example, the first action may comprise exiting the vehicle. In one example, the first side of the environment of the vehicle may comprise at least one of the left side of the vehicle and the right side of the vehicle. In one example, the vehicle may be on a road, the road may comprise a first roadway and a second roadway, the vehicle may be in the first roadway, and the first side of the environment of the vehicle may correspond to the side of the vehicle facing the second roadway. In one example, the vehicle may be on a road, the road may comprise a first roadway and a second roadway, the vehicle may be in the first roadway, and the first side of the environment of the vehicle may correspond to the side of the vehicle opposite to the second roadway. In one example, the second action may comprise providing a notification to a user. In another example, the second action may comprise updating statistical information associated with the first action.

In some examples, an indication that the vehicle is on a one way road may be obtained, and in response to the determination that the person is performing the first action of the first type on the at least one of the two sides of the environment of the vehicle, to the identification that the at least one of the two sides of the environment of the vehicle is the first side of the environment of the vehicle, and to the indication that the vehicle is on a one way road, performing the second action may be withheld and/or forgone. For example, the one or more images may be analyzed to obtain the indication that the vehicle is on a one way road.

In some examples, the one or more images may be analyzed to identify a property of the person performing the first action, and the second action may be selected based on the identified property of the person performing the first action. In some examples, the one or more images may be analyzed to identify a property of the first action, and the second action may be selected based on the identified property of the first action. In some examples, the one or more images may be analyzed to identify a property of a road in the environment of the vehicle, and the second action may be selected based on the identified property of the road.

In some embodiments, systems, methods and non-transitory computer readable media for selectively forgoing actions based on presence of people in a vicinity of containers are provided.

In some embodiments, one or more images captured using one or more image sensors and depicting at least part of a container may be obtained. Further, in some examples, the one or more images may be analyzed to determine whether at least one person is presence in a vicinity of the container. Further, in response to a determination that no person is presence in the vicinity of the container, a performance of a first action associated with the container may be caused, and in response to a determination that at least one person is presence in the vicinity of the container, causing the performance of the first action may be withheld and/or forgone.

In some examples, the one or more image sensors may be configured to be mounted to a vehicle, and the first action may comprise adjusting a route of the vehicle to bring the vehicle to a selected position with respect to the container. In some examples, the container may be a trash can, and the first action may comprise emptying the trash can. In some examples, the container may be a trash can, the one or more image sensors may be configured to be mounted to a garbage truck, and the first action may comprise collecting the content of the trash can with the garbage truck. In some examples, the first action may comprise moving at least part of the container. In some examples, the first action may comprise obtaining one or more objects placed within the container. In some examples, the first action may comprise placing one or more objects in the container. In some examples, the first action may comprise changing a physical state of the container.

In some examples, the one or more images may be analyzed to determine whether at least one person presence in the vicinity of the container belongs to a first group of people, in response to a determination that the at least one person presence in the vicinity of the container belongs to the first group of people, the performance of the first action involving the container may be caused, and in response to a determination that the at least one person presence in the vicinity of the container does not belong to the first group of people, causing the performance of the first action may be withheld and/or forgone. For example, the first group of people may be determined based on a type of the container. In one example, the one or more images may be analyzed to determine the type of the container.

In some examples, the one or more images may be analyzed to determine whether at least one person presence in the vicinity of the container uses suitable safety equipment, in response to a determination that the at least one person presence in the vicinity of the container uses suitable safety equipment, the performance of the first action involving the container may be caused, and in response to a determination that the at least one person presence in the vicinity of the container does not use suitable safety equipment, causing the performance of the first action may be withheld and/or forgone. For example, the suitable safety equipment may be determined based on a type of the container. In one example, the one or more images may be analyzed to determine the type of the container.

In some examples, the one or more images may be analyzed to determine whether at least one person presence in the vicinity of the container follows suitable safety procedures, in response to a determination that the at least one person presence in the vicinity of the container follows suitable safety procedures, the performance of the first action involving the container may be caused, and in response to a determination that the at least one person presence in the vicinity of the container does not follow suitable safety procedures, causing the performance of the first action may be withheld and/or forgone. For example, the suitable safety procedures may be determined based on a type of the container. In one example, the one or more images may be analyzed to determine the type of the container.

In some examples, causing the performance of a first action associated with the container may comprise providing information to a user, the provided information may be configured to cause the user to perform the first action. In some examples, causing the performance of a first action associated with the container may comprise providing information to an external system, the provided information may be configured to cause the external system to perform the first action.

In some embodiments, systems, methods and non-transitory computer readable media for providing information based on detection of actions that are undesired to waste collection workers are provided.

In some embodiments, one or more images captured using one or more image sensors from an environment of a garbage truck may be obtained. Further, in some examples, the one or more images may be analyzed to detect a waste collection worker in the environment of the garbage truck. Further, in some examples, the one or more images may be analyzed to determine whether the waste collection worker performs an action that is undesired to the waste collection worker. Further, in some examples, in response to a determination that the waste collection worker performs an action that is undesired to the waste collection worker, first information may be provided. For example, the action that the waste collection worker performs and is undesired to the waste collection worker may comprise misusing safety equipment. In another example, the action that the waste collection worker performs and is undesired to the waste collection worker may comprise neglecting using safety equipment. In yet another example, the action that the waste collection worker performs and is undesired to the waste collection worker may comprise placing a hand of the waste collection worker near an eye of the waste collection worker. In an additional example, the action that the waste collection worker performs and is undesired to the waste collection worker may comprise placing a hand of the waste collection worker near a mouth of the waste collection worker. In yet another example, the action that the waste collection worker performs and is undesired to the waste collection worker may comprise placing a hand of the waste collection worker near an ear of the waste collection worker. In an additional example, the action that the waste collection worker performs and is undesired to the waste collection worker may comprise performing a first action without a mechanical aid that is proper for the first action. In yet another example, the action that the waste collection worker performs and is undesired to the waste collection worker may comprise lifting an object that should be rolled. In an additional example, the action that the waste collection worker performs and is undesired to the waste collection worker may comprise performing a first action using an undesired technique (for example, the undesired technique may comprise working asymmetrically, the undesired technique may comprise not keeping proper footing when handling an object, and so forth). In another example, the action that the waste collection worker performs and is undesired to the waste collection worker may comprise throwing a sharp object. In one example, the provided first information may be provided to the waste collection worker. In one example, the provided first information may be provided to a supervisor of the waste collection worker. In one example, the provided first information may be provided to a driver of the garbage truck. In one example, the provided first information may be configured to cause an update to statistical information associated with the waste collection worker.

In some examples, the one or more images may be analyzed to identify a property of the action that the waste collection worker performs and is undesired to the waste collection worker, in response to a first identified property of the action that the waste collection worker performs and is undesired to the waste collection worker, the first information may be provided, and in response to a second identified property of the action that the waste collection worker performs and is undesired to the waste collection worker, providing the first information may be withheld and/or forgone.

In some examples, the one or more images may be analyzed to determine that the waste collection worker places a hand of the waste collection worker on an eye of the waste collection worker for a first time duration, the first time duration may be compared with a selected time threshold, in response to the first time duration being longer than the selected time threshold, the first information may be provided, and in response to the first time duration being shorter than the selected time threshold, providing the first information may be withheld and/or forgone.

In some examples, the one or more images may be analyzed to determine that the waste collection worker places a hand of the waste collection worker at a first distance from an eye of the waste collection worker, the first distance may be compared with a selected distance threshold, in response to the first distance being shorter than the selected distance threshold, the first information may be provided, and in response to the first distance being longer than the selected distance threshold, providing the first information may be withheld and/or forgone.

In some embodiments, systems, methods and non-transitory computer readable media for providing information based on amounts of waste are provided.

In some embodiments, a measurement of an amount of waste collected to a garbage truck from a particular trash can may be obtained. Further, in some examples, identifying information associated with the particular trash can may be obtained. Further, in some examples, an update to a ledger based on the obtained measurement of the amount of waste collected to the garbage truck from the particular trash can and on the identifying information associated with the particular trash can may be caused. For example, the measurement of the amount of waste collected to the garbage truck from the particular trash can may be based on an analysis of an image of the waste collected to the garbage truck from the particular trash can. In another example, the measurement of the amount of waste collected to the garbage truck from the particular trash can may be based on an analysis of a signal transmitted by the particular trash can. In yet another example, the measurement of the amount of waste collected to the garbage truck from the particular trash can may be based on an analysis of one or more weight measurements performed by the garbage truck. In an additional example, the measurement of the amount of waste collected to the garbage truck from the particular trash can may be based on an analysis of one or more volume measurements performed by the garbage truck. In yet another example, the measurement of the amount of waste collected to the garbage truck from the particular trash can may be based on an analysis of one or more weight measurements performed by the particular trash can. In an additional example, the measurement of the amount of waste collected to the garbage truck from the particular trash can may be based on an analysis of one or more volume measurements performed by the particular trash can. In one example, the measurement of the amount of waste collected to the garbage truck from the particular trash can may be a measurement of a weight of waste collected to the garbage truck from the particular trash can. In another example, the measurement of the amount of waste collected to the garbage truck from the particular trash can may be a measurement of a volume of waste collected to the garbage truck from the particular trash can. In one example, the identifying information may comprise a unique identifier of the particular trash can. In another example, the identifying information may comprise an identifier of a user of the particular trash can. In yet another example, the identifying information may comprise an identifier of an owner of the particular trash can. In an additional example, the identifying information may comprise an identifier of a residential unit associated with the particular trash can. In yet another example, the identifying information may comprise an identifier of an office unit associated with the particular trash can. In one example, the identifying information may be based on an analysis of an image of the particular trash can. In another example, the identifying information may be based on an analysis of a signal transmitted by the particular trash can.

In some examples, a second measurement of a second amount of waste collected to a second garbage truck from the particular trash can may be obtained, a sum of the obtained measurement of the amount of waste collected to the garbage truck from the particular trash can and the obtained second measurement of the second amount of waste collected to the second garbage truck from the particular trash can may be calculated, and an update to the ledger based on the calculated sum and on the identifying information associated with the particular trash can may be caused.

In some examples, a second measurement of a second amount of waste collected to the garbage truck from a second trash can may be obtained, second identifying information associated with the second trash can may be obtained, the identifying information associated with the particular trash can and the second identifying information associated with the second trash can may be used to determine that a common entity is associated with both the particular trash can and the second trash can, a sum of the obtained measurement of the amount of waste collected to the garbage truck from the particular trash can and the obtained second measurement of the second amount of waste collected to the garbage truck from the second trash can may be calculated, and an update to a record of the ledger associated with the common entity based on the calculated sum may be caused.

Consistent with other disclosed embodiments, non-transitory computer-readable medium may store software program and/or data and/or computer implementable instructions for carrying out any of the methods described herein.

The foregoing general description and the following detailed description are exemplary and explanatory only and are not restrictive of the claims.

### BRIEF DESCRIPTION OF THE DRAWINGS

FIGS. 1A and 1B are block diagrams illustrating some possible implementations of a communicating system.

FIGS. 2A and 2B are block diagrams illustrating some possible implementations of an apparatus.

FIG. 3 is a block diagram illustrating a possible implementation of a server.

FIGS. 4A and 4B are block diagrams illustrating some possible implementations of a cloud platform.

FIG. 5 is a block diagram illustrating a possible implementation of a computational node.

FIG. 6 is a schematic illustration of example an environment of a road consistent with an embodiment of the present disclosure.

FIGS. 7A and 7B are schematic illustrations of some possible vehicles consistent with an embodiment of the present disclosure.

FIG. 8 illustrates an example of a method for adjusting vehicles routes based on absent of items.

FIGS. 9A, 9B, 9C, 9D, 9E and 9F are schematic illustrations of some possible trash cans consistent with an embodiment of the present disclosure.

FIGS. 9G and 9H are schematic illustrations of content of trash cans consistent with an embodiment of the present disclosure.

FIG. 10 illustrates an example of a method for providing information about trash cans.

FIG. 11 illustrates an example of a method for selectively forgoing actions based on fullness level of containers.

FIG. 12 illustrates an example of a method for selectively forgoing actions based on the content of containers.

FIG. 13 illustrates an example of a method for restricting movement of vehicles.

FIGS. 14A and 14B are schematic illustrations of some possible vehicles consistent with an embodiment of the present disclosure.

FIG. 15 illustrates an example of a method for monitoring activities around vehicles.

FIG. 16 illustrates an example of a method for selectively forgoing actions based on presence of people in a vicinity of containers.

FIG. 17 illustrates an example of a method for providing information based on detection of actions that are undesired to waste collection workers.

FIG. 18 illustrates an example of a method for providing information based on amounts of waste.

### DESCRIPTION

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, “applying”, “obtaining”, “monitoring”, “providing”, “identifying”, “segmenting”, “classifying”, “analyzing”, “associating”, “extracting”, “storing”, “receiving”, “transmitting”, or the like, include action and/or processes of a computer that manipulate and/or transform data into other data, said data represented as physical quantities, for example such as electronic quantities, and/or said data representing the physical objects. The terms “computer”, “processor”, “controller”, “processing unit”, “computing unit”, and “processing module” should be expansively construed to cover any kind of electronic device, component or unit with data processing capabilities, including, by way of non-limiting example, a personal computer, a wearable computer, a tablet, a smartphone, a server, a computing system, a cloud computing platform, a communication device, a processor (for example, digital signal processor (DSP), an image signal processor (ISR), a microcontroller, a field programmable gate array (FPGA), an application specific integrated circuit (ASIC), a central processing unit (CPA), a graphics processing unit (GPU), a visual processing unit (VPU), and so on), possibly with embedded memory, a single core processor, a multi core processor, a core within a processor, any other electronic computing device, or any combination of the above.

The operations in accordance with the teachings herein may be performed by a computer specially constructed or programmed to perform the described functions.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) may be included in at least one embodiment of the presently disclosed subject matter. Thus the appearance of the phrase “one case”, “some cases”, “other cases” or variants thereof does not necessarily refer to the same embodiment(s). As used herein, the term “and/or” includes any and all combinations of one or more of the associated listed items.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

The term “image sensor” is recognized by those skilled in the art and refers to any device configured to capture images, a sequence of images, videos, and so forth. This includes sensors that convert optical input into images, where optical input can be visible light (like in a camera), radio waves, microwaves, terahertz waves, ultraviolet light, infrared light, x-rays, gamma rays, and/or any other light spectrum. This also includes both 2D and 3D sensors. Examples of image sensor technologies may include: CCD, CMOS, NMOS, and so forth. 3D sensors may be implemented using different technologies, including: stereo camera, active stereo camera, time of flight camera, structured light camera, radar, range image camera, and so forth.

In embodiments of the presently disclosed subject matter, one or more stages illustrated in the figures may be executed in a different order and/or one or more groups of stages may be executed simultaneously and vice versa. The figures illustrate a general schematic of the system architecture in accordance embodiments of the presently disclosed subject matter. Each module in the figures can be made up of any combination of software, hardware and/or firmware that performs the functions as defined and explained herein. The modules in the figures may be centralized in one location or dispersed over more than one location.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings.

The drawings in this document may not be to any scale. Different figures may use different scales and different scales can be used even within the same drawing, for example different scales for different views of the same object or different scales for the two adjacent objects.

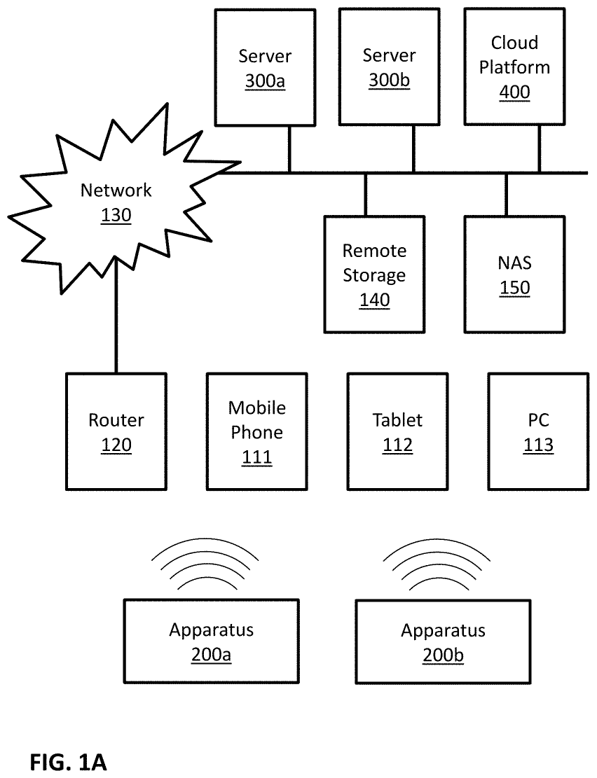

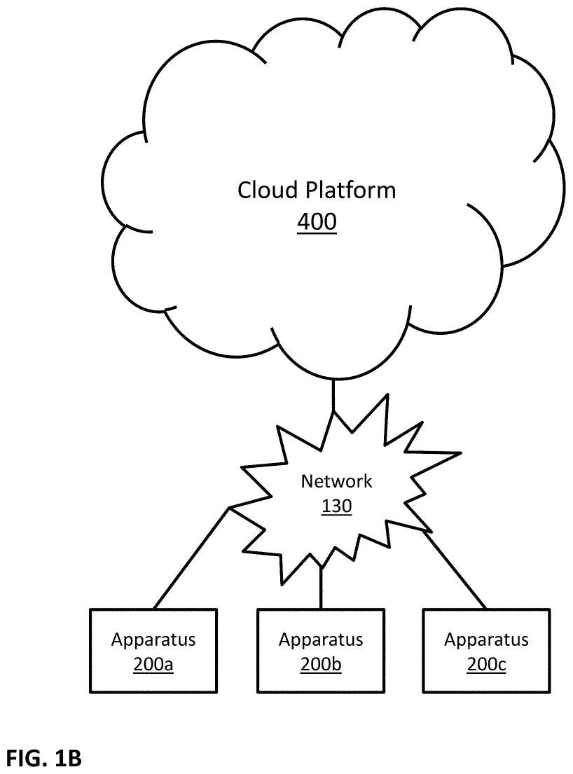

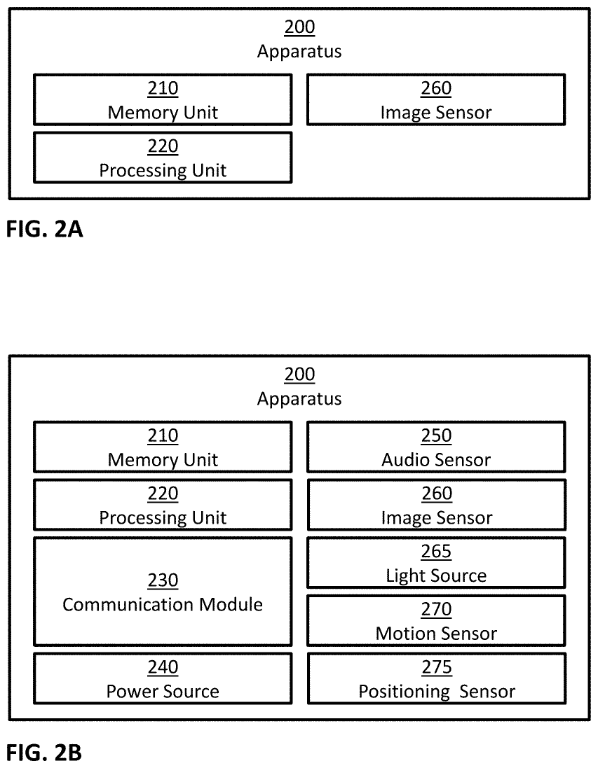

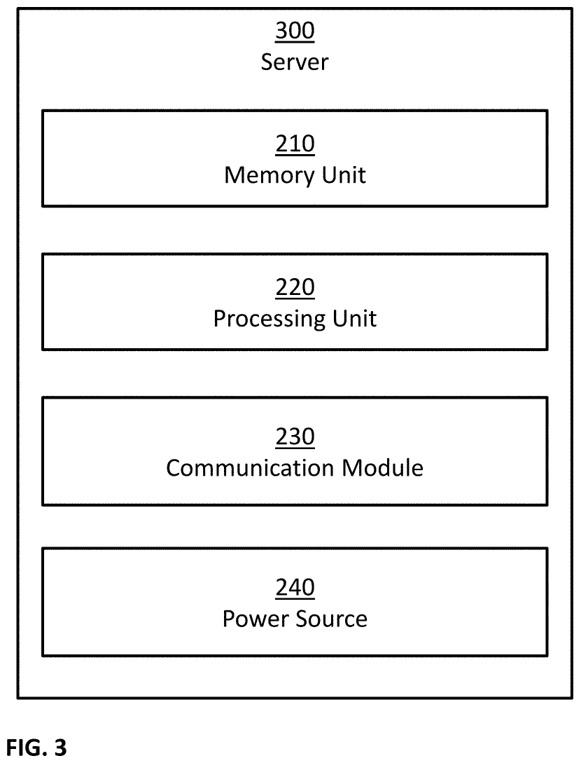

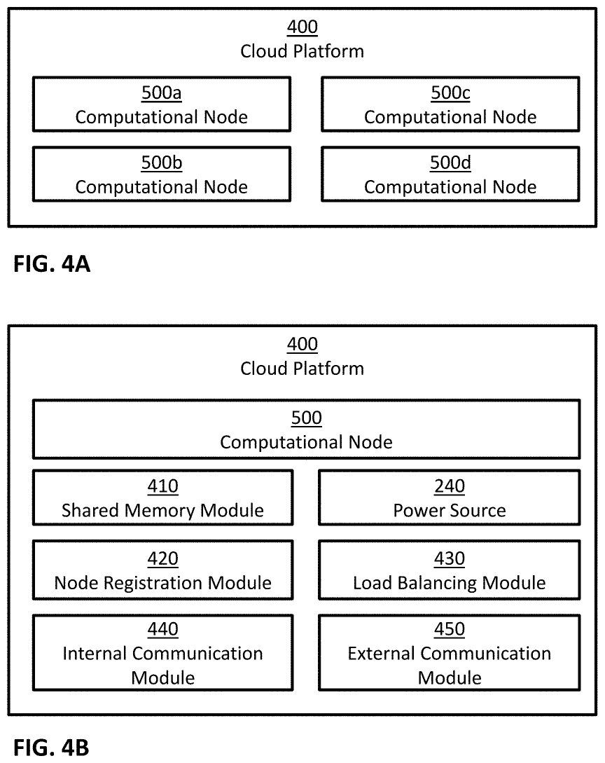

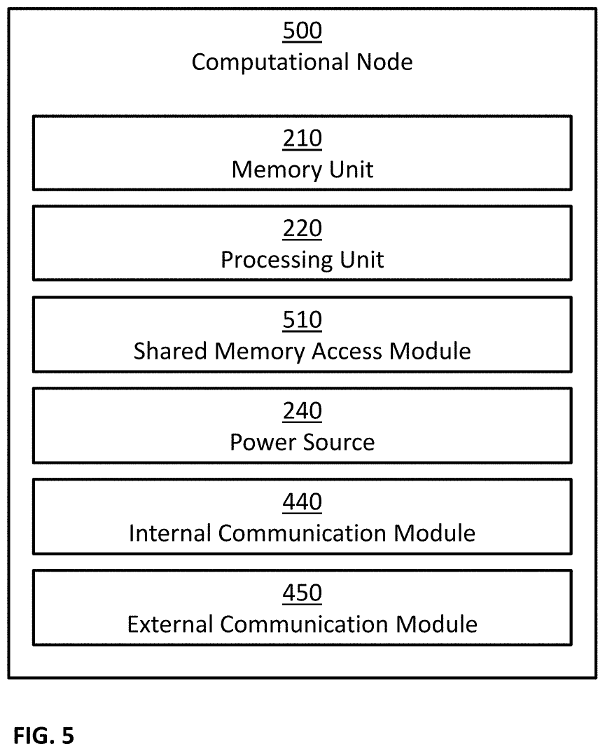

FIG. 1A is a block diagram illustrating a possible implementation of a communicating system. In this example, apparatuses 200a and 200b may communicate with server 300a, with server 300b, with cloud platform 400, with each other, and so forth. Possible implementations of apparatuses 200a and 200b may include apparatus 200 as described in FIGS. 2A and 2B. Possible implementations of servers 300a and 300b may include server 300 as described in FIG. 3. Some possible implementations of cloud platform 400 are described in FIGS. 4A, 4B and 5. In this example apparatuses 200a and 200b may communicate directly with mobile phone 111, tablet 112, and personal computer (PC) 113. Apparatuses 200a and 200b may communicate with local router 120 directly, and/or through at least one of mobile phone 111, tablet 112, and personal computer (PC) 113. In this example, local router 120 may be connected with a communication network 130. Examples of communication network 130 may include the Internet, phone networks, cellular networks, satellite communication networks, private communication networks, virtual private networks (VPN), and so forth. Apparatuses 200a and 200b may connect to communication network 130 through local router 120 and/or directly. Apparatuses 200a and 200b may communicate with other devices, such as servers 300a, server 300b, cloud platform 400, remote storage 140 and network attached storage (NAS) 150, through communication network 130 and/or directly.

FIG. 1B is a block diagram illustrating a possible implementation of a communicating system. In this example, apparatuses 200a, 200b and 200c may communicate with cloud platform 400 and/or with each other through communication network 130. Possible implementations of apparatuses 200a, 200b and 200c may include apparatus 200 as described in FIGS. 2A and 2B. Some possible implementations of cloud platform 400 are described in FIGS. 4A, 4B and 5.

FIGS. 1A and 1B illustrate some possible implementations of a communication system. In some embodiments, other communication systems that enable communication between apparatus 200 and server 300 may be used. In some embodiments, other communication systems that enable communication between apparatus 200 and cloud platform 400 may be used. In some embodiments, other communication systems that enable communication among a plurality of apparatuses 200 may be used.

FIG. 2A is a block diagram illustrating a possible implementation of apparatus 200. In this example, apparatus 200 may comprise: one or more memory units 210, one or more processing units 220, and one or more image sensors 260. In some implementations, apparatus 200 may comprise additional components, while some components listed above may be excluded.

FIG. 2B is a block diagram illustrating a possible implementation of apparatus 200. In this example, apparatus 200 may comprise: one or more memory units 210, one or more processing units 220, one or more communication modules 230, one or more power sources 240, one or more audio sensors 250, one or more image sensors 260, one or more light sources 265, one or more motion sensors 270, and one or more positioning sensors 275. In some implementations, apparatus 200 may comprise additional components, while some components listed above may be excluded. For example, in some implementations apparatus 200 may also comprise at least one of the following: one or more barometers; one or more user input devices; one or more output devices; and so forth. In another example, in some implementations at least one of the following may be excluded from apparatus 200: memory units 210, communication modules 230, power sources 240, audio sensors 250, image sensors 260, light sources 265, motion sensors 270, and positioning sensors 275.

In some embodiments, one or more power sources 240 may be configured to: power apparatus 200; power server 300; power cloud platform 400; and/or power computational node 500. Possible implementation examples of power sources 240 may include: one or more electric batteries; one or more capacitors; one or more connections to external power sources; one or more power convertors; any combination of the above; and so forth.

In some embodiments, the one or more processing units 220 may be configured to execute software programs. For example, processing units 220 may be configured to execute software programs stored on the memory units 210. In some cases, the executed software programs may store information in memory units 210. In some cases, the executed software programs may retrieve information from the memory units 210. Possible implementation examples of the processing units 220 may include: one or more single core processors, one or more multicore processors; one or more controllers; one or more application processors; one or more system on a chip processors; one or more central processing units; one or more graphical processing units; one or more neural processing units; any combination of the above; and so forth.

In some embodiments, the one or more communication modules 230 may be configured to receive and transmit information. For example, control signals may be transmitted and/or received through communication modules 230. In another example, information received though communication modules 230 may be stored in memory units 210. In an additional example, information retrieved from memory units 210 may be transmitted using communication modules 230. In another example, input data may be transmitted and/or received using communication modules 230. Examples of such input data may include: input data inputted by a user using user input devices; information captured using one or more sensors; and so forth. Examples of such sensors may include: audio sensors 250; image sensors 260; motion sensors 270; positioning sensors 275; chemical sensors; temperature sensors; barometers; and so forth.

In some embodiments, the one or more audio sensors 250 may be configured to capture audio by converting sounds to digital information. Some non-limiting examples of audio sensors 250 may include: microphones, unidirectional microphones, bidirectional microphones, cardioid microphones, omnidirectional microphones, onboard microphones, wired microphones, wireless microphones, any combination of the above, and so forth. In some examples, the captured audio may be stored in memory units 210. In some additional examples, the captured audio may be transmitted using communication modules 230, for example to other computerized devices, such as server 300, cloud platform 400, computational node 500, and so forth. In some examples, processing units 220 may control the above processes. For example, processing units 220 may control at least one of: capturing of the audio; storing the captured audio; transmitting of the captured audio; and so forth. In some cases, the captured audio may be processed by processing units 220. For example, the captured audio may be compressed by processing units 220; possibly followed: by storing the compressed captured audio in memory units 210; by transmitted the compressed captured audio using communication modules 230; and so forth. In another example, the captured audio may be processed using speech recognition algorithms. In another example, the captured audio may be processed using speaker recognition algorithms.

In some embodiments, the one or more image sensors 260 may be configured to capture visual information by converting light to: images; sequence of images; videos; 3D images; sequence of 3D images; 3D videos; and so forth. In some examples, the captured visual information may be stored in memory units 210. In some additional examples, the captured visual information may be transmitted using communication modules 230, for example to other computerized devices, such as server 300, cloud platform 400, computational node 500, and so forth. In some examples, processing units 220 may control the above processes. For example, processing units 220 may control at least one of: capturing of the visual information; storing the captured visual information; transmitting of the captured visual information; and so forth. In some cases, the captured visual information may be processed by processing units 220. For example, the captured visual information may be compressed by processing units 220; possibly followed: by storing the compressed captured visual information in memory units 210; by transmitted the compressed captured visual information using communication modules 230; and so forth. In another example, the captured visual information may be processed in order to: detect objects, detect events, detect action, detect face, detect people, recognize person, and so forth.

In some embodiments, the one or more light sources 265 may be configured to emit light, for example in order to enable better image capturing by image sensors 260. In some examples, the emission of light may be coordinated with the capturing operation of image sensors 260. In some examples, the emission of light may be continuous. In some examples, the emission of light may be performed at selected times. The emitted light may be visible light, infrared light, x-rays, gamma rays, and/or in any other light spectrum. In some examples, image sensors 260 may capture light emitted by light sources 265, for example in order to capture 3D images and/or 3D videos using active stereo method.

In some embodiments, the one or more motion sensors 270 may be configured to perform at least one of the following: detect motion of objects in the environment of apparatus 200; measure the velocity of objects in the environment of apparatus 200; measure the acceleration of objects in the environment of apparatus 200; detect motion of apparatus 200; measure the velocity of apparatus 200; measure the acceleration of apparatus 200; and so forth. In some implementations, the one or more motion sensors 270 may comprise one or more accelerometers configured to detect changes in proper acceleration and/or to measure proper acceleration of apparatus 200. In some implementations, the one or more motion sensors 270 may comprise one or more gyroscopes configured to detect changes in the orientation of apparatus 200 and/or to measure information related to the orientation of apparatus 200. In some implementations, motion sensors 270 may be implemented using image sensors 260, for example by analyzing images captured by image sensors 260 to perform at least one of the following tasks: track objects in the environment of apparatus 200; detect moving objects in the environment of apparatus 200; measure the velocity of objects in the environment of apparatus 200; measure the acceleration of objects in the environment of apparatus 200; measure the velocity of apparatus 200, for example by calculating the egomotion of image sensors 260; measure the acceleration of apparatus 200, for example by calculating the egomotion of image sensors 260; and so forth. In some implementations, motion sensors 270 may be implemented using image sensors 260 and light sources 265, for example by implementing a LIDAR using image sensors 260 and light sources 265. In some implementations, motion sensors 270 may be implemented using one or more RADARs. In some examples, information captured using motion sensors 270: may be stored in memory units 210, may be processed by processing units 220, may be transmitted and/or received using communication modules 230, and so forth.

In some embodiments, the one or more positioning sensors 275 may be configured to obtain positioning information of apparatus 200, to detect changes in the position of apparatus 200, and/or to measure the position of apparatus 200. In some examples, positioning sensors 275 may be implemented using one of the following technologies: Global Positioning System (GPS), GLObal NAvigation Satellite System (GLONASS), Galileo global navigation system, BeiDou navigation system, other Global Navigation Satellite Systems (GNSS), Indian Regional Navigation Satellite System (IRNSS), Local Positioning Systems (LPS), Real-Time Location Systems (RTLS), Indoor Positioning System (IPS), Wi-Fi based positioning systems, cellular triangulation, and so forth. In some examples, information captured using positioning sensors 275 may be stored in memory units 210, may be processed by processing units 220, may be transmitted and/or received using communication modules 230, and so forth.

In some embodiments, the one or more chemical sensors may be configured to perform at least one of the following: measure chemical properties in the environment of apparatus 200; measure changes in the chemical properties in the environment of apparatus 200; detect the present of chemicals in the environment of apparatus 200; measure the concentration of chemicals in the environment of apparatus 200. Examples of such chemical properties may include: pH level, toxicity, temperature, and so forth. Examples of such chemicals may include: electrolytes, particular enzymes, particular hormones, particular proteins, smoke, carbon dioxide, carbon monoxide, oxygen, ozone, hydrogen, hydrogen sulfide, and so forth. In some examples, information captured using chemical sensors may be stored in memory units 210, may be processed by processing units 220, may be transmitted and/or received using communication modules 230, and so forth.

In some embodiments, the one or more temperature sensors may be configured to detect changes in the temperature of the environment of apparatus 200 and/or to measure the temperature of the environment of apparatus 200. In some examples, information captured using temperature sensors may be stored in memory units 210, may be processed by processing units 220, may be transmitted and/or received using communication modules 230, and so forth.

In some embodiments, the one or more barometers may be configured to detect changes in the atmospheric pressure in the environment of apparatus 200 and/or to measure the atmospheric pressure in the environment of apparatus 200. In some examples, information captured using the barometers may be stored in memory units 210, may be processed by processing units 220, may be transmitted and/or received using communication modules 230, and so forth.

In some embodiments, the one or more user input devices may be configured to allow one or more users to input information. In some examples, user input devices may comprise at least one of the following: a keyboard, a mouse, a touch pad, a touch screen, a joystick, a microphone, an image sensor, and so forth. In some examples, the user input may be in the form of at least one of: text, sounds, speech, hand gestures, body gestures, tactile information, and so forth. In some examples, the user input may be stored in memory units 210, may be processed by processing units 220, may be transmitted and/or received using communication modules 230, and so forth.

In some embodiments, the one or more user output devices may be configured to provide output information to one or more users. In some examples, such output information may comprise of at least one of: notifications, feedbacks, reports, and so forth. In some examples, user output devices may comprise at least one of: one or more audio output devices; one or more textual output devices; one or more visual output devices; one or more tactile output devices; and so forth. In some examples, the one or more audio output devices may be configured to output audio to a user, for example through: a headset, a set of speakers, and so forth. In some examples, the one or more visual output devices may be configured to output visual information to a user, for example through: a display screen, an augmented reality display system, a printer, a LED indicator, and so forth. In some examples, the one or more tactile output devices may be configured to output tactile feedbacks to a user, for example through vibrations, through motions, by applying forces, and so forth. In some examples, the output may be provided: in real time, offline, automatically, upon request, and so forth. In some examples, the output information may be read from memory units 210, may be provided by a software executed by processing units 220, may be transmitted and/or received using communication modules 230, and so forth.

FIG. 3 is a block diagram illustrating a possible implementation of server 300. In this example, server 300 may comprise: one or more memory units 210, one or more processing units 220, one or more communication modules 230, and one or more power sources 240. In some implementations, server 300 may comprise additional components, while some components listed above may be excluded. For example, in some implementations server 300 may also comprise at least one of the following: one or more user input devices; one or more output devices; and so forth. In another example, in some implementations at least one of the following may be excluded from server 300: memory units 210, communication modules 230, and power sources 240.

FIG. 4A is a block diagram illustrating a possible implementation of cloud platform 400. In this example, cloud platform 400 may comprise computational node 500a, computational node 500b, computational node 500c and computational node 500d. In some examples, a possible implementation of computational nodes 500a, 500b, 500c and 500d may comprise server 300 as described in FIG. 3. In some examples, a possible implementation of computational nodes 500a, 500b, 500c and 500d may comprise computational node 500 as described in FIG. 5.

FIG. 4B is a block diagram illustrating a possible implementation of cloud platform 400. In this example, cloud platform 400 may comprise: one or more computational nodes 500, one or more shared memory modules 410, one or more power sources 240, one or more node registration modules 420, one or more load balancing modules 430, one or more internal communication modules 440, and one or more external communication modules 450. In some implementations, cloud platform 400 may comprise additional components, while some components listed above may be excluded. For example, in some implementations cloud platform 400 may also comprise at least one of the following: one or more user input devices; one or more output devices; and so forth. In another example, in some implementations at least one of the following may be excluded from cloud platform 400: shared memory modules 410, power sources 240, node registration modules 420, load balancing modules 430, internal communication modules 440, and external communication modules 450.

FIG. 5 is a block diagram illustrating a possible implementation of computational node 500. In this example, computational node 500 may comprise: one or more memory units 210, one or more processing units 220, one or more shared memory access modules 510, one or more power sources 240, one or more internal communication modules 440, and one or more external communication modules 450. In some implementations, computational node 500 may comprise additional components, while some components listed above may be excluded. For example, in some implementations computational node 500 may also comprise at least one of the following: one or more user input devices; one or more output devices; and so forth. In another example, in some implementations at least one of the following may be excluded from computational node 500: memory units 210, shared memory access modules 510, power sources 240, internal communication modules 440, and external communication modules 450.

In some embodiments, internal communication modules 440 and external communication modules 450 may be implemented as a combined communication module, such as communication modules 230. In some embodiments, one possible implementation of cloud platform 400 may comprise server 300. In some embodiments, one possible implementation of computational node 500 may comprise server 300. In some embodiments, one possible implementation of shared memory access modules 510 may comprise using internal communication modules 440 to send information to shared memory modules 410 and/or receive information from shared memory modules 410. In some embodiments, node registration modules 420 and load balancing modules 430 may be implemented as a combined module.

In some embodiments, the one or more shared memory modules 410 may be accessed by more than one computational node. Therefore, shared memory modules 410 may allow information sharing among two or more computational nodes 500. In some embodiments, the one or more shared memory access modules 510 may be configured to enable access of computational nodes 500 and/or the one or more processing units 220 of computational nodes 500 to shared memory modules 410. In some examples, computational nodes 500 and/or the one or more processing units 220 of computational nodes 500, may access shared memory modules 410, for example using shared memory access modules 510, in order to perform at least one of: executing software programs stored on shared memory modules 410, store information in shared memory modules 410, retrieve information from the shared memory modules 410.

In some embodiments, the one or more node registration modules 420 may be configured to track the availability of the computational nodes 500. In some examples, node registration modules 420 may be implemented as: a software program, such as a software program executed by one or more of the computational nodes 500; a hardware solution; a combined software and hardware solution; and so forth. In some implementations, node registration modules 420 may communicate with computational nodes 500, for example using internal communication modules 440. In some examples, computational nodes 500 may notify node registration modules 420 of their status, for example by sending messages: at computational node 500 startup; at computational node 500 shutdown; at constant intervals; at selected times; in response to queries received from node registration modules 420; and so forth. In some examples, node registration modules 420 may query about computational nodes 500 status, for example by sending messages: at node registration module 420 startup; at constant intervals; at selected times; and so forth.

In some embodiments, the one or more load balancing modules 430 may be configured to divide the work load among computational nodes 500. In some examples, load balancing modules 430 may be implemented as: a software program, such as a software program executed by one or more of the computational nodes 500; a hardware solution; a combined software and hardware solution; and so forth. In some implementations, load balancing modules 430 may interact with node registration modules 420 in order to obtain information regarding the availability of the computational nodes 500. In some implementations, load balancing modules 430 may communicate with computational nodes 500, for example using internal communication modules 440. In some examples, computational nodes 500 may notify load balancing modules 430 of their status, for example by sending messages: at computational node 500 startup; at computational node 500 shutdown; at constant intervals; at selected times; in response to queries received from load balancing modules 430; and so forth. In some examples, load balancing modules 430 may query about computational nodes 500 status, for example by sending messages: at load balancing module 430 startup; at constant intervals; at selected times; and so forth.

In some embodiments, the one or more internal communication modules 440 may be configured to receive information from one or more components of cloud platform 400, and/or to transmit information to one or more components of cloud platform 400. For example, control signals and/or synchronization signals may be sent and/or received through internal communication modules 440. In another example, input information for computer programs, output information of computer programs, and/or intermediate information of computer programs, may be sent and/or received through internal communication modules 440. In another example, information received though internal communication modules 440 may be stored in memory units 210, in shared memory units 410, and so forth. In an additional example, information retrieved from memory units 210 and/or shared memory units 410 may be transmitted using internal communication modules 440. In another example, input data may be transmitted and/or received using internal communication modules 440. Examples of such input data may include input data inputted by a user using user input devices.

In some embodiments, the one or more external communication modules 450 may be configured to receive and/or to transmit information. For example, control signals may be sent and/or received through external communication modules 450. In another example, information received though external communication modules 450 may be stored in memory units 210, in shared memory units 410, and so forth. In an additional example, information retrieved from memory units 210 and/or shared memory units 410 may be transmitted using external communication modules 450. In another example, input data may be transmitted and/or received using external communication modules 450. Examples of such input data may include: input data inputted by a user using user input devices; information captured from the environment of apparatus 200 using one or more sensors; and so forth. Examples of such sensors may include: audio sensors 250; image sensors 260; motion sensors 270; positioning sensors 275; chemical sensors; temperature sensors; barometers; and so forth.

In some embodiments, a method, such as methods 800, 1000, 1100, 1200, 1300, 1500, 1600, 1700, 1800 etc., may comprise of one or more steps. In some examples, a method, as well as all individual steps therein, may be performed by various aspects of apparatus 200, server 300, cloud platform 400, computational node 500, and so forth. For example, the method may be performed by processing units 220 executing software instructions stored within memory units 210 and/or within shared memory modules 410. In some examples, a method, as well as all individual steps therein, may be performed by a dedicated hardware. In some examples, computer readable medium (such as a non-transitory computer readable medium) may store data and/or computer implementable instructions for carrying out a method. Some non-limiting examples of possible execution manners of a method may include continuous execution (for example, returning to the beginning of the method once the method normal execution ends), periodically execution, executing the method at selected times, execution upon the detection of a trigger (some non-limiting examples of such trigger may include a trigger from a user, a trigger from another method, a trigger from an external device, etc.), and so forth.

In some embodiments, machine learning algorithms (also referred to as machine learning models in the present disclosure) may be trained using training examples, for example in the cases described below. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear algorithms, non-linear algorithms, ensemble algorithms, and so forth. For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by an process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

In some embodiments, trained machine learning algorithms (also referred to as trained machine learning models in the present disclosure) may be used to analyze inputs and generate outputs, for example in the cases described below. In some examples, a trained machine learning algorithm may be used as an inference model that when provided with an input generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value for the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an image, and the inferred output may include a classification of an item depicted in the image. In yet another example, a trained machine learning algorithm may include a regression model, the input may include an image, and the inferred output may include an inferred value for an item depicted in the image (such as an estimated property of the item, such as size, volume, age of a person depicted in the image, cost of a product depicted in the image, and so forth). In an additional example, a trained machine learning algorithm may include an image segmentation model, the input may include an image, and the inferred output may include a segmentation of the image. In yet another example, a trained machine learning algorithm may include an object detector, the input may include an image, and the inferred output may include one or more detected objects in the image and/or one or more locations of objects within the image. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs. Some non-limiting examples of such artificial neural networks may comprise shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the an artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

In some embodiments, analyzing one or more images, for example by Step 820, Step 1020, Step 1120, Step 1220, Step 1320, Step 1350, Step 1520, Step 1530, Step 1620, Step 1720, Step 1730, etc., may comprise analyzing the one or more images to obtain a preprocessed image data, and subsequently analyzing the one or more images and/or the preprocessed image data to obtain the desired outcome. One of ordinary skill in the art will recognize that the followings are examples, and that the one or more images may be preprocessed using other kinds of preprocessing methods. In some examples, the one or more images may be preprocessed by transforming the one or more images using a transformation function to obtain a transformed image data, and the preprocessed image data may comprise the transformed image data. For example, the transformed image data may comprise one or more convolutions of the one or more images. For example, the transformation function may comprise one or more image filters, such as low-pass filters, high-pass filters, band-pass filters, all-pass filters, and so forth. In some examples, the transformation function may comprise a nonlinear function. In some examples, the one or more images may be preprocessed by smoothing at least parts of the one or more images, for example using Gaussian convolution, using a median filter, and so forth. In some examples, the one or more images may be preprocessed to obtain a different representation of the one or more images. For example, the preprocessed image data may comprise: a representation of at least part of the one or more images in a frequency domain; a Discrete Fourier Transform of at least part of the one or more images; a Discrete Wavelet Transform of at least part of the one or more images; a time/frequency representation of at least part of the one or more images; a representation of at least part of the one or more images in a lower dimension; a lossy representation of at least part of the one or more images; a lossless representation of at least part of the one or more images; a time ordered series of any of the above; any combination of the above; and so forth. In some examples, the one or more images may be preprocessed to extract edges, and the preprocessed image data may comprise information based on and/or related to the extracted edges. In some examples, the one or more images may be preprocessed to extract image features from the one or more images. Some non-limiting examples of such image features may comprise information based on and/or related to: edges; corners; blobs; ridges; Scale Invariant Feature Transform (SIFT) features; temporal features; and so forth.

In some embodiments, analyzing one or more images, for example by Step 820, Step 1020, Step 1120, Step 1220, Step 1320, Step 1350, Step 1520, Step 1530, Step 1620, Step 1720, Step 1730, etc., may comprise analyzing the one or more images and/or the preprocessed image data using one or more rules, functions, procedures, artificial neural networks, object detection algorithms, face detection algorithms, visual event detection algorithms, action detection algorithms, motion detection algorithms, background subtraction algorithms, inference models, and so forth. Some non-limiting examples of such inference models may include: an inference model preprogrammed manually; a classification model; a regression model; a result of training algorithms, such as machine learning algorithms and/or deep learning algorithms, on training examples, where the training examples may include examples of data instances, and in some cases, a data instance may be labeled with a corresponding desired label and/or result; and so forth.

In some embodiments, analyzing one or more images, for example by Step 820, Step 1020, Step 1120, Step 1220, Step 1320, Step 1350, Step 1520, Step 1530, Step 1620, Step 1720, Step 1730, etc., may comprise analyzing pixels, voxels, point cloud, range data, etc. included in the one or more images. For example, one or more convolutions of the pixels of the one or more images may be calculated, and the analysis of the one or more images may be based on the calculated one or more convolutions of the pixels of the one or more images. In another example, one or more functions of the pixels of the one or more images may be calculated, and the analysis of the one or more images may be based on the calculated one or more functions of the pixels of the one or more images. Some non-limiting examples of such functions may include linear functions, non-linear functions, polynomial functions, and so forth.

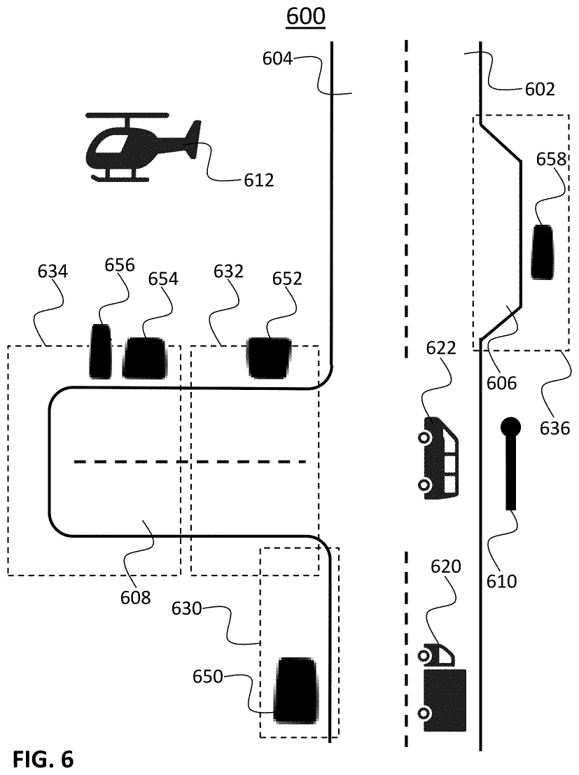

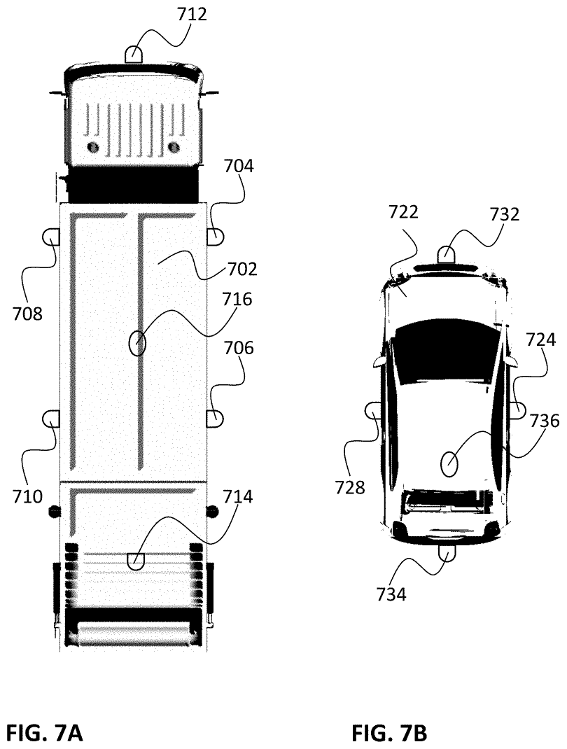

FIG. 6 is a schematic illustration of example an environment 600 of a road consistent with an embodiment of the present disclosure. In this example, the road comprise lane 602 for traffic moving in a first direction, lane 604 for traffic moving in a second direction (in this example, the second direction is opposite to the first direction), turnout area 606 adjunct to lane 602, dead end road 608, street camera 610, aerial vehicle 612 (manned or unmanned), vehicles 620 and 622 are moving on lane 602 in the first direction, areas 630, 632, 634 and 636 of the environment, item 650 in area 630, item 652 in area 632, items 654 and 656 in area 634, and item 658 in area 636. In this example, area 630 is closer to lane 604 than to lane 602 and may therefore be associated with the second direction rather than the first direction, areas 632 and 634 are associated with dead end road 608, and area 636 is associated with turnout area 606. In this example, image sensors may be positioned at different locations within environment 600 and capture images and/or videos of the environment. For example, images and/or videos of environment 600 may be captured using street cameras (such as street camera 610), image sensors mounted to aerial vehicles (such as aerial vehicle 612), image sensors mounted to vehicles in the environment (for example to vehicles 620 and/or 622, for example as described in relation to FIGS. 7A and 7B below), image sensors mounted to items in the environment (such as items 650, 652, 654, 656 and/or 658), and so forth.

In some embodiments, one or more instances of apparatus 200 may be mounted and/or configured to be mounted to a vehicle. The instances may be mounted and/or configured to be mounted to one or more sides of the vehicle (such as front, back, left, right, and so forth), to a roof of the vehicle, internally to the vehicle, and so forth. The instances may be configured to use image sensors 260 to capture and/or analyze images of the environment of the vehicle, of the exterior of the vehicle, of the interior of the vehicle, and so forth. Multiple such vehicles may be equipped with such apparatuses, and information based on images captured using the apparatuses may be gathered from the multiple vehicles. Additionally or alternatively, information from other sensors may be collected and/or analyzed, such as audio sensors 250, motion sensors 270, positioning sensors 275, and so forth. Additionally or alternatively, one or more additional instances of apparatus 200 may be positioned and/or configured to be positioned in an environment of the vehicles (such as a street, a parking area, and so forth), and similar information from the additional instances may be gathered and/or analyzed. The information captured and/or collected may be analyzed at the vehicle and/or at the apparatuses in the environment of the vehicle, for example using apparatus 200. Additionally or alternatively, the information captured and/or collected may be transmitted to an external device (such as server 300, cloud platform 400, etc.), possibly after some preprocessing, and the external device may gather and/or analyze the information.

FIG. 7A is a schematic illustration of a possible vehicle 702 and FIG. 7B is a schematic illustration of a possible vehicle 722, with image sensors mounted to the vehicles. In this example, vehicle 702 is an example of a garbage truck with image sensors mounted to it, and vehicle 704 is an example of a car with image sensors mounted to it. In this example, image sensors 704 and 706 are mounted to the right side of vehicle 702, image sensors 708 and 710 are mounted to the left side of vehicle 702, image sensor 712 is mounted to the front side of vehicle 702, image sensor 714 is mounted to the back side of vehicle 702, and image sensor 716 is mounted to the roof of vehicle 702. In this example, image sensor 724 is mounted to the right side of vehicle 722, image sensor 728 is mounted to the left side of vehicle 722, image sensor 732 is mounted to the front side of vehicle 722, image sensor 734 is mounted to the back side of vehicle 722, and image sensor 736 is mounted to the roof of vehicle 722. For example, each one of image sensors 704, 706, 708, 710, 712, 714, 716, 724, 728, 732, 734 and 736 may comprise an instance of apparatus 200, an instance of image sensor 260, and so forth. In some examples, image sensors 704, 706, 708, 710, 712, 714, 716, 724, 728, 732, 734 and/or 736 may be used to capture images and/or videos from an environment of the vehicles.

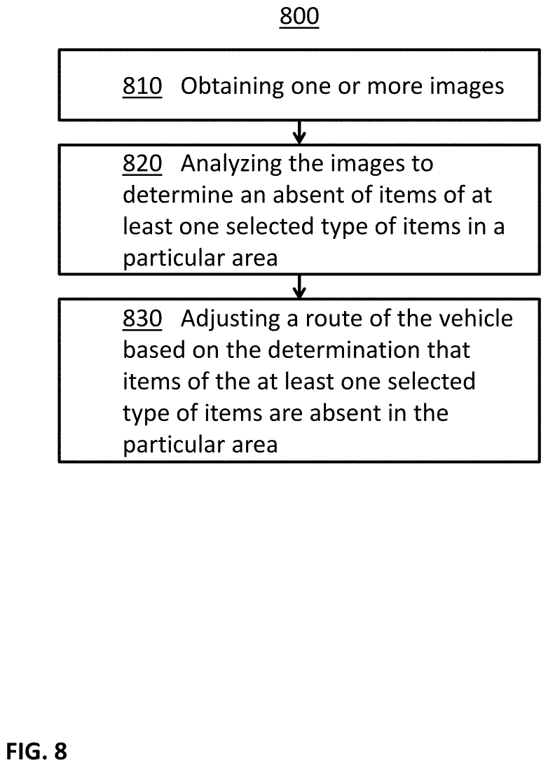

FIG. 8 illustrates an example of a method 800 for adjusting vehicles routes based on absent of items. In this example, method 800 may comprise: obtaining one or more images (Step 810), such as one or more images captured from an environment of a vehicle; analyzing the images to determine an absent of items of at least one selected type in a particular area (Step 820); and adjusting a route of the vehicle based on the determination that items of the at least one selected type are absent in the particular area (Step 830). In some implementations, method 800 may comprise one or more additional steps, while some of the steps listed above may be modified or excluded. For example, in some cases Step 810 and/or Step 820 and/or Step 830 may be excluded from method 800. In some implementations, one or more steps illustrated in FIG. 8 may be executed in a different order and/or one or more groups of steps may be executed simultaneously and/or a plurality of steps may be combined into single step and/or a single step may be broken down to a plurality of steps.

In some embodiments, obtaining one or more images (Step 810) may comprise obtaining one or more images, such as: one or more 2D images, one or more portions of one or more 2D images; sequence of 2D images; one or more video clips; one or more portions of one or more video clips; one or more video streams; one or more portions of one or more video streams; one or more 3D images; one or more portions of one or more 3D images; sequence of 3D images; one or more 3D video clips; one or more portions of one or more 3D video clips; one or more 3D video streams; one or more portions of one or more 3D video streams; one or more 360 images; one or more portions of one or more 360 images; sequence of 360 images; one or more 360 video clips; one or more portions of one or more 360 video clips; one or more 360 video streams; one or more portions of one or more 360 video streams; information based, at least in part, on any of the above; any combination of the above; and so forth. In some examples, an image of the obtained one or more images may comprise one or more of pixels, voxels, point cloud, range data, and so forth.

In some embodiments, obtaining one or more images (Step 810) may comprise obtaining one or more images captured from an environment of a vehicle using one or more image sensors, such as image sensors 260. In some examples, Step 810 may comprise capturing the one or more images from the environment of a vehicle using the one or more image sensors.

In some embodiments, obtaining one or more images (Step 810) may comprise obtaining one or more images captured using one or more image sensors (such as image sensors 260) and depicting at least part of a container and/or at least part of a trash can. In some examples, Step 810 may comprise capturing the one or more images depicting the at least part of a container and/or at least part of a trash can using the one or more image sensors.

In some embodiments, obtaining one or more images (Step 810) may comprise obtaining one or more images captured using one or more image sensors (such as image sensors 260) and depicting at least part of an external part of a vehicle. In some examples, Step 810 may comprise capturing the one or more images depicting at least part of an external part of a vehicle using the one or more image sensors. In some examples, the depicted at least part of the external part of the vehicle may comprise at least part of a place for at least one human rider.

In some embodiments, obtaining one or more images (Step 810) may comprise obtaining one or more images captured using one or more image sensors (such as image sensors 260) and depicting at least two sides of an environment of a vehicle. In some examples, Step 810 may comprise capturing the one or more images depicting at least two sides of an environment of a vehicle using one or more image sensors (such as image sensors 260). For example, the at least two sides of the environment of the vehicle may comprise a first side of the environment of the vehicle and a second side of the environment of the vehicle.

In some examples, Step 810 may comprise obtaining one or more images captured (for example, from an environment of a vehicle, from an environment of a container, from an environment of a trash can, from an environment of a road, etc.) using at least one wearable image sensor, such as wearable version of apparatus 200 and/or wearable version of image sensor 260. For example, the wearable image sensors may be configured to be worn by drivers of a vehicle, operators of machinery attached to a vehicle, passengers of a vehicle, garbage collectors, and so forth. For example, the wearable image sensor may be physically connected and/or integral to a garment, physically connected and/or integral to a belt, physically connected and/or integral to a wrist strap, physically connected and/or integral to a necklace, physically connected and/or integral to a helmet, and so forth.

In some examples, Step 810 may comprise obtaining one or more images captured (for example, from an environment of a vehicle, from an environment of a container, from an environment of a trash can, from an environment of a road, etc.) using at least one image sensor mounted to a vehicle, such as a version of apparatus 200 and/or image sensor 260 that is configured to be mounted to a vehicle. In some examples, Step 810 may comprise obtaining one or more images captured from an environment of a vehicle using at least one image sensor mounted to the vehicle, such as a version of apparatus 200 and/or image sensor 260 that is configured to be mounted to a vehicle. Some non-limiting examples of such image sensors mounted to a vehicle may include image sensors 704, 706, 708, 710, 712, 714, 716, 724, 728, 732, 734 and 736. For example, the at least one image sensor may be configured to be mounted to an external part of the vehicle. In another example, the at least one image sensor may be configured to be mounted internally to the vehicle and capture the one or more images through a window of the vehicle (for example, through a windshield of the vehicle, throw a front window of the vehicle, through a rear window of the vehicle, through a quarter glass of the vehicle, through a back window of a vehicle, and so forth). In some examples, the vehicle may be a garbage truck and the at least one image sensor may be configured to be mounted to the garbage truck. For example, the at least one image sensor may be configured to be mounted to an external part of the garbage truck. In another example, the at least one image sensor may be configured to be mounted internally to the garbage truck and capture the one or more images through a window of the garbage truck.

In some examples, Step 810 may comprise obtaining one or more images captured from an environment of a vehicle using at least one image sensor mounted to a different vehicle, such as a version of apparatus 200 and/or image sensor 260 that is configured to be mounted to a vehicle. For example, the at least one image sensor may be configured to be mounted to another vehicle, to a car, to a drone, and so forth. For example, method 800 may deal with a route of vehicle 620 based on one or more images captured by one or more image sensors mounted to vehicle 622. For example, method 800 may deal with a route of vehicle 620 based on one or more images captured by one or more image sensors mounted to aerial vehicle 612 (which may be either manned or unmanned).

In some examples, Step 810 may comprise obtaining one or more images captured (for example, from an environment of a vehicle, from an environment of a container, from an environment of a trash can, from an environment of a road, etc.) using at least one stationary image sensor, such as stationary version of apparatus 200 and/or stationary version of image sensor 260. For example, the at least one stationary image sensor may include street cameras. For example, method 800 may deal with a route of vehicle 620 based on one or more images captured by street camera 610.

In some examples, Step 810 may comprise, in addition or alternatively to obtaining one or more images and/or other input data, obtaining motion information captured using one or more motion sensors, for example using motion sensors 270. Examples of such motion information may include: indications related to motion of objects; measurements related to the velocity of objects; measurements related to the acceleration of objects; indications related to motion of motion sensor 270; measurements related to the velocity of motion sensor 270; measurements related to the acceleration of motion sensor 270; indications related to motion of a vehicle; measurements related to the velocity of a vehicle; measurements related to the acceleration of a vehicle; information based, at least in part, on any of the above; any combination of the above; and so forth.

In some examples, Step 810 may comprise, in addition or alternatively to obtaining one or more images and/or other input data, obtaining position information captured using one or more positioning sensors, for example using positioning sensors 275. Examples of such position information may include: indications related to the position of positioning sensors 275; indications related to changes in the position of positioning sensors 275; measurements related to the position of positioning sensors 275; indications related to the orientation of positioning sensors 275; indications related to changes in the orientation of positioning sensors 275; measurements related to the orientation of positioning sensors 275; measurements related to changes in the orientation of positioning sensors 275; indications related to the position of a vehicle; indications related to changes in the position of a vehicle; measurements related to the position of a vehicle; indications related to the orientation of a vehicle; indications related to changes in the orientation of a vehicle; measurements related to the orientation of a vehicle; measurements related to changes in the orientation of a vehicle; information based, at least in part, on any of the above; any combination of the above; and so forth.

In some embodiments, Step 810 may comprise receiving input data using one or more communication devices, such as communication modules 230, internal communication modules 440, external communication modules 450, and so forth. Examples of such input data may include: input data captured using one or more sensors; one or more images captured using image sensors, for example using image sensors 260; motion information captured using motion sensors, for example using motion sensors 270; position information captured using positioning sensors, for example using positioning sensors 275; and so forth.

In some embodiments, Step 810 may comprise reading input data from memory units, such as memory units 210, shared memory modules 410, and so forth. Examples of such input data may include: input data captured using one or more sensors; one or more images captured using image sensors, for example using image sensors 260; motion information captured using motion sensors, for example using motion sensors 270; position information captured using positioning sensors, for example using positioning sensors 275; and so forth.

In some embodiments, analyzing the one or more images to determine an absent of items of at least one selected type in a particular area (Step 820) may comprise analyzing the one or more images obtained by Step 810 to determine an absent of items of at least one type in a particular area of the environment, may comprise analyzing the one or more images obtained by Step 810 to determine an absent of containers of at least one type in a particular area of the environment, may comprise analyzing the one or more images obtained by Step 810 to determine an absent of trash cans of at least one type in a particular area of the environment, may comprise analyzing the one or more images obtained by Step 810 to determine an absent of trash cans in a particular area of the environment, and so forth. For example, a machine learning model may be trained using training examples to determine absent of items (such as items of at least one selected type of items, containers of at least one selected type of containers, trash cans of at least one selected type of trash cans, trash cans, etc.) in a particular area of the environment from images and/or videos, and the trained machine learning model may be used to analyze the one or more images obtained by Step 810 and determine whether items (such as items of at least one selected type of items, containers of at least one selected type of containers, trash cans of at least one selected type of trash cans, trash cans, etc.) are absent from the particular area of the environment. An example of such training example may include an image and/or a video of the particular area of the environment, together with a desired determination of whether items (such as items of at least one selected type of items, containers of at least one selected type of containers, trash cans of at least one selected type of trash cans, trash cans, etc.) are absent from the particular area of the environment according to the image and/or video. In another example, an artificial neural network (such as a deep neural network, a convolutional neural network, etc.) may be configured to determine absent of items (such as items of at least one selected type of items, containers of at least one selected type of containers, trash cans of at least one selected type of trash cans, trash cans, etc.) in a particular area of the environment from images and/or videos, and the artificial neural network may be used to analyze the one or more images obtained by Step 810 and determine whether items (such as items of at least one selected type of items, containers of at least one selected type of containers, trash cans of at least one selected type of trash cans, trash cans, etc.) are absent from the particular area of the environment.

Some non-limiting examples of the particular area of the environment of Step 820 and/or Step 830 may include an area in a vicinity of the vehicle (for example, less than a selected distance from the vehicle, where the selected distance may be less than one meter, less than two meters, less than five meters, less than ten meters, and so forth), an area not in the vicinity of the vehicle, an area visible from the vehicle, an area on a road where the vehicle is moving on the road, an area outside a road where the vehicle is moving on the road, an area in a vicinity of a road where the vehicle is moving on the road (for example, within the road, less than a selected distance from the road, where the selected distance may be less than one meter, less than two meters, less than five meters, less than ten meters, and so forth), an area in a vicinity of the garbage truck (for example, less than a selected distance from the garbage truck, where the selected distance may be less than one meter, less than two meters, less than five meters, less than ten meters, and so forth), an area not in the vicinity of the garbage truck, an area visible from the garbage truck, an area on a road where the garbage truck is moving on the road, an area outside a road where the garbage truck is moving on the road, an area in a vicinity of a road where the garbage truck is moving on the road (for example, within the road, less than a selected distance from the road, where the selected distance may be less than one meter, less than two meters, less than five meters, less than ten meters, and so forth), an area designated for trash cans, an area designated for items of a group of types of items (for example, where the group of types of items may comprise the at least one type of items of Step 820), an area designated for containers of a group of types of containers (for example, where the group of types of containers may comprise the at least one type of containers of Step 820), an area designated for trash cans of a group of types of trash cans (for example, where the group of types of trash cans may comprise the at least one type of trash cans of Step 820), an area designated for actions of a group of actions (for example, where the group of actions may comprise handling one or more items of the at least one type of items of Step 820, where the group of actions may comprise handling one or more containers of the at least one type of containers of Step 820, where the group of actions may comprise handling one or more trash cans of the at least one type of trash cans of Step 820, where the group of actions may comprise handling one or more trash cans), and so forth.

In some examples, the one or more images obtained by Step 810 may be analyzed by Step 820 using an object detection algorithm to attempt to detect an item (such as items of at least one selected type of items, containers of at least one selected type of containers, trash cans of at least one selected type of trash cans, trash cans, etc.) in a particular area of the environment. Further, in some examples, in response to a failure to detect such item in the particular area of the environment, Step 820 may determine that items (such as items of at least one selected type of items, containers of at least one selected type of containers, trash cans of at least one selected type of trash cans, trash cans, etc.) are absent in the particular area of the environment, and in response to a successful detection of one or more such item in the particular area of the environment, Step 820 may determine that items (such as items of at least one selected type of items, containers of at least one selected type of containers, trash cans of at least one selected type of trash cans, trash cans, etc.) are not absent in the particular area of the environment.

In some examples, the one or more images obtained by Step 810 may be analyzed by Step 820 using an object detection algorithm to attempt to detect items and/or containers and/or trash cans in a particular area of the environment. Further, the one or more images obtained by Step 810 may be analyzed by Step 820 to determine a type of each detected item and/or container and/or trash can, for example using an object recognition algorithm, using an image classifier, using Step 1020, and so forth. In some examples, in response to a determined type of at least one of the detected items being in the group of at least one selected type of items, Step 820 may determine that items of the at least one selected type of items are not absent in the particular area of the environment, and in response to none of the determined types of the detected items being in the group of at least one selected type of items, Step 820 may determine that items of the at least one selected type of items are absent in the particular area of the environment. In some examples, in response to a determined type of at least one of the detected containers being in the group of at least one selected type of containers, Step 820 may determine that containers of the at least one selected type of containers are not absent in the particular area of the environment, and in response to none of the determined types of the detected containers being in the group of at least one selected type of containers, Step 820 may determine that containers of the at least one selected type of containers are absent in the particular area of the environment. In some examples, in response to a determined type of at least one of the detected trash cans being in the group of at least one selected type of trash cans, Step 820 may determine that trash cans of the at least one selected type of trash cans are not absent in the particular area of the environment, and in response to none of the determined types of the detected trash cans being in the group of at least one selected type of trash cans, Step 820 may determine that trash cans of the at least one selected type of trash cans are absent in the particular area of the environment.

In some embodiments, adjusting a route of the vehicle based on the determination that items of the at least one selected type are absent in the particular area (Step 830) may comprise adjusting a route of the vehicle based on the determination of Step 820 that items of the at least one type are absent in the particular area of the environment, for example to forgo a route portion associated with handling one or more items of the at least one type in the particular area of the environment. In some examples, Step 830 may comprise adjusting a route of the vehicle based on the determination of Step 820 that containers of the at least one type of containers are absent in the particular area of the environment, for example to forgo a route portion associated with handling one or more containers of the at least one type of containers in the particular area of the environment. In some examples, Step 830 may comprise adjusting a route of the garbage truck based on the determination of Step 820 that trash cans of the at least one type of trash cans are absent in the particular area of the environment, for example to forgo a route portion associated with handling one or more trash cans of the at least one type of trash cans in the particular area of the environment. In some examples, Step 830 may comprise adjusting a route of the garbage truck based on the determination of Step 820 that trash cans are absent in the particular area of the environment, for example to forgo a route portion associated with handling one or more trash cans in the particular area of the environment.

In some examples, the handling of one or more items (for example, handling the one or more items of the at least one type of Step 820, handling the one or more containers of the at least one type of containers of Step 820, handling the one or more trash cans of the at least one type of trash cans of Step 820, handling the one or more trash cans, and so forth) of Step 830 may comprise moving at least one of the one or more items of the at least one type (for example, at least one of the one or more items of the at least one type of Step 820, at least one of the one or more containers of the at least one type of containers of Step 820, at least one of the one or more trash cans of the at least one type of trash cans of Step 820, at least one of the one or more trash cans, and so forth). In some examples, handling of one or more items (for example, handling the one or more items of the at least one type of Step 820, handling the one or more containers of the at least one type of containers of Step 820, handling the one or more trash cans of the at least one type of trash cans of Step 820, handling the one or more trash cans, and so forth) of Step 830 may comprise obtaining one or more objects placed within at least one of the one or more items (for example, within at least one of the one or more items of the at least one type of Step 820, within at least one of the one or more containers of the at least one type of containers of Step 820, within at least one of the one or more trash cans of the at least one type of trash cans of Step 820, within at least one of the one or more trash cans, and so forth). In some examples, handling of one or more items (for example, handling the one or more items of the at least one type of Step 820, handling the one or more containers of the at least one type of containers of Step 820, handling the one or more trash cans of the at least one type of trash cans of Step 820, handling the one or more trash cans, and so forth) of Step 830 may comprise placing one or more objects in at least one of the one or more items (for example, in at least one of the one or more items of the at least one type of Step 820, in at least one of the one or more containers of the at least one type of containers of Step 820, in at least one of the one or more trash cans of the at least one type of trash cans of Step 820, in at least one of the one or more trash cans, and so forth). In some examples, handling of one or more items (for example, handling the one or more items of the at least one type of Step 820, handling the one or more containers of the at least one type of containers of Step 820, handling the one or more trash cans of the at least one type of trash cans of Step 820, handling the one or more trash cans, and so forth) of Step 830 may comprise changing a physical state of at least one of the one or more items (for example, of at least one of the one or more items of the at least one type of Step 820, of at least one of the one or more containers of the at least one type of containers of Step 820, of at least one of the one or more trash cans of the at least one type of trash cans of Step 820, of at least one of the one or more trash cans, and so forth).

In some examples, adjusting a route (of a vehicle, of a garbage truck, etc.) by Step 830 may comprise canceling at least part of a planned route, and the canceled at least part of the planned route may be associated with the particular area of the environment of Step 820. For example, the canceled at least part of the planned route may be associated with the handling of one or more items (for example, of one or more items of the at least one type of Step 820, of one or more containers of the at least one type of containers of Step 820, of one or more trash cans of the at least one type of trash cans of Step 820, of one or more trash cans, and so forth) in the particular area of the environment of Step 820. In another example, the canceled at least part of the planned route may be configured, when not canceled, to enable the vehicle to move one or more items (for example, one or more items of the at least one type of Step 820, one or more containers of the at least one type of containers of Step 820, one or more trash cans of the at least one type of trash cans of Step 820, one or more trash cans, and so forth). In yet another example, the canceled at least part of the planned route is configured, when not canceled, to enable the vehicle to obtain one or more objects placed within at least one of the one or more items (for example, within at least one of the one or more items of the at least one type of Step 820, within at least one of the one or more containers of the at least one type of containers of Step 820, within at least one of the one or more trash cans of the at least one type of trash cans of Step 820, within at least one of the one or more trash cans, and so forth). In an additional example, the canceled at least part of the planned route may be configured, when not canceled, to enable the vehicle to place one or more objects in at least one of the one or more items (for example, in at least one of the one or more items of the at least one type of Step 820, in at least one of the one or more containers of the at least one type of containers of Step 820, in at least one of the one or more trash cans of the at least one type of trash cans of Step 820, in at least one of the one or more trash cans, and so forth). In yet another example, the canceled at least part of the planned route may be configured, when not canceled, to enable the vehicle to change a physical state of at least one of the one or more items (for example, of at least one of the one or more items of the at least one type of Step 820, of at least one of the one or more containers of the at least one type of containers of Step 820, of at least one of the one or more trash cans of the at least one type of trash cans of Step 820, of at least one of the one or more trash cans, and so forth).

In some examples, adjusting a route (of a vehicle, of a garbage truck, etc.) by Step 830 may comprise forgoing adding a detour to a planned route, and the detour may be associated with the particular area of the environment. For example, the detour may be associated with the handling of one or more items (for example, of one or more items of the at least one type of Step 820, of one or more containers of the at least one type of containers of Step 820, of one or more trash cans of the at least one type of trash cans of Step 820, of one or more trash cans, and so forth) in the particular area of the environment. In another example, the detour may be configured to enable the vehicle to move at least one of the one or more items (for example, at least one of the one or more items of the at least one type of Step 820, at least one of the one or more containers of the at least one type of containers of Step 820, at least one of the one or more trash cans of the at least one type of trash cans of Step 820, at least one of the one or more trash cans, and so forth). In yet another example, the detour may be configured to enable the vehicle to obtain one or more objects placed within at least one of the one or more items (for example, within at least one of the one or more items of the at least one type of Step 820, within at least one of the one or more containers of the at least one type of containers of Step 820, within at least one of the one or more trash cans of the at least one type of trash cans of Step 820, within at least one of the one or more trash cans, and so forth). In an additional example, the detour is configured to enable the vehicle to place one or more objects in at least one of the one or more items (for example, in at least one of the one or more items of the at least one type of Step 820, in at least one of the one or more containers of the at least one type of containers of Step 820, in at least one of the one or more trash cans of the at least one type of trash cans of Step 820, in at least one of the one or more trash cans, and so forth). In yet another example, the detour may be configured to enable the vehicle to change a physical state of at least one of the one or more items (for example, of at least one of the one or more items of the at least one type of Step 820, of at least one of the one or more containers of the at least one type of containers of Step 820, of at least one of the one or more trash cans of the at least one type of trash cans of Step 820, of at least one of the one or more trash cans, and so forth).

In some examples, a vehicle (such as a garbage truck or another type of vehicle) may be moving in a first direction on a first side of a road, the particular area of the environment of Step 820 may be associated with a second side of the road, and the adjustment to the route of the vehicle by Step 830 may comprise forgoing moving through the road in a second direction. For example, the particular area of the environment may be a part of a sidewalk closer to the second side of the road, or may include a part of a sidewalk closer to the second side of the road. In another example, the particular area of the environment of Step 820 may be at a first side of the vehicle when the vehicle is moving in the first direction and at a second side of the vehicle when the vehicle is moving in the second direction, and handling of the one or more items (for example, of one or more items of the at least one type of Step 820, of one or more containers of the at least one type of containers of Step 820, of one or more trash cans of the at least one type of trash cans of Step 820, of one or more trash cans, and so forth) may require the one or more items to be at the second side of the vehicle. In yet another example, the particular area of the environment of Step 820 may be closer to the vehicle when the vehicle is moving in the second direction than when the vehicle is moving in the first direction.

In some examples, the particular area of the environment of Step 820 may be associated with at least part of a dead end road, and adjusting a route (of a vehicle, of a garbage truck, etc.) by Step 830 may comprise forgoing entering the at least part of the dead end road. For example, the entering to the at least part of the dead end road may be required for the handling of one or more items (for example, of one or more items of the at least one type of Step 820, of one or more containers of the at least one type of containers of Step 820, of one or more trash cans of the at least one type of trash cans of Step 820, of one or more trash cans, and so forth) in the particular area of the environment. In another example, the entering to the at least part of the dead end road may be required to enable the vehicle to move at least one of the one or more items (for example, at least one of the one or more items of the at least one type of Step 820, at least one of the one or more containers of the at least one type of containers of Step 820, at least one of the one or more trash cans of the at least one type of trash cans of Step 820, at least one of the one or more trash cans, and so forth). In yet another example, the entering to the at least part of the dead end road may be required to enable the vehicle to obtain one or more objects placed within at least one of the one or more items (for example, within at least one of the one or more items of the at least one type of Step 820, within at least one of the one or more containers of the at least one type of containers of Step 820, within at least one of the one or more trash cans of the at least one type of trash cans of Step 820, within at least one of the one or more trash cans, and so forth). In an additional example, the entering to the at least part of the dead end road may be required to enable the vehicle to place one or more objects in at least one of the one or more items (for example, in at least one of the one or more items of the at least one type of Step 820, in at least one of the one or more containers of the at least one type of containers of Step 820, in at least one of the one or more trash cans of the at least one type of trash cans of Step 820, in at least one of the one or more trash cans, and so forth). In yet another example, the entering to the at least part of the dead end road is required to enable the vehicle to change a physical state of at least one of the one or more items (for example, of at least one of the one or more items of the at least one type of Step 820, of at least one of the one or more containers of the at least one type of containers of Step 820, of at least one of the one or more trash cans of the at least one type of trash cans of Step 820, of at least one of the one or more trash cans, and so forth).

In some examples, adjusting a route (of a vehicle, of a garbage truck, etc.) by Step 830 may comprise providing notification about the adjustment to the route of the vehicle to a user. Some non-limiting examples of such user may include driver of the vehicle, operator of machinery attached to the vehicle, passenger of the vehicle, garbage collector working with the vehicle, coordinator managing the vehicle, and so forth. For example, the user may be an operator of the vehicle (such as an operator of a garbage truck or of another type of vehicle) and the notification may comprise navigational information (for example, the navigational information may be presented to the user on a map). In another example, the notification may comprise an update to a list of tasks, for example removing a task from the list, adding a task to the list, modifying a task in the list, and so forth.

In some examples, Step 830 may further comprise using the adjusted route of the vehicle to navigate the vehicle (for example, to navigate the garbage truck or to navigate another type of vehicle). In some examples, the vehicle may be an autonomous vehicle (such as an autonomous garbage truck or another type of autonomous vehicle), and Step 830 may comprise providing information configured to cause the autonomous vehicle to navigate according to the adjusted route.

In some embodiments, Step 820 may comprise analyzing the one or more images obtained by Step 810 (for example, using an object detection algorithm) to attempt to detect an item (such as items of at least one selected type of items, containers of at least one selected type of containers, trash cans of at least one selected type of trash cans, trash cans, etc.) in a particular area of the environment. Further, in some examples, in response to a failure to detect such item (such as items of at least one selected type of items, containers of at least one selected type of containers, trash cans of at least one selected type of trash cans, trash cans, etc.) in the particular area of the environment, Step 830 may cause the route of the vehicle (for example of a garbage truck or of another type of vehicle) to avoid the route portion associated with the handling of one or more items (for example, of one or more items of the at least one type of Step 820, of one or more containers of the at least one type of containers of Step 820, of one or more trash cans of the at least one type of trash cans of Step 820, of one or more trash cans, and so forth) in the particular area of the environment, and in response to a successful detection of one or more such item (such as items of at least one selected type of items, containers of at least one selected type of containers, trash cans of at least one selected type of trash cans, trash cans, etc.) in the particular area of the environment, Step 830 may cause the route of the vehicle (for example of a garbage truck or of another type of vehicle) to include a route portion associated with the handling of one or more items (for example, of one or more items of the at least one type of Step 820, of one or more containers of the at least one type of containers of Step 820, of one or more trash cans of the at least one type of trash cans of Step 820, of one or more trash cans, and so forth) in the particular area of the environment.

In some embodiments, Step 820 may comprise analyzing the one or more images obtained by Step 810 (for example, using an object detection algorithm) to attempt to detect an item (such as items of at least one selected type of items, containers of at least one selected type of containers, trash cans of at least one selected type of trash cans, trash cans, etc.) in a particular area of the environment. Further, in some examples, in response to a successful detection of one or more such item (such as items of at least one selected type of items, containers of at least one selected type of containers, trash cans of at least one selected type of trash cans, trash cans, etc.) in the particular area of the environment, Step 830 may adjust the route of the vehicle (for example of a garbage truck or of another type of vehicle) to bring the vehicle to a vicinity of the particular area of the environment (for example, to within the particular area of the environment, to less than a selected distance from the particular area of the environment, where the selected distance may be less than one meter, less than two meters, less than five meters, less than ten meters, and so forth), and in response to a failure to detect such item (such as items of at least one selected type of items, containers of at least one selected type of containers, trash cans of at least one selected type of trash cans, trash cans, etc.) in the particular area of the environment, Step 830 may adjust the route of the vehicle to forgo bringing the vehicle to the vicinity of the particular area of the environment.

In some embodiments, the vehicle of Step 810 and/or Step 830 may comprise a delivery vehicle. Further, in some examples, the at least one type of items of Step 820 and/or Step 830 may include a receptacle and/or a container configured to hold objects for picking by the delivery vehicle and/or to hold objects received from the delivery vehicle. Further, Step 820 may comprise analyzing the one or more images obtained by Step 810 to determine an absent of receptacles of the at least one type in a particular area of the environment (for example as described above), and Step 830 may comprise adjusting a route of the delivery vehicle based on the determination that receptacles of the at least one type are absent in the particular area of the environment to forgo a route portion associated with collecting one or more objects from receptacles of the at least one type in the particular area of the environment and/or to forgo a route portion associated with placing objects in receptacles of the at least one type in the particular area of the environment (for example as described above).

In some embodiments, the vehicle of Step 810 and/or Step 830 may comprise a mail delivery vehicle. Further, in some examples, the at least one type of items of Step 820 and/or Step 830 may include a mailbox. Further, Step 820 may comprise analyzing the one or more images obtained by Step 810 to determine an absent of mailboxes in a particular area of the environment (for example as described above), and Step 830 may comprise adjusting a route of the mail delivery vehicle based on the determination that mailboxes are absent in the particular area of the environment to forgo a route portion associated with collecting mail from mailboxes in the particular area of the environment and/or to forgo a route portion associated with placing mail in mailboxes in the particular area of the environment (for example as described above).

In some embodiments, the vehicle of Step 810 and/or Step 830 may comprise a garbage truck, as described above. In some examples, the at least one type of trash cans and/or the at least one type of items and/or the at least one type of containers of Step 820 and/or Step 830 may comprise at least a first type of trash cans configured to hold objects designated to be collected using the garbage truck. In some examples, the at least one type of trash cans and/or the at least one type of items and/or the at least one type of containers of Step 820 and/or Step 830 may comprise at least a first type of trash cans while not including at least a second type of trash cans (some non-limiting examples of such first type of trash cans and second type of trash cans may comprise at least one of a trash can for paper, a trash can for plastic, a trash can for glass, a trash can for metals, a trash can for non-recyclable waste, a trash can for mixed recycling waste, a trash can for biodegradable waste, and a trash can for packaging products).

In some embodiments, Step 820 and/or Step 1020 may analyze the one or more images obtained by Step 810 to determine a type of a trash can depicted in the one or more images and/or a type of a container depicted in the one or more images. For example, a machine learning model may be trained using training examples to determine types of trash cans and/or of containers from images and/or videos, and Step 820 and/or Step 1020 may use the trained machine learning model to analyze the one or more images obtained by Step 810 and determine the type of the trash can depicted in the one or more images. An example of such training example may include an image and/or a video of a trash can and/or of a container together with a desired determined type of the trash can in the image and/or video a desired determined type of the container in the image and/or video. In another example, an artificial neural network (such as a deep neural network, a convolutional neural network, etc.) may be configured to determine types of trash cans and/or of containers from images and/or videos, and Step 820 and/or Step 1020 may use the artificial neural network to analyze the one or more images obtained by Step 810 and determine the type of the trash can depicted in the one or more images and/or to determine the type of the container depicted in the one or more images. In some examples, information may be provided (for example, to a user) based on the determined type of the trash can depicted in the one or more images and/or the determined type of the container depicted in the one or more images, for example using Step 1030 as described below.

In some examples, Step 820 and/or Step 1020 may analyze the one or more images obtained by Step 810 to determine a type of a trash can depicted in the one or more images based on at least one color of the depicted trash can and/or to determine a type of a container depicted in the one or more images based on at least one color of the depicted container. For example, Step 820 and/or Step 1020 may analyze the one or more images obtained by Step 810 to determine color information of the depicted trash can and/or of the depicted container (for example, by computing a color histogram for the depiction of the trash can and/or for the depiction of the container, by selecting the most prominent or prevalent color in the depiction of the trash can and/or in the depiction of the container, by calculating an average and/or median color of the depiction of the trash can and/or of the depiction of the container, and so forth). In some examples, in response to a first determined color information (for example, a first color histogram, a first most prominent, a first most prevalent color, a first average color, a first median color, etc.) of the depicted trash can, Step 820 and/or Step 1020 may determine that the type of the depicted trash can is the first type of trash cans, and in response to a second determined color information (for example, a second color histogram, a second most prominent, a second most prevalent color, a second average color, a second median color, etc.) of the depicted trash can, Step 820 and/or Step 1020 may determine that the type of the depicted trash can is not the first type of trash cans, may determine that the type of the depicted trash can is a second type of trash cans (different from the first type), and so forth. In some examples, in response to a first determined color information (for example, a first color histogram, a first most prominent, a first most prevalent color, a first average color, a first median color, etc.) of the depicted container, Step 820 may determine that the type of the depicted container is the first type of containers, and in response to a second determined color information (for example, a second color histogram, a second most prominent, a second most prevalent color, a second average color, a second median color, etc.) of the depicted container, Step 820 may determine that the type of the depicted container is not the first type of containers, may determine that the type of the depicted container is a second type of containers (different from the first type), and so forth. In some examples, a lookup table may be used by Step 820 and/or Step 1020 to determine the type of the depicted trash can from the determined color information of the depicted trash can (for example, from the determined color histogram, from the determined most prominent, from the determined most prevalent color, from the determined average color, from the determined median color, and so forth). In some examples, a lookup table may be used to determine the type of the depicted container from the determined color information of the depicted container (for example, from the determined color histogram, from the determined most prominent, from the determined most prevalent color, from the determined average color, from the determined median color, and so forth). For example, Step 820 and/or Step 1020 may determine the type of the trash can 910 based on a color of trash can 910. For example, in response to a first color of trash can 910, Step 820 and/or Step 1020 may determine that the type of trash can 910 is a first type, and in response to a second color of trash can 910, Step 820 and/or Step 1020 may determine that the type of trash can 910 is a second type (different from the first type).

In some examples, Step 820 and/or Step 1020 may analyze the one or more images obtained by Step 810 to determine a type of a trash can depicted in the one or more images based on at least a logo presented on the depicted trash can and/or to determine a type of a container depicted in the one or more images based on at least a logo presented on the depicted container. For example, Step 820 and/or Step 1020 may analyze the one or more images obtained by Step 810 to detect and/or recognize a logo presented on the depicted trash can and/or on the depicted container (for example, using a logo detection algorithm and/or a logo recognition algorithm). In some examples, in response to a first detected logo, Step 820 and/or Step 1020 may determine that the type of the depicted trash can is the first type of trash cans, and in response to a second detected logo, Step 820 and/or Step 1020 may determine that the type of the depicted trash can is not the first type of trash cans, may determine that the type of the depicted trash can is a second type of trash cans (different from the first type), and so forth. In some examples, in response to a first detected logo, Step 820 may determine that the type of the depicted container is the first type of containers, and in response to a second detected logo, Step 820 may determine that the type of the depicted container is not the first type of containers, may determine that the type of the depicted container is a second type of containers (different from the first type), and so forth. For example, Step 820 and/or Step 1020 may determine the type of the trash can 920 to be ‘PLASTIC RECYCLING TRASH CAN’ based on logo 922 and the type of trash can 930 to be ‘ORGANIC MATERIALS TRASH CAN’ based on logo 932.

In some examples, Step 820 and/or Step 1020 may analyze the one or more images obtained by Step 810 to determine a type of a trash can depicted in the one or more images based on at least a text presented on the depicted trash can and/or to determine a type of a container depicted in the one or more images based on at least a text presented on the depicted container. For example, Step 820 and/or Step 1020 may analyze the one or more images obtained by Step 810 to detect and/or recognize a text presented on the depicted trash can and/or on the depicted container (for example, using an Optical Character Recognition algorithm). In some examples, in response to a first detected text, Step 820 and/or Step 1020 may determine that the type of the depicted trash can is the first type of trash cans, and in response to a second detected text, Step 820 and/or Step 1020 may determine that the type of the depicted trash can is not the first type of trash cans, may determine that the type of the depicted trash can is a second type of trash cans (different from the first type), and so forth. In some examples, in response to a first detected text, Step 820 may determine that the type of the depicted container is the first type of containers, and in response to a second detected text, Step 820 may determine that the type of the depicted container is not the first type of containers, may determine that the type of the depicted container is a second type of containers (different from the first type), and so forth. In some examples, Step 820 and/or Step 1020 may use a Natural Language Processing algorithm (such as a text classification algorithm) to analyze the detected text and determine the type of the depicted trash can and/or the depicted container from the detected text. For example, Step 820 and/or Step 1020 may determine the type of the trash can 920 to be ‘PLASTIC RECYCLING TRASH CAN’ based on text 924 and the type of trash can 930 to be ‘ORGANIC MATERIALS TRASH CAN’ based on text 934.

In some examples, Step 820 and/or Step 1020 may analyze the one or more images obtained by Step 810 to determine a type of a trash can depicted in the one or more images based on at least a shape of the depicted trash can and/or to determine a type of a container depicted in the one or more images based on at least a shape of the depicted container. For example, Step 820 and/or Step 1020 may analyze the one or more images obtained by Step 810 to identify the shape of the depicted trash can and/or of the depicted container (for example, using a shape detection algorithm, by representing the shape of a detected trash can and/or a detected container using a shape representation algorithm, and so forth). In some examples, in response to a first identified shape, Step 820 and/or Step 1020 may determine that the type of the depicted trash can is the first type of trash cans, and in response to a second identified shape, Step 820 and/or Step 1020 may determine that the type of the depicted trash can is not the first type of trash cans, may determine that the type of the depicted trash can is a second type of trash cans (different from the first type), and so forth. In some examples, in response to a first identified shape, Step 820 may determine that the type of the depicted container is the first type of containers, and in response to a second identified shape, Step 820 may determine that the type of the depicted container is not the first type of containers, may determine that the type of the depicted container is a second type of containers (different from the first type), and so forth. In some examples, Step 820 and/or Step 1020 may compare a representation of the shape of the depicted trash can and/or of the shape of the depicted container with one or more shape prototypes (for example, the representation of the shape may include a graph and an inexact graph matching algorithm may be used to match the shape with a prototype, the representation of the shape may include a hypergraph and an inexact hypergraph matching algorithm may be used to match the shape with a prototype, etc.), and Step 820 and/or Step 1020 may select the type of the depicted trash can and/or the type of the depicted container according to the most similar prototype to the shape, according to all prototypes with a similarity measure to the shape that is above a selected threshold, and so forth. For example, Step 820 and/or Step 1020 may determine the type of the trash can 900 and trash can 940 based on the shapes of trash can 900 and trash can 940. For example, although the colors, logos, and texts of trash can 900 and trash can 940 may be substantially identical or similar, Step 820 and/or Step 1020 may determine the type of trash can 900 to be a first type of trash cans based on the shape of trash can 900, and the type of trash can 940 to be a second type of trash cans (different from the first type of trash cans) based on the shape of trash can 940.

In some examples, Step 820 and/or Step 1020 may analyze the one or more images obtained by Step 810 to determine a type of a trash can depicted in the one or more images based on at least a fullness level of the trash can and/or to determine a type of a container depicted in the one or more images based on at least a fullness level of the container. Some non-limiting examples of such fullness level may include a fullness percent (such as 20%, 80%, 100%, 125%, etc.), a fullness state (such as ‘empty’, ‘partially filled’, ‘almost empty’, ‘almost full’, ‘full’, ‘overfilled’, ‘unknown’, etc.), and so forth. For example, Step 820 and/or Step 1020 may use Step 1120 to identify the fullness level of the container and/or the fullness level of the trash can. In some examples, Step 820 and/or Step 1020 may analyze the one or more images obtained by Step 810 to obtain and/or determine a fullness indicator for a trash can depicted in the one or more images and/or for a container depicted in the one or more images. Further, Step 820 and/or Step 1020 may use the obtained and/or determined fullness indicator to determine whether a type of the depicted trash can is the first type of trash cans and/or whether a type of the depicted container is the first type of containers. For example, in response to a first fullness indicator, Step 820 and/or Step 1020 may determine that the type of the depicted trash can is the first type of trash cans, and in response to a second fullness indicator, Step 820 and/or Step 1020 may determine that the type of the depicted trash can is not the first type of trash cans, may determine that the type of the depicted trash can is a second type of trash cans (different from the first type), and so forth. In another example, in response to a first fullness indicator, Step 820 may determine that the type of the depicted container is the first type of containers, and in response to a second fullness indicator, Step 820 may determine that the type of the depicted container is not the first type of containers, may determine that the type of the depicted container is a second type of containers (different from the first type), and so forth. In some examples, the fullness indicator may be compared with a selected fullness threshold, and Step 820 and/or Step 1020 may determine the type of the depicted trash can and/or type of the depicted container based on a result of the comparison. Such threshold may be selected based on context, geographical location, presence and/or state of other trash cans and/or containers in the vicinity of the depicted trash can and/or the depicted container, and so forth. For example, in response to the obtained fullness indicator being higher than the selected threshold, Step 820 and/or Step 1020 may determine that the depicted trash can is not of the first type of trash cans and/or that the depicted container is not of the first type of containers. In another example, in response to a first result of the comparison of the fullness indicator with the selected fullness threshold, Step 820 and/or Step 1020 may determine that the depicted trash can is of the first type of trash cans and/or that the depicted container is of the first type of containers, and in response to a second result of the comparison of the fullness indicator with the selected fullness threshold, Step 820 and/or Step 1020 may determine that the depicted trash can is not of the first type of trash cans and/or that the depicted container is not of the first type of containers and/or that the depicted trash can is of the second type of trash cans and/or that the depicted container is of the second type of containers.

In some examples, Step 820 and/or Step 1020 may analyze the one or more images obtained by Step 810 to determine whether a trash can depicted in the one or more images is overfilled and/or to determine whether a container depicted in the one or more images is overfilled. In some examples, Step 820 and/or Step 1020 may use a determination that the trash can depicted in the one or more images is overfilled to determine a type of the depicted trash can. For example, in response to a determination that the trash can depicted in the one or more images is overfilled, Step 820 and/or Step 1020 may determine that the type of the depicted trash can is the first type of trash cans, and in response to a determination that the trash can depicted in the one or more images is not overfilled, Step 820 and/or Step 1020 may determine that the type of the depicted trash can is not the first type of trash cans, may determine that the type of the depicted trash can is a second type of trash cans (different from the first type), and so forth. In some examples, Step 820 may use a determination that the container depicted in the one or more images is overfilled to determine a type of the depicted container. For example, in response to a determination that the container depicted in the one or more images is overfilled, Step 820 may determine that the type of the depicted container is the first type of containers, and in response to a determination that the container depicted in the one or more images is not overfilled, Step 820 may determine that the type of the depicted container is not the first type of containers, may determine that the type of the depicted container is a second type of containers (different from the first type), and so forth. For example, a machine learning model may be trained using training examples to determine whether trash can and/or containers are overfilled from images and/or videos, and the trained machine learning model may be used by Step 820 and/or Step 1020 to analyze the one or more images obtained by Step 810 to determine whether a trash can depicted in the one or more images is overfilled and/or to determine whether a container depicted in the one or more images is overfilled. An example of such training example may include an image and/or a video of a trash can and/or a container, together with an indication of whether the trash can and/or the container are overfilled. In another example, an artificial neural network (such as a deep neural network, a convolutional neural network, etc.) may be configured to determine whether trash can and/or containers are overfilled from images and/or videos, and the artificial neural network may be used by Step 820 and/or Step 1020 to analyze the one or more images obtained by Step 810 to determine whether a trash can depicted in the one or more images is overfilled and/or to determine whether a container depicted in the one or more images is overfilled.

In some examples, Step 820 and/or Step 1020 may analyze the one or more images obtained by Step 810 to identify a state of a lid of the container and/or of the trash can. For example, a machine learning model may be trained using training examples to identify states of lids of containers and/or trash cans from images and/or videos, and the trained machine learning model may be used to analyze the one or more images obtained by Step 810 and identify the state of the lid of the container and/or of the trash can. An example of such training example may include an image and/or a video of a container and/or a trash can, together with an indication of the state of the lid of the container and/or the trash can. In another example, an artificial neural network (such as a deep neural network, a convolutional neural network, etc.) may be configured to identify states of lids of containers and/or trash cans from images and/or videos, and the artificial neural network may be used to analyze the one or more images obtained by Step 810 and identify the state of the lid of the container and/or of the trash can. In yet another example, an angle of the lid of the container and/or the trash can (for example, with respect to another part of the container and/or the trash can, with respect to the ground, with respect to the horizon, and so forth) may be identified (for example as described below), and the state of the lid of the container and/or of the trash can may be determined based on the identified angle of the lid of the container and/or the trash can. For example, in response to a first identified angle of the lid of the container and/or the trash can, it may be determined that the state of the lid is a first state, and in response to a second identified angle of the lid of the container and/or the trash can, it may be determined that the state of the lid is a second state (different from the first state). In an additional example, a distance of at least part of the lid of the container and/or the trash can from at least one other part of the container and/or trash can may be identified (for example as described below), and the state of the lid of the container and/or of the trash can may be determined based on the identified distance. For example, in response to a first identified distance, it may be determined that the state of the lid is a first state, and in response to a second identified distance, it may be determined that the state of the lid is a second state (different from the first state). Further, in some examples, a type of the container and/or the trash can may be determined using the identified state of the lid of the container and/or the trash can. For example, in response to a first determined state of the lid, it may be determined that the type of the container and/or of the trash can is a first type, and in response to a second determined state of the lid, it may be determined that the type of the container and/or of the trash can is a second type (different from the first type).

In some examples, Step 820 and/or Step 1020 may analyze the one or more images obtained by Step 810 to identify an angle of a lid of the container and/or of the trash can (for example, with respect to another part of the container and/or of the trash can, with respect to the ground, with respect to the horizon, and so forth). For example, an object detection algorithm may detect the lid of the container and/or of the trash can in the image, may detect the other part of the container and/or of the trash can, and the angle between the lid and the other part may be measured geometrically in the image. In another example, an object detection algorithm may detect the lid of the container and/or of the trash can in the image, a horizon may be detected in the image using a horizon detection algorithm, and the angle between the lid and the horizon may be measured geometrically in the image. Further, the type of the trash can may be identified using the identified angle of the lid of the container and/or of the trash can. For example, in response to a first identified angle of the lid of the container and/or the trash can, it may be determined that the type of the container and/or of the trash can is a first type, and in response to a second identified angle of the lid of the container and/or the trash can, it may be determined that the type of the container and/or of the trash can is a second type (different from the first type).

In some examples, Step 820 and/or Step 1020 may analyze the one or more images obtained by Step 810 to identify a distance of at least part of a lid of the trash can from at least one other part of the container and/or of the trash can. For example, an object detection algorithm may detect the at least part of the lid of the container and/or of the trash can in the image, may detect the other part of the container and/or of the trash can, and the distance of the at least part of a lid of the trash can from at least one other part of the container and/or of the trash can may be measured geometrically in the image, may be measured in the real world using location of the at least part of a lid of the trash can and location of the at least one other part of the container and/or of the trash can in depth images. Further, the type of the trash can may be identified using the identified distance. For example, in response to a first identified distance, it may be determined that the type of the container and/or of the trash can is a first type, and in response to a second identified distance, it may be determined that the type of the container and/or of the trash can is a second type (different from the first type).

In some examples, the at least one type of items and/or the at least one type of containers of Step 820 and/or Step 830 may comprise at least a first type of containers configured to hold objects designated to be collected using the vehicle of Step 810 and/or Step 830. In some examples, the at least one type of items of Step 820 and/or Step 830 may comprise at least bulky waste.

In some examples, the at least one selected type of items and/or the at least one selected type of containers of Step 820 and/or Step 830 may be selected based on context, geographical location, presence and/or state of other trash cans and/or containers in the vicinity of the depicted trash can and/or the depicted container, identity and/or type of the vehicle of Step 810 and/or Step 830, and so forth.

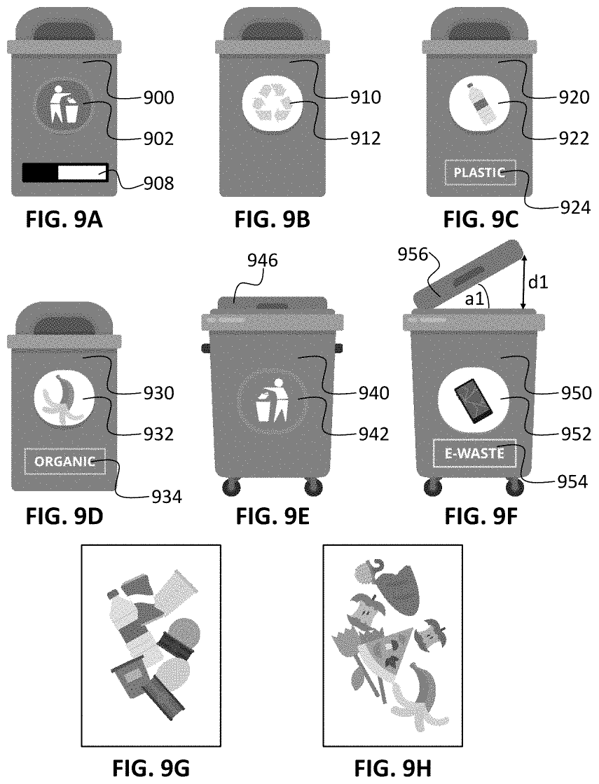

FIG. 9A is a schematic illustration of a trash can 900, with external visual indicator 908 of the fullness level of trash can 900 and logo 902 presented on trash can 900, where external visual indicator 908 and/or logo 902 may be indicative of the type of trash can 900. In some examples, external visual indicator 908 may have different visual appearances to indicate different fullness levels of trash can 900. For example, external visual indicator 908 may present a picture of at least part of the content of trash can 900, and therefore be indicative of the fullness level of trash can 900. In another example, external visual indicator 908 may include a visual indicator of the fullness level of trash can 900, such as a needle positioned according to the fullness level of trash can 900, a number indicative of the fullness level of trash can 900, a textual information indicative of the fullness level of trash can 900, a display of a color indicative of the fullness level of trash can 900, a graph indicative of the fullness level of trash can 900 (such as the bar graph in the example illustrated in FIG. 9A), and so forth. FIG. 9B is a schematic illustration of a trash can 910, with logo 912 presented on trash can 910, where logo 912 may be indicative of the type of trash can 910. FIG. 9C is a schematic illustration of a trash can 920, with logo 922 presented on trash can 920 and a visual presentation of textual information 924 including the word ‘PLASTIC’ presented on trash can 920, both logo 922 and the visual presentation of textual information 924 may be indicative of the type of trash can 920. FIG. 9D is a schematic illustration of a trash can 930, with logo 932 presented on trash can 930 and a visual presentation of textual information 934 including the word ‘ORGANIC’ presented on trash can 930, both logo 932 and the visual presentation of textual information 934 may be indicative of the type of trash can 930. FIG. 9E is a schematic illustration of a trash can 940, with closed lid 946, and with logo 942 presented on trash can 940, where closed lid 946 and/or logo 942 may be indicative of the type of trash can 940. FIG. 9F is a schematic illustration of a trash can 950 with a partially opened lid 956, logo 952 presented on trash can 950 and a visual presentation of textual information 954 including the word ‘E-WASTE’ presented on trash can 950, where partially opened lid 956 and/or logo 952 and/or the visual presentation of textual information 954 may be indicative of the type of trash can 950. In this example, dl is a distance between a selected point of lid 956 and a selected point of the body of trash can 950, and al is an angle between lid 956 and the body of trash can 950. FIG. 9G is a schematic illustration the content of a trash can comprising both plastic and metal objects. FIG. 9H is a schematic illustration the content of a trash can comprising organic objects.

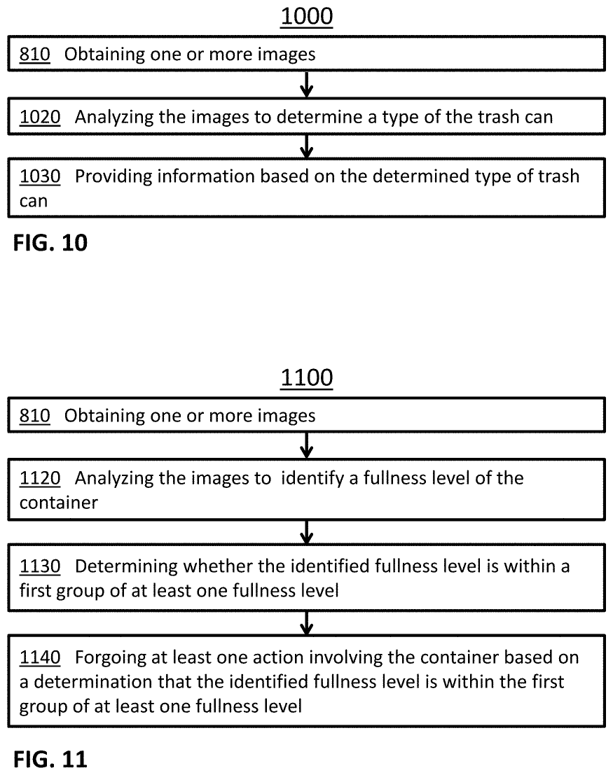

FIG. 10 illustrates an example of a method 1000 for providing information about trash cans. In this example, method 1000 may comprise: obtaining one or more images (Step 810), such as one or more images captured using one or more image sensors and depicting at least part of a trash can; analyzing the images to determine a type of the trash can (Step 1020); and providing information based on the determined type of the trash can (Step 1030). In some implementations, method 1000 may comprise one or more additional steps, while some of the steps listed above may be modified or excluded. For example, in some cases Step 810 and/or Step 1020 and/or Step 1030 may be excluded from method 1000. In some implementations, one or more steps illustrated in FIG. 10 may be executed in a different order and/or one or more groups of steps may be executed simultaneously and/or a plurality of steps may be combined into single step and/or a single step may be broken down to a plurality of steps. Some non-limiting examples of such type of trash cans may include a trash can for paper, a trash can for plastic, a trash can for glass, a trash can for metals, a trash can for non-recyclable waste, a trash can for mixed recycling waste, a trash can for biodegradable waste, a trash can for packaging products, and so forth.

In some embodiments, analyzing the images to determine a type of the trash can (Step 1020) may comprise analyzing the one or more images obtained by Step 810 to determine a type of the trash can, for example as described above.

In some embodiments, providing information based on the determined type of the trash can (Step 1030) may comprise providing information based on the type of the trash can determined by Step 1020. For example, in response to a first determined type of trash can, Step 1030 may provide first information, and in response to a second determined type of trash can, may 1030 may withhold and/or forgo providing the first information, may provide a second information (different from the first information), and so forth.

In some examples, Step 1030 may provide the first information to a user, and the provided first information may be configured to cause the user to initiate an action involving the trash can. In some examples, Step 1030 may provide the first information to an external system, and the provided first information may be configured to cause the external system to perform an action involving the trash can. Some non-limiting examples of such actions may include moving the trash can, obtaining one or more objects placed within the trash can, changing a physical state of the trash can, and so forth. In some examples, the first information may be configured to cause an adjustment to a route of a vehicle. In some examples, the first information may be configured to cause an update to a list of tasks.

FIG. 11 illustrates an example of a method 1100 for selectively forgoing actions based on fullness level of containers. In this example, method 1100 may comprise: obtaining one or more images (Step 810), such as one or more images captured using one or more image sensors and depicting at least part of a container; analyzing the images to identify a fullness level of the container (Step 1120); determining whether the identified fullness level is within a first group of at least one fullness level (Step 1130); and forgoing at least one action involving the container based on a determination that the identified fullness level is within the first group of at least one fullness level (Step 1140). In some implementations, method 1100 may comprise one or more additional steps, while some of the steps listed above may be modified or excluded. For example, in some cases Step 810 and/or Step 1120 and/or Step 1130 and/or Step 1140 may be excluded from method 1100. In some implementations, one or more steps illustrated in FIG. 11 may be executed in a different order and/or one or more groups of steps may be executed simultaneously and/or a plurality of steps may be combined into single step and/or a single step may be broken down to a plurality of steps.

In some examples, the one or more images obtained by Step 810 and/or analyzed by Step 1120 may depict at least part of the content of the container, at least one internal part of the container, at least one external part of the container, and so forth.

In some embodiments, analyzing the images to identify a fullness level of the container (Step 1120) may comprise analyzing the one or more images obtained by Step 810 to identify a fullness level of the container (such as a trash can and/or other type of containers). Some non-limiting examples of such fullness level may include a fullness percent (such as 20%, 80%, 100%, 125%, etc.), a fullness state (such as ‘empty’, ‘partially filled’, ‘almost empty’, ‘almost full’, ‘full’, ‘overfilled’, ‘unknown’, etc.), and so forth. For example, a machine learning model may be trained using training examples to identify fullness level of containers (for example of a trash cans and/or of other containers of other types), and the trained machine learning model may be used to analyze the one or more images obtained by Step 810 and identify the fullness level of the container and/or of the trash can. An example of such training example may comprise an image of at least part of a container and/or at least part of a trash can, together with an indication of the fullness level of the container and/or trash can. In another example, an artificial neural network (such as a deep neural network, a convolutional neural network, etc.) may be configured to identify fullness level of containers (for example of a trash cans and/or of other containers of other types), and the artificial neural network may be used to analyze the one or more images obtained by Step 810 and identify the fullness level of the container and/or of the trash can.

In some examples, the container may be configured to provide a visual indicator associated with the fullness level of the container on at least one external part of the container. For example, the visual indicator may present a picture of at least part of the content of the container, and therefore be indicative of the fullness level of the container. In another example, the visual indicator of the fullness level of the container may include a needle positioned according to the fullness level of the container, a number indicative of the fullness level of the container, a textual information indicative of the fullness level of the container, a display of a color indicative of the fullness level of the container, a graph indicative of the fullness level of the container, and so forth. In yet another example, a trash can may be configured to provide a visual indicator associated with the fullness level of the trash can on at least one external part of the trash can, for example as described above in relation to FIG. 9A.

In some examples, Step 1120 may analyze the one or more images obtained by Step 810 to detect the visual indicator associated with the fullness level of the container and/or of the trash can, for example using an object detector, using a machine learning model trained using training examples to detect the visual indicator, by searching for the visual indicator at a known position on the container and/or the trash can, and so forth. Further, in some examples, Step 1120 may use the detected visual indicator to identify the fullness level of the container and/or of the trash can. For example, in response to a first state and/or appearance of the visual indicator, Step 1120 may identify a first fullness level, and in response to a second state and/or appearance of the visual indicator, Step 1120 may identify a second fullness level (different from the first fullness level). In another example, fullness level may be calculated as a function of the state and/or appearance of the visual indicator.

In some examples, Step 1120 may analyze the one or more images obtained by Step 810 to identify a state of a lid of the container and/or of the trash can, for example using Step 820 and/or Step 1020 as described above. Further, Step 1120 may identify the fullness level of the container and/or of the trash can using the identified state of the lid of the container and/or of the trash can. For example, in response to a first state of the lid of the container and/or of the trash can, Step 1120 may identify a first fullness level of the container and/or of the trash can, and in response to a second state of the lid of the container and/or of the trash can, Step 1120 may identify a second fullness level of the container and/or of the trash can (different from the first fullness level).

In some examples, Step 1120 may analyze the one or more images obtained by Step 810 to identify an angle of a lid of the container and/or of the trash can (for example, with respect to another part of the container and/or the trash can, with respect to the ground, with respect to the horizon, and so forth), for example using Step 820 and/or Step 1020 as described above. Further, Step 1120 may identify the fullness level of the container and/or of the trash can using the identified angle of the lid of the container and/or of the trash can. For example, in response to a first angle of the lid of the container and/or of the trash can, Step 1120 may identify a first fullness level of the container and/or of the trash can, and in response to a second angle of the lid of the container and/or of the trash can, Step 1120 may identify a second fullness level of the container and/or of the trash can (different from the first fullness level).

In some examples, Step 1120 may analyze the one or more images obtained by Step 810 to identify a distance of at least part of a lid of the container and/or of the trash can from at least one other part of the container and/or of the trash can, for example using Step 820 and/or Step 1020 as described above. Further, Step 1120 may identify the fullness level of the container and/or of the trash can using the identified distance of the at least part of a lid of the container and/or of the trash can from the at least one other part of the container and/or of the trash can. For example, in response to a first identified distance, Step 1120 may identify a first fullness level of the container and/or of the trash can, and in response to a second identified distance, Step 1120 may identify a second fullness level of the container and/or of the trash can (different from the first fullness level).

In some embodiments, determining whether the identified fullness level is within a first group of at least one fullness level (Step 1130) may comprise determining whether the fullness level identified by Step 1120 is within a first group of at least one fullness level. In some examples, Step 1130 may compare the fullness level of the container and/or of the trash can identified by Step 1120 with a selected fullness threshold. Further, in response to a first result of the comparison of the identified fullness level of the container and/or the trash can with the selected fullness threshold, Step 1130 may determine that the identified fullness level is within the first group of at least one fullness level, and in response to a second result of the comparison of the identified fullness level of the container and/or the trash can with the selected fullness threshold, Step 1130 may determine that the identified fullness level is not within the first group of at least one fullness level. In some examples, the first group of at least one fullness level may be a group of a number of fullness levels (for example, a group of a single fullness level, a group of at least two fullness levels, a group of at least ten fullness levels, etc.). Further, the fullness level identified by Step 1120 may be compared with the elements of the first group to determine whether the fullness level identified by Step 1120 is within the first group. In some examples, the first group of at least one fullness level may comprise an empty container and/or an empty trash can. Further, in response to a determination that the container and/or the trash can are empty, Step 1130 may determine that the identified fullness level is within the first group of at least one fullness level. In some examples, the first group of at least one fullness level may comprise an overfilled container and/or an overfilled trash can. Further, in response to a determination that the container and/or the trash can are overfilled, Step 1130 may determine that the identified fullness level is within the first group of at least one fullness level.

In some embodiments, Step 1130 may comprise determining the first group of at least one fullness level using a type of the container and/or of the trash can. In some examples, the one or more images obtained by Step 810 may be analyzed to determine the type of the container and/or of the trash can, for example using Step 1020 as described above, and Step 1130 may comprise determining the first group of at least one fullness level using the type of the container and/or of the trash can determined by analyzing the one or more images obtained by Step 810. In some examples, the first group of at least one fullness level may be selected from a plurality of alternative groups of fullness levels based on the type of the container and/or of the trash can. In some examples, a parameter defining the first group of at least one fullness level may be calculated using the type of the container and/or of the trash can. In some examples, in response to a first type of the container and/or of the trash can, Step 1130 may determine that the first group of at least one fullness level include a first value, and in response to a second type of the container and/or of the trash can, Step 1130 may determine that the first group of at least one fullness level does not include the first value.

In some embodiments, forgoing at least one action involving the container based on a determination that the identified fullness level is within the first group of at least one fullness level (Step 1140) may comprise forgoing at least one action involving the container and/or the trash can based on a determination by Step 1130 that the identified fullness level is within the first group of at least one fullness level. In some examples, in response to a determination that the identified fullness level is not within the first group of at least one fullness level, Step 1140 may perform the at least one action involving the container and/or the trash can, and in response to a determination that the identified fullness level is within the first group of at least one fullness level, Step 1140 may withhold and/or forgo performing the at least one action. In some examples, in response to a determination that the identified fullness level is not within the first group of at least one fullness level, Step 1140 may provide first information, and the first information may be configured to cause the performance of the at least one action involving the container and/or the trash can, and in response to a determination that the identified fullness level is within the first group of at least one fullness level, Step 1140 may withhold and/or forgo providing the first information. For example, the first information may be provided to a user, may include instructions for the user to perform the at least one action, and so forth. In another example, the first information may be provided to an external system, may include instructions for the external system to perform the at least one action, and so forth. In yet another example, the first information may be provided to a list of pending tasks. In an additional example, the first information may include information configured to enable a user and/or an external system to perform the at least one action. In yet another example, Step 1140 may provide the first information by storing it in memory (such as memory units 210, shared memory modules 410, and so forth), by transmitting it over a communication network using a communication device (such as communication modules 230, internal communication modules 440, external communication modules 450, and so forth), by visually presenting it to a user, by audibly presenting it to a user, and so forth. In some examples, in response to the determination that the identified fullness level is within the first group of at least one fullness level, Step 1140 may provide a notification to a user, and in response to the determination that the identified fullness level is not within the first group of at least one fullness level, Step 1140 may withhold and/or forgo providing the notification to the user, may provide a different notification to the user, and so forth.

In some embodiments, the one or more image sensors used to capture the one or more images obtained by Step 810 may be configured to be mounted to a vehicle, and the at least one action of Step 1140 may comprise adjusting a route of the vehicle to bring the vehicle to a selected position with respect to the container and/or the trash can, for example using Step 830 as described above.

In some embodiments, the container may be a trash can, and the at least one action of Step 1140 may comprise emptying the trash can. For example, the emptying of the trash can may be performed by an automated mechanical system without human intervention. In another example, the emptying of the trash can may be performed by a human, such as a cleaning worker, a waste collector, a driver and/or an operator of a garbage truck, and so forth. In yet another example, the one or more image sensors used to capture the one or more images obtained by Step 810 may be configured to be mounted to a garbage truck, and the at least one action of Step 1140 may comprise collecting the content of the trash can with the garbage truck.

In some embodiments, Step 1140 may comprise forgoing the at least one action involving the container and/or the trash can based on a combination of at least two of a determination that an identified fullness level of the container and/or the trash can is within the first group of at least one fullness level (for example, as determined using Step 1120), a type of the container and/or of the trash can (for example, as determined using Step 1020), and a type of at least one item in the container and/or in the trash can (for example, as determined using Step 1220). For example, in response to a first identified fullness level and a first type of the container and/or of the trash can, Step 1140 may forgo and/or withhold the at least one action, in response to a second identified fullness level and the first type of the container and/or of the trash can, Step 1140 may enable the performance of the at least one action, and in response to the first identified fullness level and a second type of the container and/or of the trash can, Step 1140 may enable the performance of the at least one action. In another example, in response to a first identified fullness level and a first type of the at least one item in the container and/or in the trash can, Step 1140 may forgo and/or withhold the at least one action, in response to a second identified fullness level and the first type of the at least one item in the container and/or in the trash can, Step 1140 may enable the performance of the at least one action, and in response to the first identified fullness level and a second type of the at least one item in the container and/or in the trash can, Step 1140 may enable the performance of the at least one action. In yet another example, in response to a first identified fullness level, a first type of the container and/or of the trash can and a first type of the at least one item in the container and/or in the trash can, Step 1140 may forgo and/or withhold the at least one action, in response to a second identified fullness level, the first type of the container and/or of the trash can and the first type of the at least one item in the container and/or in the trash can, Step 1140 may enable the performance of the at least one action, in response to the first identified fullness level, a second type of the container and/or of the trash can and the first type of the at least one item in the container and/or in the trash can, Step 1140 may enable the performance of the at least one action, and in response to the first identified fullness level, the first type of the container and/or of the trash can and a second type of the at least one item in the container and/or in the trash can, Step 1140 may enable the performance of the at least one action.

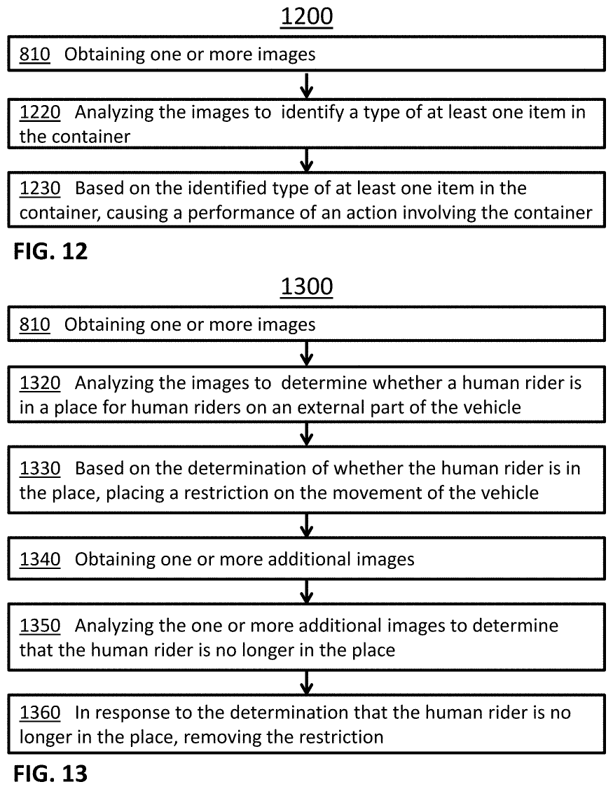

FIG. 12 illustrates an example of a method 1200 for selectively forgoing actions based on the content of containers. In this example, method 1200 may comprise: obtaining one or more images (Step 810), such as one or more images captured using one or more image sensors and depicting at least part of a container; analyzing the images to identify a type of at least one item in the container (Step 1220); and based on the identified type of at least one item in the container, causing a performance of at least one action involving the container (Step 1230). In some implementations, method 1200 may comprise one or more additional steps, while some of the steps listed above may be modified or excluded. For example, in some cases Step 810 and/or Step 1220 and/or Step 1230 may be excluded from method 1200. In some implementations, one or more steps illustrated in FIG. 12 may be executed in a different order and/or one or more groups of steps may be executed simultaneously and/or a plurality of steps may be combined into single step and/or a single step may be broken down to a plurality of steps.

In some embodiments, analyzing the images to identify a type of at least one item in the container (Step 1220) may comprise analyzing the one or more images obtained by Step 810 to identify a type of at least one item in the container and/or in the trash can. Some non-limiting examples of such types of items may include ‘Plastic items’, ‘Paper items’, ‘Glass items’, ‘Metal items’, ‘Recyclable items’, ‘Non-recyclable items’, ‘Mixed recycling waste’, ‘Biodegradable waste’, ‘Packaging products’, ‘Electronic items’, ‘Hazardous materials’, and so forth. In some examples, visual object recognition algorithms may be used to identify the type of at least one item in the container and/or in the trash can from images and/or videos of the at least one items. For example, the one or more images obtained by Step 810 may depict at least part of the content of the container and/or of the trash can (for example as illustrated in FIG. 9G and in FIG. 9H), and the depiction of the items in the container and/or in the trash can in the one or more images obtained by Step 810 may be analyzed using visual object recognition algorithms to identify the type of at least one item in the container and/or in the trash can.

In some examples, the container and/or the trash can may be configured to provide a visual indicator of the type of the at least one item in the container and/or in the trash can on at least one external part of the container and/or of the trash can. Further, the one or more images obtained by Step 810 may depict the at least one external part of the container and/or of the trash can. For example, the visual indicator of the type of the at least one item may include a picture of at least part of the content of the container and/or of the trash can. In another example, the visual indicator of the type of the at least one item may include one or more logos presented on the at least one external part of the container and/or of the trash can (such as logo 902, logo 912, logo 922, logo 932, logo 942, and logo 952), for example presented using a screen, an electronic paper, and so forth. In yet another example, the visual indicator of the type of the at least one item may include textual information presented on the at least one external part of the container and/or of the trash can (such as textual information 924, textual information 934, and textual information 954), for example presented using a screen, an electronic paper, and so forth.

In some examples, Step 1220 may analyze the one or more images obtained by Step 810 to detect the visual indicator of the type of the at least one item in the container and/or in the trash can, for example using an object detector, using an Optical Character Recognition algorithm, using a machine learning model trained using training examples to detect the visual indicator, by searching for the visual indicator at a known position on the container and/or the trash can, and so forth. Further, in some examples, Step 1220 may use the detected visual indicator to identify the type of the at least one item in the container and/or in the trash can. For example, in response to a first state and/or appearance of the visual indicator, Step 1220 may identify a first type of the at least one item, and in response to a second state and/or appearance of the visual indicator, Step 1220 may identify a second type of the at least one item (different from the first type). In another example, a lookup table may be used to determine the type of the at least one item in the container and/or in the trash can from a property of the visual indicator (for example, from the identity of the logo, from the textual information, and so forth).

In some embodiments, causing a performance of at least one action involving the container based on the identified type of at least one item in the container (Step 1230) may comprise causing a performance of at least one action involving the container and/or the trash can based on the type of at least one item in the container and/or in the trash can identified by Step 1220. For example, in response to a first type of at least one item in the container and/or in the trash can identified by Step 1220, Step 1230 may cause a performance of at least one action involving the container and/or the trash can, and in response to a second type of at least one item in the container and/or in the trash can identified by Step 1220, Step 1230 may withhold and/or forgo causing the performance of the at least one action.

In some examples, Step 1230 may determine whether the type identified by Step 1220 is in a group of one or more allowable types. Further, in some examples, in response to a determination that the type identified by Step 1220 is not in the group of one or more allowable types, Step 1230 may withhold and/or forgo causing the performance of the at least one action, and in response to a determination that the type identified by Step 1220 is in the group of one or more allowable types, Step 1230 may cause the performance of at least one action involving the container and/or the trash can. In one example, in response to a determination that the type identified by Step 1220 is not in the group of one or more allowable types, Step 1230 may provide a first notification to a user, and in response to a determination that the type identified by Step 1220 is in the group of one or more allowable types, Step 1230 may withhold and/or forgo providing the first notification to the user, may provide a second notification (different from the first notification) to the user, and so forth. For example, the group of one or more allowable types may comprise exactly one allowable type, at least one allowable type, at least two allowable types, at least ten allowable types, and so forth. In some examples, the group of one or more allowable types may comprise at least one type of waste. For example, the group of one or more allowable types may include at least one type of recyclable objects while not including at least one type of non-recyclable objects. In another example, the group of one or more allowable types may include at least a first type of recyclable objects while not including at least a second type of recyclable objects. In some examples, Step 1230 may use a type of the container and/or of the trash can to determine the group of one or more allowable types. For example, Step 1230 may analyze the one or more images obtained by Step 810 to determine the type of the container and/or of the trash can, for example using Step 1020 as described above. For example, in response to a first type of the container and/or of the trash can, Step 1230 may determine a first group of one or more allowable types, and in response to a second type of the container and/or of the trash can, Step 1230 may determine a second group of one or more allowable types (different from the first group). In another example, Step 1230 may select the group of one or more allowable types from a plurality of alternative groups of types based on the type of the container and/or of the trash can. In yet another example, Step 1230 may calculate a parameter defining the group of one or more allowable types using the type of the container and/or of the trash can.

In some examples, Step 1230 may determine whether the type identified by Step 1220 is in a group of one or more forbidden types. Further, in some examples, in response to a determination that the type identified by Step 1220 is in the group of one or more forbidden types, Step 1230 may withhold and/or forgo causing the performance of the at least one action, and in response to a determination that the type identified by Step 1220 is not in the group of one or more forbidden types, Step 1230 may cause the performance of the at least one action. In one example, in response to the determination that the type identified by Step 1220 is not in the group of one or more forbidden types, Step 1230 may provide a first notification to a user, and in response to the determination that the type identified by Step 1220 is in the group of one or more forbidden types, Step 1230 may withhold and/or forgo providing the first notification to the user, may provide a second notification (different from the first notification) to the user, and so forth. For example, the group of one or more forbidden types may comprise exactly one forbidden type, at least one forbidden type, at least two forbidden types, at least ten forbidden types, and so forth. In one example, the group of one or more forbidden types may include at least one type of hazardous materials. In some examples, the group of one or more forbidden types may include at least one type of waste. For example, the group of one or more forbidden types may include non-recyclable waste. In another example, the group of one or more forbidden types may include at least a first type of recyclable objects while not including at least a second type of recyclable objects. In some examples, Step 1230 may use a type of the container and/or of the trash can to determine the group of one or more forbidden types. For example, Step 1230 may analyze the one or more images obtained by Step 810 to determine the type of the container and/or of the trash can, for example using Step 1020 as described above. For example, in response to a first type of the container and/or of the trash can, Step 1230 may determine a first group of one or more forbidden types, and in response to a second type of the container and/or of the trash can, Step 1230 may determine a second group of one or more forbidden types (different from the first group). In another example, Step 1230 may select the group of one or more forbidden types from a plurality of alternative groups of types based on the type of the container and/or of the trash can. In yet another example, Step 1230 may calculate a parameter defining the group of one or more forbidden types using the type of the container and/or of the trash can.

In some embodiments, the one or more image sensors used to capture the one or more images obtained by Step 810 may be configured to be mounted to a vehicle, and the at least one action of Step 1230 may comprise adjusting a route of the vehicle to bring the vehicle to a selected position with respect to the container and/or the trash can, for example using Step 830 as described above.

In some embodiments, the container may be a trash can, and the at least one action of Step 1230 may comprise emptying the trash can. For example, the emptying of the trash can may be performed by an automated mechanical system without human intervention. In another example, the emptying of the trash can may be performed by a human, such as a cleaning worker, a waste collector, a driver and/or an operator of a garbage truck, and so forth. In yet another example, the one or more image sensors used to capture the one or more images obtained by Step 810 may be configured to be mounted to a garbage truck, and the at least one action of Step 1230 may comprise collecting the content of the trash can with the garbage truck.

In some examples, Step 810 may obtain an image of the content of a trash can illustrated in FIG. 9G. In this example, the content of the trash can includes both plastic and metal objects. Further, Step 1220 may analyze the image of the content of a trash can illustrated in FIG. 9G and determine that the content of the trash can includes both plastic and metal waste, but does not include organic waste, hazardous materials, or electronic waste. Further, Step 1230 may determine actions involving the trash can to be performed and actions involving the trash can to be forgone. For example, Step 1230 may cause a garbage truck collecting plastic waste but not metal waste to forgo collecting the content of the trash can. In another example, Step 1230 may cause a garbage truck collecting mixed recycling waste to collect the content of the trash can. In yet another example, when the trash can is originally dedicated to metal waste but not to plastic waste, Step 1230 may cause a notification to be provided to a user informing the user about the misuse of the trash can.

In some examples, Step 810 may obtain a first image of the content of a first trash can illustrated in FIG. 9G and a second image of the content of a second trash can illustrated in FIG. 9H. In this example, the content of the first trash can includes both plastic and metal objects, and the content of the second trash can includes organic waste. Further, Step 1220 may analyze the first image and determine that the content of the first trash can includes both plastic waste and metal waste, but does not include organic waste, hazardous materials, or electronic waste. Further, Step 1220 may analyze the second image and determine that the content of the second trash can includes organic waste, but does not include plastic waste, metal waste, hazardous materials, or electronic waste. In one example, Step 1230 may use a group of one or more allowable types that includes plastic waste and organic waste but do not include metal waste, and as a result Step 1230 may cause a performance an action of a first kind with the second trash can, and forgo causing the action of the first kind with the first trash can. In another example, Step 1230 may use a group of one or more allowable types that includes plastic waste and metal waste but do not include organic waste, and as a result Step 1230 may cause a performance an action of a first kind with the first trash can, and forgo causing the action of the first kind with the second trash can. In yet another example, Step 1230 may use a group of one or more forbidden types that includes metal waste but do not plastic waste or organic waste, and as a result Step 1230 may cause a performance an action of a first kind with the second trash can, and forgo causing the action of the first kind with the first trash can. In an additional example, Step 1230 may use a group of one or more forbidden types that includes organic waste but do not plastic waste or metal waste, and as a result Step 1230 may cause a performance an action of a first kind with the first trash can, and forgo causing the action of the first kind with the second trash can.

FIG. 13 illustrates an example of a method 1300 for restricting movement of vehicles. In this example, method 1300 may comprise: obtaining one or more images (Step 810), such as one or more images captured using one or more image sensors and depicting at least part of an external part of a vehicle, the at least part of the external part of the vehicle may comprise at least part of a place for at least one human rider; analyzing the images to determine whether a human rider is in a place for at least one human rider on an external part of the vehicle (Step 1320); based on the determination of whether the human rider is in the place, placing at least one restriction on the movement of the vehicle (Step 1330); obtaining one or more additional images (Step 1340), such as one or more additional images captured using the one or more image sensors after determining that the human rider is in the place for at least one human rider and/or after placing the at least one restriction on the movement of the vehicle; analyzing the one or more additional images to determine that the human rider is no longer in the place (Step 1350); and in response to the determination that the human rider is no longer in the place, removing the at least one restriction on the movement of the vehicle (Step 1360). In some implementations, method 1300 may comprise one or more additional steps, while some of the steps listed above may be modified or excluded. For example, in some cases Step 810 and/or Step 1320 and/or Step 1330 and/or Step 1340 and/or Step 1350 and/or Step 1360 may be excluded from method 1300. In some implementations, one or more steps illustrated in FIG. 13 may be executed in a different order and/or one or more groups of steps may be executed simultaneously and/or a plurality of steps may be combined into single step and/or a single step may be broken down to a plurality of steps.

Some non-limiting examples of possible restrictions on the movement of the vehicle that Step 1330 may place and/or that Step 1360 may remove may include a restriction on the speed of the vehicle, a restriction on the speed of the vehicle to a maximal speed (for example, where the maximal speed is less than 40 kilometers per hour, less than 30 kilometers per hour, less than 20 kilometers per hour, less than 10 kilometers per hour, less than 5 kilometers per hour, etc.), a restriction on the driving distance of the vehicle, a restriction on the driving distance of the vehicle to a maximal distance (for example, where the maximal distance is less than 1 kilometer, less than 600 meters, less than 400 meters, less than 200 meters, less than 100 meters, less than 50 meters, less than 10 meters, etc.), a restriction forbidding the vehicle from driving, a restriction forbidding the vehicle from increasing speed, and so forth.

In some examples, the vehicle of method 1300 may be a garbage truck and the human rider of Step 1320 and/or Step 1330 and/or Step 1350 and/or Step 1360 may be a waste collector. In some examples, the vehicle of method 1300 may be a golf cart, a tractor, and so forth. In some examples, the vehicle of method 1300 may be a crane, and the place for at least one human rider on an external part of the vehicle may be the crane.

In some embodiments, analyzing the images to determine whether a human rider is in a place for at least one human rider on an external part of the vehicle (Step 1320) may comprise analyzing the one or more images obtained by Step 810 to determine whether a human rider is in the place for at least one human rider. For example, a person detector may be used to detect a person in the an image obtained by Step 810, in response to a successful detection of a person in a region of the image corresponding to the place for at least one human rider, Step 1320 may determine that a human rider is in the place for at least one human rider, and in response to a failure to detect a person in the region of the image corresponding to the place for at least one human rider, Step 1320 may determine that a human rider is not in the place for at least one human rider. In another example, a machine learning model may be trained using training examples to determine whether human riders are present in places for human riders at external parts of vehicles from images and/or videos, and the trained machine learning model may be used to analyze the one or more images obtained by Step 810 and determine whether a human rider is in the place for at least one human rider. An example of such training example may include an image and/or a video of a place for a human rider at an external part of a vehicle, together with a desired determination of whether a human rider is in the place according to the image and/or video. In another example, an artificial neural network (such as a deep neural network, a convolutional neural network, etc.) may be configured to determine whether human riders are present in places for human riders at external parts of vehicles from images and/or videos, and the artificial neural network may be used to analyze the one or more images obtained by Step 810 and determine whether a human rider is in the place for at least one human rider.

Alternatively or additionally to determining whether a human rider is in the place for at least one human rider based on image analysis, Step 1320 may analyze inputs from other sensors attached to the vehicle to determine whether a human rider is in the place for at least one human rider. In some examples, the place for at least one human rider may comprise at least a riding step externally attached to the vehicle, a sensor connected to the riding step (such as a weight sensor, a pressure sensor, a touch sensor, etc.) may be used to collect data useful for determining whether a person is standing on the riding step, Step 810 may obtain the data from the sensor (such as weight data from the weight sensor connected to the riding step, pressure data from the pressure sensor connected to the riding step, touch data from the touch sensor connected to the riding step, etc.), and Step 1320 may use the data obtained by Step 810 from the sensor to determine whether a human rider is in the place for at least one human rider. For example, weight data obtained by Step 810 from the weight sensor connected to the riding step may be analyzed by Step 1320 (for example by comparing weight data to selected thresholds) to determine whether a human rider is standing on the riding step, and the determination of whether a human rider is standing on the riding step may be used by Step 1320 to determine whether a human rider is in the place for at least one human rider. In another example, pressure data obtained by Step 810 from the pressure sensor connected to the riding step may be analyzed by Step 1320 to determine whether a human rider is standing on the riding step (for example, analyzed using pattern recognition algorithms to determine whether the pressure patterns in the obtained pressure data are compatible with a person standing on the riding step), and the determination of whether a human rider is standing on the riding step may be used by Step 1320 to determine whether a human rider is in the place for at least one human rider. In yet another example, touch data obtained by Step 810 from the touch sensor connected to the riding step may be analyzed by Step 1320 to determine whether a human rider is standing on the riding step (for example, analyzed using pattern recognition algorithms to determine whether the touch patterns in the obtained touch data are compatible with a person standing on the riding step), and the determination of whether a human rider is standing on the riding step may be used by Step 1320 to determine whether a human rider is in the place for at least one human rider. In some examples, the place for at least one human rider may comprise at least a grabbing handle externally attached to the vehicle, a sensor connected to the grabbing handle (such as a pressure sensor, a touch sensor, etc.) may be used to collect data useful for determining whether a person is holding the grabbing handle, Step 810 may obtain the data from the sensor (such as pressure data from the pressure sensor connected to the grabbing handle, touch data from the touch sensor connected to the grabbing handle, etc.), and Step 1320 may use the data obtained by Step 810 from the sensor to determine whether a human rider is in the place for at least one human rider. For example, pressure data obtained by Step 810 from the pressure sensor connected to the grabbing handle may be analyzed by Step 1320 to determine whether a human rider is holding the grabbing handle (for example, analyzed using pattern recognition algorithms to determine whether the pressure patterns in the obtained pressure data are compatible with a person holding the grabbing handle), and the determination of whether a human rider is holding the grabbing handle may be used by Step 1320 to determine whether a human rider is in the place for at least one human rider. In another example, touch data obtained by Step 810 from the touch sensor connected to the grabbing handle may be analyzed by Step 1320 to determine whether a human rider is holding the grabbing handle (for example, analyzed using pattern recognition algorithms to determine whether the touch patterns in the obtained touch data are compatible with a person holding the grabbing handle), and the determination of whether a human rider is holding the grabbing handle may be used by Step 1320 to determine whether a human rider is in the place for at least one human rider.

In some embodiments, placing at least one restriction on the movement of the vehicle based on the determination of whether the human rider is in the place (Step 1330) may comprise placing at least one restriction on the movement of the vehicle based on the determination of whether the human rider is in the place by Step 1320. For example, in response to a determination by Step 1320 that the human rider is in the place, Step 1330 may place at least one restriction on the movement of the vehicle, and in response to a determination by Step 1320 that the human rider is not in the place, Step 1330 may withhold and/or forgo placing the at least one restriction on the movement of the vehicle. In some examples, placing the at least one restriction on the movement of the vehicle by Step 1330 and/or removing the at least one restriction on the movement of the vehicle by Step 1360 may comprise providing a notification related to the at least one restriction to a driver of the vehicle. For example, the notification may inform the driver about the placed at least one restriction and/or about the removal of the at least one restriction. In another example, the notification may be provided textually, may be provided audibly through an audio speaker, may be provided visually through a screen, and so forth. In yet another example, the notification may be provided through a personal communication device associated with the driver, may be provided through the vehicle, and so forth. In some examples, placing the at least one restriction on the movement of the vehicle by Step 1330 may comprise causing the vehicle to enforce the at least one restriction. In some examples, the vehicle may be an autonomous vehicle, and placing the at least one restriction on the movement of the vehicle by Step 1330 may comprise causing the autonomous vehicle to drive according to the at least one restriction. In some examples, placing the at least one restriction on the movement of the vehicle by Step 1330 and/or removing the at least one restriction on the movement of the vehicle by Step 1360 may comprise providing information about the at least one restriction, by storing the information in memory (such as memory units 210, shared memory modules 410, etc.), by transmitting the information over a communication network using a communication device (such as communication modules 230, internal communication modules 440, external communication modules 450, etc.), and so forth.

In some embodiments, obtaining one or more additional images (Step 1340) may comprise obtaining one or more additional images captured using the one or more image sensors after Step 1320 determined that the human rider is in the place for at least one human rider and/or after Step 1330 placed the at least one restriction on the movement of the vehicle. For example, Step 1340 may use Step 810 to obtain the one or more additional images as described above.

In some embodiments, analyzing the one or more additional images to determine that the human rider is no longer in the place (Step 1350) may comprise analyzing the one or more additional images obtained by Step 1340 to determine that the human rider is no longer in the place for at least one human rider. For example, a person detector may be used to detect a person in the an image obtained by Step 1340, in response to a successful detection of a person in a region of the image corresponding to the place for at least one human rider, Step 1350 may determine that the human rider is still in the place for at least one human rider, and in response to a failure to detect a person in the region of the image corresponding to the place for at least one human rider, Step 1350 may determine that that the human rider is no longer in the place for at least one human rider. In another example, the machine learning model trained using training examples and described above in relation to Step 1320 may be used to analyze the one or more additional images obtained by Step 1340 and determine whether the human rider is still in the place for at least one human rider. In another example, the artificial neural network described above in relation to Step 1320 may be used to analyze the one or more images obtained by Step 1340 and determine whether the human rider is still in the place for at least one human rider.

Alternatively or additionally to determining that the human rider is no longer in the place for at least one human rider based on image analysis, Step 1350 may analyze inputs from other sensors attached to the vehicle to determine whether the human rider is still in the place for at least one human rider. For example, additional data may be obtained by Step 1340 from the sensors connected to the riding step after Step 1320 determined that the human rider is in the place for at least one human rider and/or after Step 1330 placed the at least one restriction on the movement of the vehicle, and the analysis of data from sensors connected to a riding step described above in relation to Step 1320 may be used by Step 1350 to analyze the additional data obtained by Step 1340 and determine whether the human rider is still in the place for at least one human rider. In another example, additional data may be obtained by Step 1340 from the sensors connected to the grabbing handle after Step 1320 determined that the human rider is in the place for at least one human rider and/or after Step 1330 placed the at least one restriction on the movement of the vehicle, and the analysis of data from sensors connected to a grabbing handle described above in relation to Step 1320 may be used by Step 1350 to analyze the additional data obtained by Step 1340 and determine whether the human rider is still in the place for at least one human rider.

In some embodiments, Step 1360 may comprise removing the at least one restriction on the movement of the vehicle placed by Step 1330 based on the determination of whether the human rider is still in the place for at least one human rider by Step 1350. For example, in response to a determination by Step 1350 that the human rider is no longer in the place, Step 1360 may remove the at least one restriction on the movement of the vehicle placed by Step 1330, and in response to a determination by Step 1350 that the human rider is still in the place, Step 1360 may withhold and/or forgo removing the at least one restriction on the movement of the vehicle placed by Step 1330. In some examples, removing the at least one restriction on the movement of the vehicle by Step 1360 may comprise providing a notification to a driver of the vehicle as described above, may comprise causing the vehicle to stop enforce the at least one restriction, causing an autonomous vehicle to stop driving according to the at least one restriction, and so forth.

In some embodiments, Step 1320 may analyze the one or more images obtained by Step 810 to determine whether the human rider in the place is in an undesired position. For example, a machine learning model may be trained using training examples to determine whether human riders in selected places are in undesired positions from images and/or videos, and the trained machine learning model may be used to analyze the one or more images obtained by Step 810 and determine whether the human rider in the place is in an undesired position. An example of such training example may include an image of a human rider in the place together with an indication of whether the human rider is in a desired position or in an undesired position. In another example, an artificial neural network (such as a deep neural network, a convolutional neural network, etc.) may be configured to determine whether human riders in selected places are in undesired positions from images and/or videos, and the artificial neural network may be used to analyze the one or more images obtained by Step 810 and determine whether the human rider in the place is in an undesired position. Further, in some examples, in response to a determination that the human rider in the place is in the undesired position, the at least one restriction on the movement of the vehicle may be adjusted. For example, the adjusted at least one restriction on the movement of the vehicle may comprise forbidding the vehicle from driving, forbidding the vehicle from increasing speed, decreasing a maximal speed of the at least one restriction, decreasing a maximal distance of the at least one restriction, and so forth. For example, in response to a determination that the human rider in the place is in a desired position, Step 1330 may place a first at least one restriction on the movement of the vehicle, and in response to a determination that the human rider in the place is in an undesired position, Step 1330 may place a second at least one restriction on the movement of the vehicle (different from the first at least one restriction). In some examples, the place for at least one human rider may comprise at least a riding step externally attached to the vehicle, and the undesired position may comprise a person not safely standing on the riding step. In some examples, the place for at least one human rider may comprise at least a grabbing handle externally attached to the vehicle, and the undesired position may comprise a person not safely holding the grabbing handle. In some examples, Step 1320 may analyze the one or more images obtained by Step 810 to determine that at least part of the human rider is at least a threshold distance away of the vehicle, and may use the determination that the at least part of the human rider is at least a threshold distance away of the vehicle to determine that the human rider in the place is in the undesired position. For example, using an object detection algorithm to detect the vehicle in the one or more images, a person detection algorithm to detect the human rider in the one or more images, geometrically measuring the distance from at least part of the human rider to the vehicle in the image, and comparing the measured distance in the image with the threshold distance to determine whether at least part of the human rider is at least a threshold distance away of the vehicle. In another example, the distance from at least part of the human rider to the vehicle may be measured in the real world using location of the at least part of the human rider and location of the vehicle in depth images, and Step 1320 may compare the measured distance in the real world with the threshold distance to determine whether at least part of the human rider is at least a threshold distance away of the vehicle.

In some embodiments, image data depicting a road ahead of the vehicle may be obtained, for example by using Step 810 as described above. Further, in some examples, Step 1320 may analyze the image data depicting the road ahead of the vehicle to determine whether the vehicle is about to drive over a bumper and/or over a pothole. For example, Step 1320 may use an object detector to detect bumpers and/or potholes in the road ahead of the vehicle in the image data, in response to a successful detection of one or more bumpers and/or one or more potholes in the road ahead of the vehicle, Step 1320 may determine that the vehicle is about to drive over a bumper and/or over a pothole, and in response to a failure to detect bumpers and/or potholes in the road ahead of the vehicle, Step 1320 may determine that the vehicle is not about to drive over a bumper and/or over a pothole. In another example, a machine learning model may be trained using training examples to determine whether vehicles are about to drive over bumpers and/or potholes from images and/or videos, and Step 1320 may use the trained machine learning model to analyze the image data and determine whether the vehicle is about to drive over a bumper and/or over a pothole. An example of such training example may include an image and/or a video of a road ahead of a vehicle, together with an indication of whether the vehicle is about to drive over a bumper and/or over a pothole. In another example, an artificial neural network (such as a deep neural network, a convolutional neural network, etc.) may be configured to determine whether vehicles are about to drive over bumpers and/or over potholes from images and/or videos, and Step 1320 may use the artificial neural network to analyze the image data and determine whether the vehicle is about to drive over a bumper and/or over a pothole. Further, in some examples, in response to a determination by Step 1320 that the vehicle is about to drive over a bumper and/or over a pothole, Step 1330 may adjust the at least one restriction on the movement of the vehicle. For example, the adjusted at least one restriction on the movement of the vehicle may comprise forbidding the vehicle from driving, forbidding the vehicle from increasing speed, decreasing a maximal speed of the at least one restriction, decreasing a maximal distance of the at least one restriction, and so forth. For example, in response to a determination by Step 1320 that the vehicle is not about to drive over the bumper and/or over a pothole, Step 1330 may place a first at least one restriction on the movement of the vehicle, and in response to a determination by Step 1320 that the vehicle is about to drive over the bumper and/or over a pothole, Step 1330 may place a second at least one restriction on the movement of the vehicle (different from the first at least one restriction).

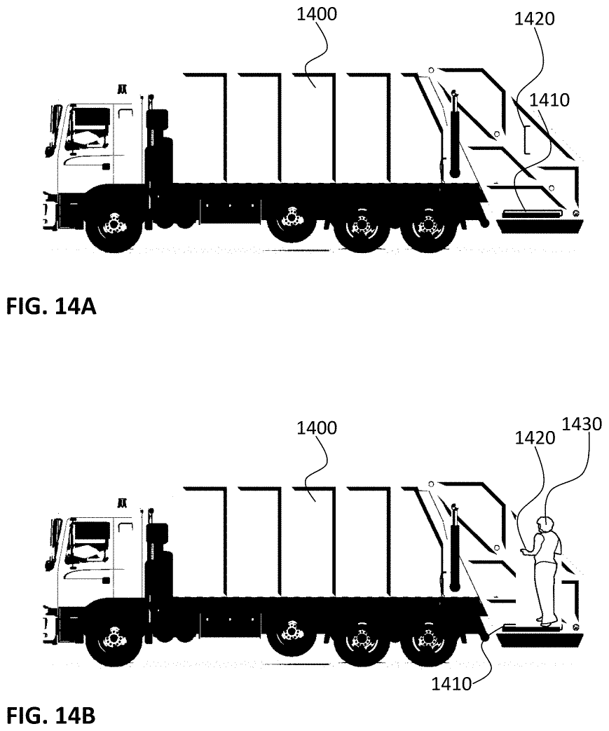

FIGS. 14A and 14B are schematic illustrations of a possible example of a vehicle 1400. In this example, vehicle 1400 is a garbage truck with a place for a human rider on an external part of the vehicle. The place for the human rider includes riding step 1410 and grabbing handle 1420. In FIG. 14A, there is no human rider in the place for a human rider, and in FIG. 14B, human rider 1430 is in the place for a human rider, standing on riding step 1410 and holding grabbing handle 1420. In some examples, in response to no human rider being in the place for a human rider as illustrated in FIG. 14A, Step 1320 may determine that no human rider is in a place for at least one human rider, and Step 1330 may therefore forgo placing restrictions on the movement of vehicle 1400. In some examples, in response to human rider 1430 being in the place for a human rider as illustrated in FIG. 14B, Step 1320 may determine that a human rider is in a place for at least one human rider, and Step 1330 may therefore place at least one restriction on the movement of vehicle 1400. In some examples, after Step 1330 placed the at least one restriction on the movement of the vehicle, human rider 1430 may step out of the place for at least one human rider, Step 1350 may determine that human rider 1430 is no longer in the place, and in response Step 1360 may remove the at least one restriction on the movement of vehicle 1400.

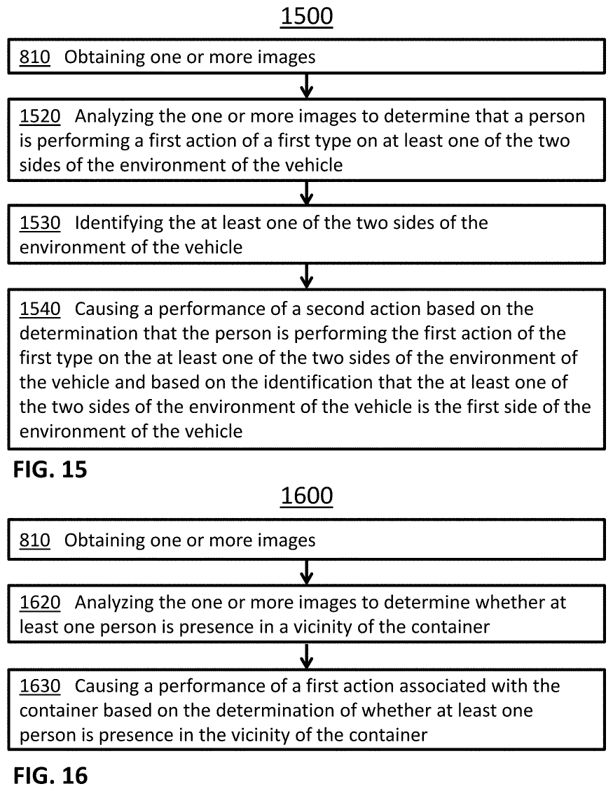

FIG. 15 illustrates an example of a method 1500 for monitoring activities around vehicles. In this example, method 1500 may comprise: obtaining one or more images (Step 810), such as one or more images captured using one or more image sensors and depicting at least two sides of an environment of a vehicle, the at least two sides of the environment of the vehicle may comprise a first side of the environment of the vehicle and a second side of the environment of the vehicle; analyzing the images to determine that a person is performing a first action of a first type on at least one of the two sides of the environment of the vehicle (Step 1520); identifying the at least one of the two sides of the environment of the vehicle (Step 1530); and causing a performance of a second action based on the determination that the person is performing the first action of the first type on the at least one of the two sides of the environment of the vehicle and based on the identification that the at least one of the two sides of the environment of the vehicle is the first side of the environment of the vehicle (Step 1540). In some implementations, method 1500 may comprise one or more additional steps, while some of the steps listed above may be modified or excluded. For example, in some cases Step 810 and/or Step 1520 and/or Step 1530 and/or Step 1540 may be excluded from method 1500. In some implementations, one or more steps illustrated in FIG. 15 may be executed in a different order and/or one or more groups of steps may be executed simultaneously and/or a plurality of steps may be combined into single step and/or a single step may be broken down to a plurality of steps.

In some examples, each of the first side of the environment of the vehicle and the second side of the environment of the vehicle may comprise at least one of the left side of the vehicle, the right side of the vehicle, the front side of the vehicle, and the back side of the vehicle. For example, the first side of the environment of the vehicle may be the left side of the vehicle and the second side of the environment of the vehicle may comprise at least one of the right side of the vehicle, the front side of the vehicle, and the back side of the vehicle. In another example, the first side of the environment of the vehicle may be the right side of the vehicle and the second side of the environment of the vehicle may comprise at least one of the left side of the vehicle, the front side of the vehicle, and the back side of the vehicle. In yet another example, the first side of the environment of the vehicle may be the front side of the vehicle and the second side of the environment of the vehicle may comprise at least one of the left side of the vehicle, the right side of the vehicle, and the back side of the vehicle. In an additional example, the first side of the environment of the vehicle may be the back side of the vehicle and the second side of the environment of the vehicle may comprise at least one of the left side of the vehicle, the right side of the vehicle, and the front side of the vehicle.

In some examples, the vehicle of method 1500 may be on a road, the road may comprise a first roadway and a second roadway, the vehicle may be in the first roadway, and the first side of the environment of the vehicle may correspond to the side of the vehicle facing the second roadway, may correspond to the side of the vehicle opposite to the second roadway, and so forth.

In some embodiments, analyzing the images to determine that a person is performing a first action of a first type on at least one of the two sides of the environment of the vehicle (Step 1520) may comprise analyzing the one or more images obtained by Step 810 to determine that a person is performing a first action of a first type on at least one of the two sides of the environment of the vehicle. For example, action detection and/or recognition algorithms may be used to detect actions of the first type performed by a person in the one or more images obtained by Step 810 (or in a selected portion of the one or more images corresponding to the two sides of the environment of the vehicle), in response to a successful detection of such actions, Step 1520 may determine that a person is performing a first action of a first type on at least one of the two sides of the environment of the vehicle, and in response to a failure to detect such action, Step 1520 may determine that no person is performing an action of the first type on the two sides of the environment of the vehicle. In another example, a machine learning model may be trained using training examples to determine whether actions of selected types are performed on selected sides of vehicles from images and/or videos, and the trained machine learning model may be used to analyze the one or more images obtained by Step 810 and determine whether a person is performing a first action of a first type on at least one of the two sides of the environment of the vehicle. An example of such training examples may include images and/or videos of an environment of a vehicle together with an indication of whether actions of selected types are performed on selected sides of vehicles. In yet another example, an artificial neural network (such as a deep neural network, a convolutional neural network, etc.) may be configured to determine whether actions of selected types are performed on selected sides of vehicles from images and/or videos, and the artificial neural network may be used to analyze the one or more images obtained by Step 810 and determine whether a person is performing a first action of a first type on at least one of the two sides of the environment of the vehicle.

In some examples, the vehicle of method 1500 may comprise a garbage truck, the person of Step 1520 may comprise a waste collector, and the first action of Step 1520 may comprise collecting trash. In some examples, the vehicle of method 1500 may carry a cargo, and the first action of Step 1520 may comprise unloading at least part of the cargo. In some examples, the first action of Step 1520 may comprise loading cargo to the vehicle of method 1500. In some examples, the first action of Step 1520 may comprise entering the vehicle. In some examples, the first action of Step 1520 may comprise exiting the vehicle. In some examples, the first action of Step 1520 may comprise standing. In some examples, the first action of Step 1520 may comprise walking.

In some embodiments, identifying the at least one of the two sides of the environment of the vehicle (Step 1530) may comprise identifying the at least one of the two sides of the environment of the vehicle in which the first action of Step 1520 is performed. In some examples, Step 1520 may use action detection and/or recognition algorithms to detect the first action in the one or more images obtained by Step 810, and Step 1530 may identify the at least one of the two sides of the environment of the vehicle in which the first action of Step 1520 is performed according to a location within the one or more images obtained by Step 810 in which the first action is detected. For example, a first portion of the one or more images obtained by Step 810 may correspond to the first side of the environment of the vehicle, a second portion of the one or more images obtained by Step 810 may correspond to the second side of the environment of the vehicle, in response to detection of the first action at the first portion, Step 1530 may identify that the at least one of the two sides of the environment of the vehicle is the first side of the environment of the vehicle, and in response to detection of the first action at the second portion, Step 1530 may identify that the at least one of the two sides of the environment of the vehicle is the second side of the environment of the vehicle. In some examples, Step 1520 may use a machine learning model to determine whether a person is performing a first action of a first type on at least one of the two sides of the environment of the vehicle. The same machine learning model may be further trained to identify the side of the environment of the vehicle in which the first action is performed, for example by including an indication of the side of the environment in the training examples, and Step 1530 may use the trained machine learning model to analyze the one or more images obtained by Step 810 and identify the at least one of the two sides of the environment of the vehicle in which the first action of Step 1520 is performed.

In some embodiments, causing a performance of a second action based on the determination that the person is performing the first action of the first type on the at least one of the two sides of the environment of the vehicle and based on the identification that the at least one of the two sides of the environment of the vehicle is the first side of the environment of the vehicle (Step 1540) may comprise causing a performance of a second action based on the determination that the person is performing the first action of the first type on the at least one of the two sides of the environment of the vehicle by Step 1520 and based on the identification that the at least one of the two sides of the environment of the vehicle is the first side of the environment of the vehicle by Step 1530. For example, in response to the determination by Step 1520 that the person is performing the first action of the first type on the at least one of the two sides of the environment of the vehicle and in response to the identification by Step 1530 that the at least one of the two sides of the environment of the vehicle is the first side of the environment of the vehicle, Step 1540 may cause a performance of a second action, and in response to the determination by Step 1520 that the person is performing the first action of the first type on the at least one of the two sides of the environment of the vehicle and in response to the identification by Step 1530 that the at least one of the two sides of the environment of the vehicle is the second side of the environment of the vehicle, Step 1540 may withhold and/or forgo causing the performance of the second action.

In some examples, an indication that the vehicle is on a one way road may be obtained. For example, the indication that the vehicle is on a one way road may be obtained from a navigational system, may be obtained from a human user, may be obtained by analyzing the one or more images obtained by Step 810 (for example as described below), and so forth. Further, in some examples, in response to the determination that the person is performing the first action of the first type on the at least one of the two sides of the environment of the vehicle, to the identification that the at least one of the two sides of the environment of the vehicle is the first side of the environment of the vehicle, and to the indication that the vehicle is on a one way road, Step 1540 may withhold and/or forgo performing the second action. In some examples, the one or more images obtained by Step 810 may be analyzed to obtain the indication that the vehicle is on a one way road. For example, a machine learning model may be trained using training examples to determine whether vehicles are in one way roads from images and/or videos, and the trained machine learning model may be used to analyze the one or more images obtained by Step 810 and determine whether the vehicle of method 1500 is on a one way road. An example of such training example may include an image and/or a video of a road, together with an indication of whether the road is a one way road. In another example, an artificial neural network (such as a deep neural network, a convolutional neural network, etc.) may be configured to determine whether vehicles are in one way roads from images and/or videos, and the artificial neural network may be used to analyze the one or more images obtained by Step 810 and determine whether the vehicle of method 1500 is on a one way road.

In some examples, the second action of Step 1540 may comprise providing a notification to a user, such as a driver of the vehicle of method 1500, a passenger of the vehicle of method 1500, a user of the vehicle of method 1500, a supervisor supervising the vehicle of method 1500, and so forth. For example, the notification may be provided textually, may be provided audibly through an audio speaker, may be provided visually through a screen, may be provided through a personal communication device associated with the driver, may be provided through the vehicle, and so forth.

In some examples, causing the performance of the second action by Step 1540 may comprise providing information configured to cause and/or to enable the performance of the second action, for example by storing the information in memory (such as memory units 210, shared memory modules 410, etc.), by the transmitting the information over a communication network using a communication device (such as communication modules 230, internal communication modules 440, external communication modules 450, etc.), and so forth. In some examples, causing the performance of the second action by Step 1540 may comprise performing the second action.

In some examples, the vehicle of method 1500 may be an autonomous vehicle, and causing the performance of the second action by Step 1540 may comprise causing the autonomous vehicle to drive according to selected parameters.

In some examples, causing the performance of the second action by Step 1540 may comprise causing an update to statistical information associated with the first action, updating statistical information associated with the first action, and so forth. For example, the statistical information associated with the first action may include a count of the first action in selected context.

In some examples, Step 1520 may analyze the one or more images obtained by Step 810 to identify a property of the person performing the first action, and Step 1540 may select the second action based on the identified property of the person performing the first action. For example, in response to a first identified property of the person performing the first action, Step 1540 may select one action as the second action, and in response to a second identified property of the person performing the first action, Step 1540 may select a different action as the second action. For example, Step 1520 may use person recognition algorithms to analyze the one or more images obtained by Step 810 and identify the property of the person performing the first action. In another example, a machine learning model may be trained using training examples to identify properties of people from images and/or videos, and Step 1520 may use the trained machine learning model to analyze the one or more images obtained by Step 810 and identify the property of the person performing the first action. An example of such training example may include an image and/or a video of a person, together with an indication of a property of the person. In yet another example, an artificial neural network (such as a deep neural network, a convolutional neural network, etc.) may be configured to identify properties of people from images and/or videos, and Step 1520 may use the artificial neural network to analyze the one or more images obtained by Step 810 and identify the property of the person performing the first action.

In some examples, Step 1520 may analyze the one or more images obtained by Step 810 to identify a property of the first action, and Step 1540 may select the second action based on the identified property of the first action. For example, in response to a first identified property of the first action, Step 1540 may select one action as the second action, and in response to a second identified property of the first action, Step 1540 may select a different action as the second action. For example, Step 1520 may use action recognition algorithms to analyze the one or more images obtained by Step 810 and identify the property of the first action. In another example, a machine learning model may be trained using training examples to identify properties of actions from images and/or videos, and Step 1520 may use the trained machine learning model to analyze the one or more images obtained by Step 810 and identify the property of the first action. An example of such training example may include an image and/or a video of an action, together with an indication of a property of the action. In yet another example, an artificial neural network (such as a deep neural network, a convolutional neural network, etc.) may be configured to identify properties of actions from images and/or videos, and Step 1520 may use the artificial neural network to analyze the one or more images obtained by Step 810 and identify the property of the first action.

In some examples, Step 1540 may select the second action based on a property of the road. For example, in response to a first property of the road, Step 1540 may select one action as the second action, and in response to a second property of the road, Step 1540 may select a different action as the second action. Some examples as such property of a road may include geographical location of the road, length of the road, numbers of lanes in the road, width of the road, condition of the road, speed limit in the road, environment of the road (for example, urban, rural, etc.), legal limitations on usage of the road, and so forth. In some examples, the property of the road may be obtained from a navigational system, may be obtained from a human user, may be obtained by analyzing the one or more images obtained by Step 810 (for example as described below), and so forth. In some examples, Step 1520 may analyze the one or more images obtained by Step 810 to identify a property of the road. For example, a machine learning model may be trained using training examples to identify properties of roads from images and/or videos, and Step 1520 may use the trained machine learning model to analyze the one or more images obtained by Step 810 and identify the property of the road. An example of such training example may include an image and/or a video of a road, together with an indication of a property of the road. In yet another example, an artificial neural network (such as a deep neural network, a convolutional neural network, etc.) may be configured to identify properties of roads from images and/or videos, and Step 1520 may use the artificial neural network to analyze the one or more images obtained by Step 810 and identify the property of the road.

FIG. 16 illustrates an example of a method 1600 for selectively forgoing actions based on presence of people in a vicinity of containers. In this example, method 1600 may comprise: obtaining one or more images (Step 810), such as one or more images captured using one or more image sensors and depicting at least part of a container and/or depicting at least part of a trash can; analyzing the images to determine whether at least one person is presence in a vicinity of the container (Step 1620); and causing a performance of a first action associated with the container based on the determination of whether at least one person is presence in the vicinity of the container (Step 1630). In some implementations, method 1600 may comprise one or more additional steps, while some of the steps listed above may be modified or excluded. For example, in some cases Step 810 and/or Step 1620 and/or Step 1630 may be excluded from method 1600. In some implementations, one or more steps illustrated in FIG. 16 may be executed in a different order and/or one or more groups of steps may be executed simultaneously and/or a plurality of steps may be combined into single step and/or a single step may be broken down to a plurality of steps.

In some embodiments, analyzing the images to determine whether at least one person is presence in a vicinity of the container (Step 1620) may comprise analyzing the one or more images obtained by Step 810 to determine whether at least one person is presence in a vicinity of the container and/or in a vicinity of the trash can. In some examples, being presence in a vicinity of the container and/or in a vicinity of the trash can may include being in a selected area around the container and/or around the trash can (such as an area defined by regulation and/or safety instructions, area selected as described below, etc.), being in a distance shorter than a selected distance threshold from the container and/or from the trash can (for example, the selected distance threshold may be between five and ten meters, between two and five meters, between one and two meters, between half and one meter, less than half meter, and so forth), within a touching distance from the container and/or from the trash can, and so forth. For example, Step 1620 may use person detection algorithms to analyze the one or more images obtained by Step 810 to attempt to detect people in the vicinity of the container and/or in the vicinity of the trash can, in response to a successful detection of a person in the vicinity of the container and/or in the vicinity of the trash can, Step 1620 may determine that at least one person is presence in a vicinity of the container and/or in a vicinity of the trash can, and in response to a failure to detect a person in the vicinity of the container and/or in the vicinity of the trash can, Step 1620 may determine that no person is presence in a vicinity of the container and/or in a vicinity of the trash can. In another example, a machine learning model may be trained using training example to determine whether people are presence in a vicinity of selected objects from images and/or videos, and Step 1620 may use the trained machine learning model to analyze the one or more images obtained by Step 810 and determine whether at least one person is presence in a vicinity of the container and/or in a vicinity of the trash can. An example of such training example may include an image and/or a video of an object, together with an indication of whether at least one person is presence in a vicinity of the object. In yet another example, an artificial neural network (such as a deep neural network, a convolutional neural network, etc.) may be configured to determine whether people are presence in a vicinity of selected objects from images and/or videos, and Step 1620 may use the artificial neural network to analyze the one or more images obtained by Step 810 and determine whether at least one person is presence in a vicinity of the container and/or in a vicinity of the trash can.

In some embodiments, being presence in a vicinity of the container and/or in a vicinity of the trash can may be defined according to a relative position of a person to the container and/or the trash can, and according to a relative position of the person to a vehicle. For example, Step 1620 may analyze the one or more images obtained by Step 810 to determine a relative position of a person to the container and/or the trash can (for example, distance from the container and/or the trash can, angle with respect to the container and/or to the trash can, etc.), a relative position of the person to the vehicle (for example, distance from the vehicle, angle with respect to the vehicle, etc.), and determine whether at least one person is presence in a vicinity of the container and/or in a vicinity of the trash can based on the relative position of the person to the container and/or the trash can, and on the relative position of the person to the vehicle. In some examples, the person, the container and/or trash can, and the vehicle may define a triangle, in response to a first triangle, Step 1620 may determine that the person is in a vicinity of the container and/or of the trash can, and in response to a second triangle, Step 1620 may determine that person is not in a vicinity of the container and/or of the trash can, and in response to a second triangle.

In some examples, Step 1620 may use a rule to determine whether at least one person is presence in a vicinity of the container and/or in a vicinity of the trash can. In some examples, the rule may be selected based on a type of the container and/or a type of the trash can, a property of a road, a property of the at least one person, a property of the desired first action, and so forth. For example, Step 1620 may analyze the one or more images to determine the type of the container and/or the trash can (for example using Step 1020 as described above), in response to a first type of the container and/or of the trash can, Step 1620 may select a first rule, and in response to a second type of the container and/or of the trash can, Step 1620 may select a second rule (different from the first rule). In another example, Step 1620 may obtain a property of a road (for example, as described above in relation to Step 1520), in response to a first property of the road, Step 1620 may select a first rule, and in response to a second property of the road, Step 1620 may select a second rule (different from the first rule). In yet another example, Step 1620 may obtain a property of a person (for example, as described above in relation to Step 1520), in response to a first property of the person, Step 1620 may select a first rule, and in response to a second property of the person, Step 1620 may select a second rule (different from the first rule). In an additional example, Step 1620 may obtain a property the desired first action of Step 1630, in response to a first property of the desired first action, Step 1620 may select a first rule, and in response to a second property of the desired first action, Step 1620 may select a second rule (different from the first rule).

In some embodiments, causing a performance of a first action associated with the container based on the determination of whether at least one person is presence in the vicinity of the container (Step 1630) may comprise causing a performance of a first action associated with the container and/or the trash can based on the determination by Step 1620 of whether at least one person is presence in the vicinity of the container and/or in the vicinity of the trash can. For example, in response to a determination by Step 1620 that no person is presence in the vicinity of the container and/or in the vicinity of the trash can, Step 1630 may cause the performance of the first action associated with the container and/or the trash can, and in response to a determination by Step 1620 that at least one person is presence in the vicinity of the container and/or in the vicinity of the trash can, Step 1630 may withhold and/or forgo causing the performance of the first action. In some examples, in response to a determination by Step 1620 that at least one person is presence in the vicinity of the container and/or in the vicinity of the trash can, Step 1630 may cause the performance of a second action associated with the container and/or the trash can (different from the first action).

In some examples, the one or more image sensors used to capture the one or more images obtained by Step 810 may be configured to be mounted to a vehicle, and the first action of Step 1630 may comprise adjusting a route of the vehicle to bring the vehicle to a selected position with respect to the container and/or with respect to the trash can. In some examples, the container may be a trash can, and the first action of Step 1630 may comprise emptying the trash can. In some examples, the container may be a trash can, the one or more image sensors used to capture the one or more images obtained by Step 810 may be configured to be mounted to a garbage truck, and the first action of Step 1630 may comprise collecting the content of the trash can with the garbage truck. In some examples, the first action of Step 1630 may comprise moving at least part of the container and/or moving at least part of the trash can. In some examples, the first action of Step 1630 may comprise obtaining one or more objects placed within the container and/or placed within the trash can. In some examples, the first action of Step 1630 may comprise placing one or more objects in the container and/or in the trash can. In some examples, the first action of Step 1630 may comprise changing a physical state of the container and/or a physical state of the trash can.

In some examples, causing a performance of a first action associated with the container and/or the trash can by Step 1630 may comprise providing information. For example, the information may be provided to a user, and the provided information may be configured to cause the user to perform the first action, to enable the user to perform the first action, to inform the user about the first action, and so forth. In another example, the information may be provided to an external system, and the provided information may be configured to cause the external system to perform the first action, to enable the external system to perform the first action, to inform the external system about the first action, and so forth. In some examples, Step 1630 may provide the information textually, may provide the information audibly through an audio speaker, may provide the information visually through a screen, may provide the information through a personal communication device associated with the user, and so forth. In some examples, Step 1630 may provide the information by storing the information in memory (such as memory units 210, shared memory modules 410, etc.), by the transmitting the information over a communication network using a communication device (such as communication modules 230, internal communication modules 440, external communication modules 450, etc.), and so forth. In some examples, causing a performance of a first action associated with the container and/or the trash can by Step 1630 may comprise performing the first action associated with the container and/or the trash can.

In some examples, Step 1620 may analyze the one or more images obtained by Step 810 to determine whether at least one person presence in the vicinity of the container and/or the trash can belongs to a first group of people (as described below), and Step 1630 may withhold and/or forgo causing the performance of the first action based on determination of whether the at least one person presence in the vicinity of the container and/or the trash can belongs to a first group of people. For example, in response to a determination that the at least one person presence in the vicinity of the container belongs to the first group of people, Step 1630 may cause the performance of the first action involving the container, and in response to a determination that the at least one person presence in the vicinity of the container and/or the trash can does not belong to the first group of people, Step 1630 may withhold and/or forgo causing the performance of the first action. For example, Step 1620 may use face recognition algorithms and/or people recognition algorithms to identify the at least one person presence in the vicinity of the container and/or the trash can and determine whether the at least one person presence in the vicinity of the container and/or the trash can belongs to a first group of people. In some examples, Step 1620 may determine the first group of people based on a type of the container and/or the trash can. For example, in response to a first type of the container and/or the trash can, one group of people may be used as the first group, and in response to a second type of the container and/or the trash can, a different group of people may be used as the first group. For example, Step 1620 may analyze the one or more images to determine the type of the container and/or the trash can, for example using Step 1020 as described above.

In some examples, Step 1620 may analyze the one or more images obtained by Step 810 to determine whether at least one person presence in the vicinity of the container and/or the trash can uses suitable safety equipment (as described below), and Step 1630 may withhold and/or forgo causing the performance of the first action based on determination of whether at least one person presence in the vicinity of the container and/or the trash can uses suitable safety equipment. For example, in response to a determination that the at least one person presence in the vicinity of the container uses suitable safety equipment, Step 1630 may cause the performance of the first action involving the container, and in response to a determination that the at least one person presence in the vicinity of the container does not use suitable safety equipment, Step 1630 may withhold and/or forgo causing the performance of the first action. In some examples, Step 1620 may determine the suitable safety equipment based on a type of the container based on a type of the container and/or the trash can. For example, in response to a first type of the container and/or the trash can, first safety equipment may be determined suitable, and in response to a second type of the container and/or the trash can, second safety equipment may be determined suitable (different from the first safety equipment). For example, Step 1620 may analyze the one or more images to determine the type of the container and/or the trash can, for example using Step 1020 as described above. For example, a machine learning model may be trained using training examples to determine whether people are using suitable safety equipment from images and/or videos, and Step 1620 may use the trained machine learning model to analyze the one or more images obtained by Step 810 and determine whether the at least one person presence in the vicinity of the container and/or the trash can uses suitable safety equipment. An example of such training example may include an image and/or a video with a person together with an indication of whether the person uses suitable safety equipment. In another example, an artificial neural network (such as a deep neural network, a convolutional neural network, etc.) may be configured to determine whether people are using suitable safety equipment from images and/or videos, and Step 1620 may use the artificial neural network to analyze the one or more images obtained by Step 810 and determine whether the at least one person presence in the vicinity of the container and/or the trash can uses suitable safety equipment.

In some examples, Step 1620 may analyze the one or more images obtained by Step 810 to determine whether at least one person presence in the vicinity of the container and/or the trash can follows suitable safety procedures (as described below), and Step 1630 may withhold and/or forgo causing the performance of the first action based on determination of whether at least one person presence in the vicinity of the container and/or the trash can follows suitable safety procedures. For example, in response to a determination that the at least one person presence in the vicinity of the container follows suitable safety procedures, Step 1630 may cause the performance of the first action involving the container, and in response to a determination that the at least one person presence in the vicinity of the container does not follow suitable safety procedures, Step 1630 may withhold and/or forgo causing the performance of the first action. In some examples, Step 1620 may determine the suitable safety procedures based on a type of the container based on a type of the container and/or the trash can. For example, in response to a first type of the container and/or the trash can, first safety procedures may be determined suitable, and in response to a second type of the container and/or the trash can, second safety procedures may be determined suitable (different from the first safety procedures). For example, Step 1620 may analyze the one or more images to determine the type of the container and/or the trash can, for example using Step 1020 as described above. For example, a machine learning model may be trained using training examples to determine whether people are following suitable safety procedures from images and/or videos, and Step 1620 may use the trained machine learning model to analyze the one or more images obtained by Step 810 and determine whether the at least one person presence in the vicinity of the container and/or the trash can follows suitable safety procedures. An example of such training example may include an image and/or a video with a person together with an indication of whether the person follows suitable safety procedures. In another example, an artificial neural network (such as a deep neural network, a convolutional neural network, etc.) may be configured to determine whether people are following suitable safety procedures from images and/or videos, and Step 1620 may use the artificial neural network to analyze the one or more images obtained by Step 810 and determine whether the at least one person presence in the vicinity of the container and/or the trash can follows suitable safety procedures.

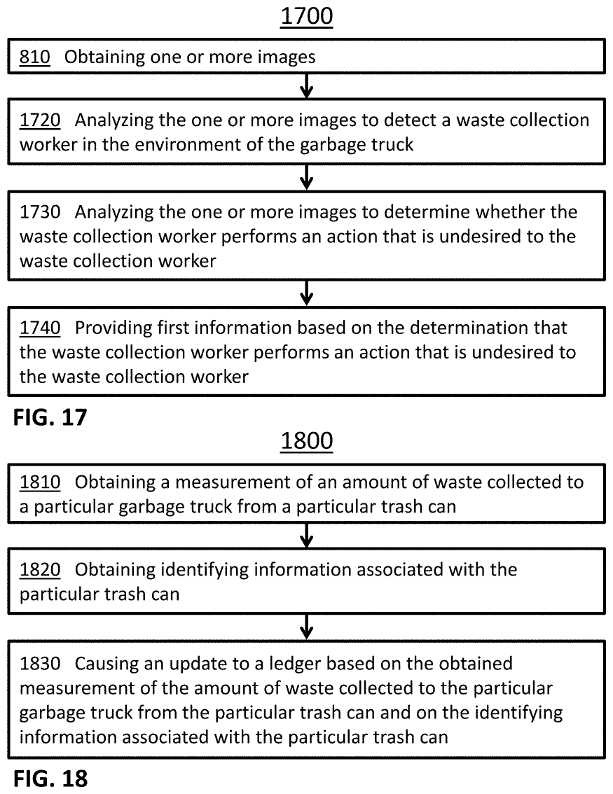

FIG. 17 illustrates an example of a method 1700 for providing information based on detection of actions that are undesired to waste collection workers. In this example, method 1700 may comprise: obtaining one or more images (Step 810), such as one or more images captured using one or more image sensors from an environment of a garbage truck; analyzing the one or more images to detect a waste collection worker in the environment of the garbage truck (Step 1720); analyzing the one or more images to determine whether the waste collection worker performs an action that is undesired to the waste collection worker (Step 1730); and providing first information based on the determination that the waste collection worker performs an action that is undesired to the waste collection worker (Step 1740). In some implementations, method 1700 may comprise one or more additional steps, while some of the steps listed above may be modified or excluded. For example, in some cases Step 810 and/or Step 1720 and/or Step 1730 and/or Step 1740 may be excluded from method 1700. In some implementations, one or more steps illustrated in FIG. 17 may be executed in a different order and/or one or more groups of steps may be executed simultaneously and/or a plurality of steps may be combined into single step and/or a single step may be broken down to a plurality of steps.

Some non-limiting examples of the action that the waste collection worker performs and is undesired to the waste collection worker (of Step 1730 and/or Step 1740) may comprise at least one of misusing safety equipment (such as protective equipment, safety glasses, reflective vests, gloves, full-body coverage clothes, non-slip shoes, steel-toed shoes, etc.), neglecting using safety equipment (such as protective equipment, safety glasses, reflective vests, gloves, full-body coverage clothes, non-slip shoes, steel-toed shoes, etc.), placing a hand of the waste collection worker near and/or on an eye of the waste collection worker, placing a hand of the waste collection worker near and/or on a mouth of the waste collection worker, placing a hand of the waste collection worker near and/or on an ear of the waste collection worker, placing a hand of the waste collection worker near and/or on a nose of the waste collection worker, performing a first action without a mechanical aid that is proper for the first action, lifting an object that should be rolled, performing a first action using an undesired technique, working asymmetrically, not keeping proper footing when handling an object, throwing a sharp object, and so forth.

In some embodiments, analyzing the one or more images to detect a waste collection worker in the environment of the garbage truck (Step 1720) may comprise analyzing the one or more images obtained by Step 810 to detect a waste collection worker in the environment of the garbage truck. For example, Step 1720 may use person detection algorithms to detect people in the vicinity the environment of the garbage truck, may use logo recognition algorithms to determine if the detected people wear uniforms of waste collection workers, and may determine that a detected person is a waste collection worker when it is determined that the person is wearing uniforms of waste collection workers. In another example, a machine learning algorithm may be trained using training examples to detect waste collection workers in images and/or videos, and Step 1720 may use the trained machine learning model to analyze the one or more images obtained by Step 810 and detect waste collection workers in the environment of the garbage truck. An example of such training example may include an image and/or a video, together with an indication of a region depicting a waste collection worker in the image and/or in the video. In yet another example, an artificial neural network (such as a deep neural network, a convolutional neural network, etc.) may be configured to detect waste collection workers in images and/or videos, and Step 1720 may use the artificial neural network to analyze the one or more images obtained by Step 810 and detect waste collection workers in the environment of the garbage truck.

In some embodiments, analyzing the one or more images to determine whether the waste collection worker performs an action that is undesired to the waste collection worker (Step 1730) may comprise analyzing the one or more images obtained by Step 810 to determine whether the waste collection worker detected by Step 1720 performs an action that is undesired to the waste collection worker. For example, Step 1730 may analyze the one or more images obtained by Step 810 to determine whether the waste collection worker detected by Step 1720 performed an action of a selected category (some non-limiting examples of such selected categories may include at least one of misusing safety equipment, neglecting using safety equipment, placing a hand of the waste collection worker near and/or on an eye of the waste collection worker, placing a hand of the waste collection worker near and/or on a mouth of the waste collection worker, placing a hand of the waste collection worker near and/or on an ear of the waste collection worker, placing a hand of the waste collection worker near and/or on a nose of the waste collection worker, performing a first action without a mechanical aid that is proper for the first action, lifting an object that should be rolled, performing a first action using an undesired technique, working asymmetrically, not keeping proper footing when handling an object, throwing a sharp object, and so forth). For example, Step 1730 may use action detection algorithms to detect an action performed by the waste collection worker detected by Step 1720 in the one or more images obtained by Step 810, may use action recognition algorithms to determine whether the detected action is of a category undesired to the waste collection worker (for example, to determine whether the detected action is of a selected category, some non-limiting examples of possible selected categories are listed above), and may determine that the waste collection worker detected by Step 1720 performs an action that is undesired to the waste collection worker when the detected action is of a category undesired to the waste collection worker. In another example, a machine learning model may be trained using training examples to determine whether waste collection workers performs actions that are undesired to themselves (or actions that are of selected categories) from images and/or videos, and Step 1730 may use the trained machine learning model to analyze the one or more images obtained by Step 810 and determine whether a waste collection worker performs an action that is undesired to the waste collection worker (or whether a waste collection worker performs an action of a selected category, some non-limiting examples of possible selected categories are listed above). An example of such training example may include an image and/or a video, together with an indication of whether a waste collection worker performs an action that is undesired to the waste collection worker in the image and/or video (or performs an action from selected categories in the image and/or video). In yet another example, an artificial neural network (such as a deep neural network, a convolutional neural network, etc.) may be configured to determine whether waste collection workers performs actions that are undesired to themselves (or actions that are of selected categories) from images and/or videos, and Step 1730 may use the artificial neural network to analyze the one or more images obtained by Step 810 and determine whether a waste collection worker performs an action that is undesired to the waste collection worker (or whether a waste collection worker performs an action of a selected category, some non-limiting examples of possible selected categories are listed above).

In some embodiments, providing first information based on the determination that the waste collection worker performs an action that is undesired to the waste collection worker (Step 1740) may comprise providing the first information based on the determination by Step 1730 that the waste collection worker detected by Step 1720 performs an action that is undesired to the waste collection worker. For example, in response to a determination by Step 1730 that the waste collection worker detected by Step 1720 performs an action that is undesired to the waste collection worker, Step 1740 may provide the first information, and in response to a determination by Step 1730 that the waste collection worker detected by Step 1720 does not perform an action that is undesired to the waste collection worker, Step 1740 may withhold and/or forgo providing the first information, may provide second information (different from the first information), and so forth. In some examples, Step 1740 may provide the first information based on the determination by Step 1730 that the waste collection worker detected by Step 1720 performed an action of a selected category (some non-limiting examples of such selected categories may include at least one of misusing safety equipment, neglecting using safety equipment, placing a hand of the waste collection worker near and/or on an eye of the waste collection worker, placing a hand of the waste collection worker near and/or on a mouth of the waste collection worker, placing a hand of the waste collection worker near and/or on an ear of the waste collection worker, placing a hand of the waste collection worker near and/or on a nose of the waste collection worker, performing a first action without a mechanical aid that is proper for the first action, lifting an object that should be rolled, performing a first action using an undesired technique, working asymmetrically, not keeping proper footing when handling an object, throwing a sharp object, and so forth). For example, in response to a determination by Step 1730 that the waste collection worker detected by Step 1720 performs an action of the selected category, Step 1740 may provide the first information, and in response to a determination by Step 1730 that the waste collection worker detected by Step 1720 does not perform an action of the selected category, Step 1740 may withhold and/or forgo providing the first information, may provide second information (different from the first information), and so forth.

In some examples, Step 1730 may analyze the one or more images obtained by Step 810 to identify a property of the action that the waste collection worker detected by Step 1720 performs and is undesired to the waste collection worker, for example as described below. Further, in some examples, in response to a first identified property of the action that the waste collection worker performs and is undesired to the waste collection worker, Step 1740 may provide the first information, and in response to a second identified property of the action that the waste collection worker performs and is undesired to the waste collection worker, Step 1740 may withhold and/or forgo providing the first information. For example, the action may comprise placing a hand of the waste collection worker near an ear and/or a mouth and/or an eye and/or a nose of the waste collection worker, and the property may be a distance of the hand from the ear and/or mouth and/or eye and/or nose. In another example, the action may comprise placing a hand of the waste collection worker near and/or on an ear and/or a mouth and/or an eye and/or a nose of the waste collection worker, and the property may be a time that the hand was near and/or on the ear and/or mouth and/or eye and/or nose. In another example, the action may comprise lifting an object that should be rolled, and the property may comprise at least one of a distance that the object was carried, an estimated weight of the object, and so forth.

In some examples, Step 1730 may analyze the one or more images obtained by Step 810 to determine that the waste collection worker places a hand of the waste collection worker near and/or on an ear and/or a mouth and/or an eye and/or a nose of the waste collection worker for a first time duration. For example, frames at which waste collection worker places a hand of the waste collection worker near and/or on an ear and/or a mouth and/or an eye and/or a nose of the waste collection worker may be identified in a video, for example using Step 1730 as described above, and the first time duration may be measured according to the elapsed time in the video corresponding to the identified frames. In another example, a machine learning model may be trained using training examples to determine lengths of time durations at which a hand is placed near and/or on an ear and/or a mouth and/or an eye and/or a nose from images and/or videos, and Step 1730 may use the trained machine learning model to analyze the one or more images obtained by Step 810 to determine the first time duration. An example of such training example may include images and/or a video of a hand placed near and/or on an ear and/or a mouth and/or an eye and/or a nose, together with an indication of the length of the time duration that the hand is placed near and/or on the ear and/or mouth and/or eye and/or nose. Further, in some examples, Step 1740 may compare the first time duration with a selected time threshold. Further, in some examples, in response to the first time duration being longer than the selected time threshold, Step 1740 may provide the first information, and in response to the first time duration being shorter than the selected time threshold, Step 1740 may withhold and/or forgo providing the first information.

In some examples, Step 1740 may provide the first information to a user, and in some examples, the provided first information may be configured to cause the user to perform an action, to enable the user to perform an action, to inform the user about the action that is undesired to the waste collection worker, and so forth. Some non-limiting examples of such user may include the waste collection worker of Step 1720 and/or Step 1730, a supervisor of the waste collection worker of Step 1720 and/or Step 1730, a driver of the garbage truck of method 1700, and so forth. In another example, Step 1740 may provide the first information to an external system, and in some examples, the provided first information may be configured to cause the external system to perform an action, to enable the external system to perform an action, to inform the external system about the action that is undesired to the waste collection worker, and so forth. In some examples, Step 1740 may provide the information textually, may provide the information audibly through an audio speaker, may provide the information visually through a screen, may provide the information through a personal communication device associated with the user, and so forth. In some examples, Step 1740 may provide the first information by storing the first information in memory (such as memory units 210, shared memory modules 410, etc.), by the transmitting the first information over a communication network using a communication device (such as communication modules 230, internal communication modules 440, external communication modules 450, etc.), and so forth. In some examples, the first information provided by Step 1740 may be configured to cause an update to statistical information associated with the waste collection worker. For example, the statistical information associated with the waste collection worker may include a count of the actions, count of actions of selected categories (some non-limiting examples of such selected categories may include at least one of misusing safety equipment, neglecting using safety equipment, placing a hand of the waste collection worker near and/or on an eye of the waste collection worker, placing a hand of the waste collection worker near and/or on a mouth of the waste collection worker, placing a hand of the waste collection worker near and/or on an ear of the waste collection worker, placing a hand of the waste collection worker near and/or on a nose of the waste collection worker, performing a first action without a mechanical aid that is proper for the first action, lifting an object that should be rolled, performing a first action using an undesired technique, working asymmetrically, not keeping proper footing when handling an object, throwing a sharp object, and so forth), count of actions performed in selected context, and so forth.

FIG. 18 illustrates an example of a method 1800 for providing information based on amounts of waste. In this example, method 1800 may comprise: obtaining a measurement of an amount of waste collected to a particular garbage truck from a particular trash can (Step 1810); obtaining identifying information associated with the particular trash can (Step 1820); and causing an update to a ledger based on the obtained measurement of the amount of waste collected to the particular garbage truck from the particular trash can and on the identifying information associated with the particular trash can (Step 1830). In some implementations, method 1800 may comprise one or more additional steps, while some of the steps listed above may be modified or excluded. For example, in some cases Step 1810 and/or Step 1820 and/or Step 1830 may be excluded from method 1800. In some implementations, one or more steps illustrated in FIG. 18 may be executed in a different order and/or one or more groups of steps may be executed simultaneously and/or a plurality of steps may be combined into single step and/or a single step may be broken down to a plurality of steps.

In some embodiments, a second measurement of a second amount of waste collected to a second garbage truck from the particular trash can may be obtained by Step 1810, for example as described below. Further, in some examples, a function (such as sum, sum of square roots, etc.) of the obtained measurement of the amount of waste collected to the garbage truck from the particular trash can and the obtained second measurement of the second amount of waste collected to the second garbage truck from the particular trash can may be calculated. Further, in some examples, Step 1830 may cause an update to the ledger based on the calculated function (such as the calculated sum, the calculated sum of square roots, etc.) and on the identifying information associated with the particular trash can.

In some embodiments, a second measurement of a second amount of waste collected to the garbage truck from a second trash can may be obtained by Step 1810, for example as described below. Further, in some examples, second identifying information associated with the second trash can may be obtained by Step 1820, for example as described below. Further, in some examples, the identifying information associated with the particular trash can and the second identifying information associated with the second trash can may be used to determine that a common entity is associated with both the particular trash can and the second trash can. Some non-limiting examples of such common entity may include a common user, a common owner, a common residential unit, a common office unit, and so forth. Further, in some examples, a function (such as sum, sum of square roots, etc.) of the obtained measurement of the amount of waste collected to the garbage truck from the particular trash can and the obtained second measurement of the second amount of waste collected to the garbage truck from the second trash can may be calculated. Further, in some examples, Step 1830 may cause an update to a record of the ledger associated with the common entity based on the calculated function (such as the calculated sum, the calculated sum of square roots, and so forth).

In some embodiments, Step 1810 may comprise obtaining one or more measurements, where each obtained measurement may be a measurement of an amount of waste collected to a garbage truck from a trash can. For example, a measurement of an amount of waste collected to the particular garbage truck from the particular trash can may be obtained, a second measurement of a second amount of waste collected to a second garbage truck from the particular trash can may be obtained, a third measurement of a third amount of waste collected to the garbage truck from a second trash can may be obtained, and so forth. In some examples, Step 1810 may comprise reading at least part of the one or more measurements from memory (such as memory units 210, shared memory modules 410, and so forth), may comprise receiving at least part of the one or more measurements from an external device (such as a device associated with the garbage truck, a device associated with the trash can, etc.) over a communication network using a communication device (such as communication modules 230, internal communication modules 440, external communication modules 450, etc.), and so forth.

In some examples, any measurement obtained by Step 1810 of an amount of waste collected to a garbage truck from a trash can may comprise at least one of a measurement of the weight of waste collected to the garbage truck from the trash can, a measurement of the volume of waste collected to the garbage truck from the trash can, and so forth.

In some examples, any measurement obtained by Step 1810 of an amount of waste collected to a garbage truck from a trash can may be based on an analysis of an image of the waste collected to the garbage truck from the trash can. For example, such image may be captured by an image sensor mounted to the garbage truck, by an image sensor mounted to the trash can, by a wearable image sensor used by a waste collection worker, and so forth. In some examples, a machine learning model may be trained using training examples to determine amounts of waste (such as weight, volume, etc.) from images and/or videos, and the trained machine learning model may be used to analyze the image of the waste collected to the garbage truck from the trash can and determine the amount of waste collected to the garbage truck from the trash can. An example of such training example may include an image and/or a video of waste together with the desired determined amount of waste. In some examples, an artificial neural network (such as a deep neural network, a convolutional neural network, etc.) may be configured to determine amounts of waste (such as weight, volume, etc.) from images and/or videos, and the artificial neural network may be used to analyze the image of the waste collected to the garbage truck from the trash can and determine the amount of waste collected to the garbage truck from the trash can.

In some examples, any measurement obtained by Step 1810 of an amount of waste collected to a garbage truck from a trash can may be based on an analysis of one or more weight measurements performed by the garbage truck. For example, the garbage truck may include a weight sensor for measuring weight of the waste carried by the garbage truck, the weight of the waste carried by the garbage truck may be measured before and after collecting waste from the trash can, and the measurement of the amount of waste collected to the garbage truck from the trash can may be calculated as the difference between the before and after measurements.

In some examples, any measurement obtained by Step 1810 of an amount of waste collected to a garbage truck from a trash can may be based on an analysis of one or more volume measurements performed by the garbage truck. For example, the garbage truck may include a volume sensor for measuring volume of the waste carried by the garbage truck, the volume of the waste carried by the garbage truck may be measured before and after collecting waste from the trash can, and the measurement of the amount of waste collected to the garbage truck from the trash can may be calculated as the difference between the before and after measurements.

In some examples, any measurement obtained by Step 1810 of an amount of waste collected to a garbage truck from a trash can may be based on an analysis of one or more weight measurements performed by the trash can. For example, the trash can may include a weight sensor for measuring weight of the waste in the trash can, the weight of the waste in the trash can may be measured before and after collecting waste from the trash can, and the measurement of the amount of waste collected to the garbage truck from the trash can may be calculated as the difference between the before and after measurements. In another example, the trash can may include a weight sensor for measuring weight of the waste in the trash can, and the weight of the waste in the trash can may be measured before collecting waste from the trash can, assuming all the waste within the trash can is collected.

In some examples, any measurement obtained by Step 1810 of an amount of waste collected to a garbage truck from a trash can may be based on an analysis of one or more volume measurements performed by the trash can. For example, the trash can may include a volume sensor for measuring volume of the waste in the trash can, the volume of the waste in the trash can may be measured before and after collecting waste from the trash can, and the measurement of the amount of waste collected to the garbage truck from the trash can may be calculated as the difference between the before and after measurements. In another example, the trash can may include a volume sensor for measuring volume of the waste in the trash can, and the volume of the waste in the trash can may be measured before collecting waste from the trash can, assuming all the waste within the trash can is collected.

In some examples, any measurement obtained by Step 1810 of an amount of waste collected to a garbage truck from a trash can may be based on an analysis of a signal transmitted by the particular trash can. For example, the trash can may estimate the amount of waste within it (for example, by analyzing an image of the waste as described above, using a weight sensor as described above, using a volume sensor as described above, etc.) and transmit information based on the estimation encoded in a signal, the signal may be analyzed to determine the encoded estimation, and the measurement obtained by Step 1810 may be based on the encoded estimation. For example, the measurement may be the encoded estimated amount of waste within the trash can before emptying the trash can to the garbage truck. In another example, the measurement may be the result of subtracting the estimated amount of waste within the trash can after emptying the trash can to the garbage truck from the estimated amount of waste within the trash can before emptying.

In some embodiments, Step 1820 may comprise obtaining one or more identifying information records, where each obtained identifying information record may comprise identifying information associated with a trash can. For example, identifying information associated with a particular trash can may be obtained, second identifying information associated with a second trash can may be obtained, and so forth. In some examples, Step 1810 may comprise reading at least part of the one or more identifying information records from memory (such as memory units 210, shared memory modules 410, and so forth), may comprise receiving at least part of the one or more identifying information records from an external device (such as a device associated with the garbage truck, a device associated with the trash can, etc.) over a communication network using a communication device (such as communication modules 230, internal communication modules 440, external communication modules 450, etc.), and so forth. In some examples, any identifying information associated with a trash can and obtained by Step 1820 may comprise a unique identifier of the trash can (such as a serial number of the trash can), may comprise an identifier of a user of the particular trash can, may comprise an identifier of an owner of the trash can, may comprise an identifier of a residential unit (such as an apartment, a residential building, etc.) associated with the trash can, may comprise an identifier of an office unit associated with the trash can, and so forth.

In some examples, any identifying information associated with a trash can and obtained by Step 1820 may be based on an analysis of an image of the trash can. In some examples, such image of the trash can may be captured by an image sensor mounted to the garbage truck, a wearable image sensor used by a waste collection worker, and so forth. In some examples, a visual identifier (such as a QR code, a barcode, a unique visual code, a serial number, a string, and so forth) may be presented visually on the trash can, and the analysis of the image of the trash can may identify this visual identifier (for example, using OCR, using QR reading algorithm, using barcode reading algorithm, and so forth). In some examples, a machine learning model may be trained using training examples to determine identifying information associated with trash cans from images and/or videos of the trash cans, and the trained machine learning model may be used to analyze the image of the trash can and determine the identifying information associated with the trash can. An example of such training example may include an image and/or a video of a trash can, together with identifying information associated with the trash can. In some examples, an artificial neural network (such as a deep neural network, a convolutional neural network, etc.) may be configured to determine identifying information associated with trash cans from images and/or videos of the trash cans, and the artificial neural network may be used to analyze the image of the trash can and determine the identifying information associated with the trash can.

In some examples, any identifying information associated with a trash can and obtained by Step 1820 may be based on an analysis of a signal transmitted by the trash can. For example, the trash can may encode identifying information in a signal and transmit the signal with the encoded identifying information, and the transmitted signal may be received and analyzed to decode the identifying information.

In some embodiments, Step 1830 may comprise causing an update to a ledger based on the obtained measurement of the amount of waste collected to the garbage truck from the particular trash can and on the identifying information associated with the particular trash can. In some examples, data configured to cause the update to the ledger may be provided. For example, the data configured to cause the update to the ledger may be determined based on the obtained measurement of the amount of waste collected to the garbage truck from the particular trash can and/or on the identifying information associated with the particular trash can. In another example, the data configured to cause the update to the ledger may comprise the obtained measurement of the amount of waste collected to the garbage truck from the particular trash can and/or on the identifying information associated with the particular trash can. In one example, the data configured to cause the update to the ledger may be provided to an external device, may be provided to a user, may be provided to a different process, and so forth. In one example, the data configured to cause the update to the ledger may be stored in memory (such as memory units 210, shared memory modules 410, etc.), may be transmitted over a communication network using a communication device (such as communication modules 230, internal communication modules 440, external communication modules 450, etc.), and so forth.

In some examples, the update to the ledger caused by Step 1830 may include charging an entity selected based on the identifying information associated with the particular trash can obtained by Step 1820 for the amount of waste collected to the garbage truck from the particular trash can determined by Step 1810. For example, a price for a unit of waste may be selected, the selected price may be multiplied by the amount of waste collected to the garbage truck from the particular trash can determined by Step 1810 to obtain a subtotal, and the subtotal may be charged to the entity selected based on the identifying information associated with the particular trash can obtained by Step 1820. For example, the selected price for a unit of waste may be selected according to the entity, according to the day in week, according to a geographical location of the trash can, according to a geographical location of the garbage truck, according to the type of trash can (for example, the type of the trash can may be determined as described above), according to the type of waste collected from the trash can (for example, the type of waste may be determined as described above), and so forth.

In some examples, Step 1830 may comprise recording of the amount of waste collected to the garbage truck from the particular trash can determined by Step 1810. For example, the amount may be recorded in a log entry associated with an entity selected based on the identifying information associated with the particular trash can obtained by Step 1820.

In some embodiments, other garbage trucks and/or personnel associated with the other garbage trucks and/or systems associated with the other garbage trucks may be notified about garbage status that is not collected by this truck. For example, the garbage truck may not be designated for some kinds of trash (hazardous materials, other kind of trash, etc.), and a notification may be provided to a garbage truck that is designated for these kinds of trash observed by the garbage truck. For example, the garbage truck may forgo picking some trash (for example, when full or near full, when engaged in another activity, etc.), and a notification may be provided to other garbage trucks about the unpicked trash.

In some embodiments, personnel associated with a vehicle (such as waste collectors associated with a garbage truck, carrier associated with a truck, etc.) may be monitored, for example by analyzing the one or more images captured by Step 810 from an environment of a vehicle, for example using person detection algorithms. In some examples, reverse driving may be forgone and/or withheld when not all personnel are detected in the image data (or when at least one person is detected in an unsafe location).

In some embodiments, accidents and/or near-accidents and/or injuries in the environment of the vehicle may be identified by analyzing the one or more images captured by Step 810 from an environment of a vehicle. For example, injuries to waste collectors may be identified by analyzing the one or more images captured by Step 810, for example using event detection algorithms, and corresponding notification may be provided to a user and/or statistics about such events may be gathered. For example, the notification may include recommended actions to be taken (for example, when punctured by a used hypodermic needle, recommend on going immediately to a hospital, for example to be tested and/or treated).

It will also be understood that the system according to the invention may be a suitably programmed computer, the computer including at least a processing unit and a memory unit. For example, the computer program can be loaded onto the memory unit and can be executed by the processing unit. Likewise, the invention contemplates a computer program being readable by a computer for executing the method of the invention. The invention further contemplates a machine-readable memory tangibly embodying a program of instructions executable by the machine for executing the method of the invention.

What is claimed is:

1. A non-transitory computer readable medium storing a software program comprising data and computer implementable instructions for carrying out a method for providing information based on detection of actions that are undesired to waste collection workers, the method comprising:
obtaining one or more images captured using one or more image sensors from an environment of a garbage truck;
analyzing the one or more images to detect a waste collection worker in the environment of the garbage truck;
analyzing the one or more images to determine whether the waste collection worker performs an action that is undesired to the waste collection worker; and
in response to a determination that the waste collection worker performs an action that is undesired to the waste collection worker, providing first information.

2. The non-transitory computer readable medium of claim 1, wherein the method further comprises:
analyzing the one or more images to identify a property of the action that the waste collection worker performs and is undesired to the waste collection worker;
in response to a first identified property of the action that the waste collection worker performs and is undesired to the waste collection worker, providing the first information; and
in response to a second identified property of the action that the waste collection worker performs and is undesired to the waste collection worker, forgoing providing the first information.

3. The non-transitory computer readable medium of claim 1, wherein the method further comprises:
analyzing the one or more images to determine that the waste collection worker places a hand of the waste collection worker on an eye of the waste collection worker for a first time duration;
comparing the first time duration with a selected time threshold;
in response to the first time duration being longer than the selected time threshold, providing the first information; and
in response to the first time duration being shorter than the selected time threshold, forgoing providing the first information.

4. The non-transitory computer readable medium of claim 1, wherein the method further comprises:
analyzing the one or more images to determine that the waste collection worker places a hand of the waste collection worker at a first distance from an eye of the waste collection worker;
comparing the first distance with a selected distance threshold;
in response to the first distance being shorter than the selected distance threshold, providing the first information; and
in response to the first distance being longer than the selected distance threshold, forgoing providing the first information.

5. The non-transitory computer readable medium of claim 1, wherein the action that the waste collection worker performs and is undesired to the waste collection worker comprises misusing safety equipment.

6. The non-transitory computer readable medium of claim 1, wherein the action that the waste collection worker performs and is undesired to the waste collection worker comprises neglecting using safety equipment.

7. The non-transitory computer readable medium of claim 1, wherein the action that the waste collection worker performs and is undesired to the waste collection worker comprises placing a hand of the waste collection worker near an eye of the waste collection worker.

8. The non-transitory computer readable medium of claim 1, wherein the action that the waste collection worker performs and is undesired to the waste collection worker comprises placing a hand of the waste collection worker near a mouth of the waste collection worker.

9. The non-transitory computer readable medium of claim 1, wherein the action that the waste collection worker performs and is undesired to the waste collection worker comprises placing a hand of the waste collection worker near an ear of the waste collection worker.

10. The non-transitory computer readable medium of claim 1, wherein the action that the waste collection worker performs and is undesired to the waste collection worker comprises performing a first action without a mechanical aid that is proper for the first action.

11. The non-transitory computer readable medium of claim 1, wherein the action that the waste collection worker performs and is undesired to the waste collection worker comprises lifting an object that should be rolled.

12. The non-transitory computer readable medium of claim 1, wherein the action that the waste collection worker performs and is undesired to the waste collection worker comprises performing a first action using an undesired technique.

13. The non-transitory computer readable medium of claim 12, wherein the undesired technique comprises working asymmetrically.

14. The non-transitory computer readable medium of claim 12, wherein the undesired technique comprises not keeping proper footing when handling an object.

15. The non-transitory computer readable medium of claim 1, wherein the action that the waste collection worker performs and is undesired to the waste collection worker comprises throwing a sharp object.

16. The non-transitory computer readable medium of claim 1, wherein the provided first information is provided to the waste collection worker.

17. The non-transitory computer readable medium of claim 1, wherein the provided first information is provided to a driver of the garbage truck.

18. The non-transitory computer readable medium of claim 1, wherein the provided first information is configured to cause an update to statistical information associated with the waste collection worker.

19. A system for providing information based on detection of actions that are undesired to waste collection workers, the system comprising:
at least one processing unit configured to:
obtain one or more images captured using one or more image sensors from an environment of a garbage truck;
analyze the one or more images to detect a waste collection worker in the environment of the garbage truck;
analyze the one or more images to determine whether the waste collection worker performs an action that is undesired to the waste collection worker; and
in response to a determination that the waste collection worker performs an action that is undesired to the waste collection worker, provide first information.

20. A method for providing information based on detection of actions that are undesired to waste collection workers, the method comprising:
obtaining one or more images captured using one or more image sensors from an environment of a garbage truck;
analyzing the one or more images to detect a waste collection worker in the environment of the garbage truck;
analyzing the one or more images to determine whether the waste collection worker performs an action that is undesired to the waste collection worker; and
in response to a determination that the waste collection worker performs an action that is undesired to the waste collection worker, providing first information.
